(19) United States
(12) Patent Application Publication
(10) Pub. No.: US 2024/0193497 A1
(43) Pub. Date: Jun. 13, 2024

(54) SUBJECT-TRACKING IN A CASHIER-LESS SHOPPING STORE FOR AUTONOMOUS CHECKOUT FOR IMPROVING ITEM AND SHELF PLACEMENT AND FOR PERFORMING SPATIAL ANALYTICS USING SPATIAL DATA AND THE SUBJECT-TRACKING

(71) Applicant: STANDARD COGNITION, CORP., San Francisco, CA (US)

(72) Inventors: Luis Yoichi MORALES SAIKI, San Francisco, CA (US); Adhvaith VIJAY, San Diego, CA (US); Francesco ZANLUNGO, Okayama City (JP); Atul DHINGRA, Sunnyvale, CA (US); Michael John LEE, Castro Valley, CA (US)

(73) Assignee: STANDARD COGNITION, CORP., San Francisco, CA (US)

(21) Appl. No.: 18/522,104

(22) Filed: Nov. 28, 2023

Related U.S. Application Data
(60) Provisional application No. 63/428,373, filed on Nov. 28, 2022.
(60) Provisional application No. 63/435,926, filed on Dec. 29, 2022.

(51) Int. Cl. G06Q 10/04; G01C 21/20; G06T 7/70

(52) U.S. Cl. CPC G06Q 10/04; G01C 21/206; G06T 7/70

(57) ABSTRACT

The technology disclosed relates to systems and methods for predicting a path of a subject in an area of real space in a shopping store including a cashier-less checkout system. The system comprises a plurality of sensors producing respective sequences of frames of corresponding fields of view in the real space. The system comprises an identification device comprising logic to identify, for a particular subject, a determined path in the area of real space over a period of time using the sequences of frames produced by sensors in the plurality of sensors. The system comprises a path prediction device to predict path of new subjects in the area of real space. The system comprises a layout generation device comprising logic to change a preferred placement of a particular item, in dependence on the predicted path.

### PRIORITY APPLICATION

This application claims the benefit of U.S. Provisional Patent Application No. 63/428,373 (Attorney Docket No. STCG 1039-1) filed 28 Nov. 2022, which application is incorporated herein by reference; this application also claims the benefit of U.S. Provisional Patent Application No. 63/435,926 (Attorney Docket No. STCG 1041-1) filed on 29 Dec. 2022, which application is incorporated herein by reference.

### BACKGROUND

### Field

The technology disclosed relates to systems and methods that track subjects in an area of real space and detect actions performed by subjects in the area of real space, specifically the technology disclosed is related to generating heatmaps and other analytics using spatial data that includes maps of the area of real space, subject tracks and inventory events in a cashier-less shopping store.

### Description of Related Art

Manufacturers, distributors, shopping store management are interested to know different activities performed by shoppers related to inventory items in a shopping store. Some examples of activities are shoppers taking the inventory item from shelf, putting the inventory item back on a shelf, or purchasing the inventory item, etc. Consider the example of a shopping store in which the inventory items are placed at multiple inventory locations such as on a shelf in an aisle and on promotional fixtures such as end-caps at the end of an aisle or in an open area. Manufacturers and distributors supplying the inventory items and the shopping store management are interested to know which inventory locations (such as shelves, bins, etc.) are more frequently visited for taking particular inventory items and which inventory locations are occasionally visited by shoppers for taking the same or different inventory items. Consolidating inventory item sale data from point of sale systems can indicate the total number of a particular inventory item sold in a specific period of time such as a day, week or month. However, this information does not identify the inventory locations from where the customers took these inventory items, if inventory items are stocked at multiple inventory locations in the shopping store.

The store management is interested to know which areas of the shopping store are more frequently visited by shoppers and which areas are not visited or rarely visited by the shoppers. Arrangement of the shelves and the inventory items positioned on the shelves can increase the flow of shoppers in the areas of the shopping store that are not frequently visited. In some cases, the areas at the far back end or corners of the shopping store are not visited by most of the shoppers in the shopping store, or in other cases, depending on the layout of the store, the middle aisles are not visited as often as other locations by shoppers. Improving the flow of the shoppers in various areas of the shopping store can increase the sale of items positioned on shelves in those areas.

It is desirable to provide a system that can more effectively and automatically provide the activity data related to shoppers and locations of purchased inventory items and locations of inventory items that have been picked up by shoppers when the same or similar items are at multiple locations in the shopping store.

### SUMMARY

A system and method for operating a system are provided for predicting a path of a subject in an area of real space. The system for predicting the path of a subject in an area of space in a shopping store including a cashier-less checkout system comprises the following components. The system comprises a plurality of sensors, producing respective sequences of frames of corresponding fields of view in the real space. The system comprises an identification device comprising logic to identify, for a particular subject, a determined path in the area of real space over a period of time using the sequences of frames produced by sensors in the plurality of sensors. The determined path can include a subject identifier, one or more locations in the area of real space and one or more timestamps. The system comprises an accumulation device, comprising logic to accumulate multiple determined paths for multiple subjects over a period of time. The system comprises a matrix generation device, comprising logic to generate a transition matrix using the accumulated determined paths. An element in the transition matrix identifies a probability of a new subject moving from a first location to at least one of other locations in the area of real space. The system comprises a path prediction device. The path prediction device comprises logic to predict the path of the new subject in the area of real space in dependence on an interaction of the new subject with an item associated with the first location in the area of real space. The predicting of the path comprises identifying a second location, from the other locations included in the transition matrix, having a highest probability associated therewith with respect to movement of the new subject from the first location. The system comprises a layout generation device. The layout generation device comprises logic to change a preferred placement of a particular item, in dependence on the predicted path, from an existing location to a new location in the area of real space to increase interaction of future subjects with the particular item.

The layout generation device further includes logic to change a preferred placement of a shelf containing the particular item, in dependence on the predicted path, from an existing location to a new location in the area of real space to increase interaction of the future subjects with the particular item contained within the shelf.

The path prediction device further includes logic to identify a third location, from the other locations included in the transition matrix, having a highest probability associated therewith with respect to movement of the new subject from the second location.

The path prediction device further includes logic to determine the interaction of the new subject with the item when an angle between a plane connecting shoulder joints of the new subject is greater than or equal to 40 degrees and less than or equal to 50 degrees corresponding to a plane representing a front side of a shelf at the first location and when a speed of the subject is greater than or equal to 0.15 meters per second and less than or equal to 0.25 meters per second and when a distance of the subject is less than or equal to 1 meter from the shelf at the first location.

The system further comprises a shelf popularity score calculation device including logic to increment a count of visits to a particular shelf whenever the interaction is determined for the particular shelf. The shelf popularity score calculation device includes logic to use the count of visits to the particular shelf over a period of time to determine a shelf popularity score for the particular shelf.

The shelf popularity score can be calculated for the particular shelf at different times of a day and at different days of a week.

The system further comprises a heatmap generation device including logic to generate a heatmap for the area of real space in dependence on a count of interactions of all subjects in the area of real space with all shelves in the area of real space.

The system further comprises a heatmap generation device including logic to re-calculate the heatmap for the area of real space in dependence upon a change of a location of at least a first shelf in the area of real space.

The path prediction device further comprises logic to generate the predicted path for the new subject starting from a location of a first shelf with which the subject interacted and ending at an exit location from the area of real space.

The system further comprises a display generation device including logic to display a graphical representation of connectedness of shelves in the area of real space. The graphical representation comprises nodes representing shelves in the area of real space and comprises edges connecting the nodes representing distances between respective shelves weighted by respective elements of the transition matrix.

In response to changing a location of a shelf in the area of real space, the display generation device further includes logic to display an updated graphical representation by recalculating the edges connecting the shelf to other shelves in the area of real space.

The system further comprises a training device including logic to train a machine learning model for predicting the path of the subject in the area of real space. The training device includes logic to input, to the machine learning model, labeled examples from training data. An example in the labeled examples comprises at least one determined path from the accumulated multiple paths for multiple subjects. The training device includes logic to input, to the machine learning mode, a map of the area of real space comprising locations of shelves in the area of real space. The training device includes logic to input, to the machine learning model, labels of products associated with respective shelves in the area of real space.

The system further comprises logic to use the trained machine learning model to predict the path of the new subject in the area of real space by providing, as input, at least one interaction of the new subject with an item associated with the first location in the area of real space.

A method for predicting a path of a subject in an area of real space in a shopping store including a cashier-less checkout system is also disclosed. The method includes features for the system described above. Computer program products which can be executed by the computer system are also described herein.

A method for predicting a path of a subject in an area of real space is disclosed. The method includes using a plurality of sensors to produce respective sequences of frames of corresponding fields of view in the real space. The method includes identifying, for a particular subject, a determined path in the area of real space over a period of time using the sequences of frames produced by sensors in the plurality of sensors. The determined path can include a subject identifier, one or more locations in the area of real space and one or more timestamps. The method includes accumulating multiple determined paths for multiple subjects over a period of time. The method includes generating a transition matrix using the accumulated determined paths. An element in the transition matrix can identify a probability of a new subject moving from a first location to at least one of other locations in the area of real space. The method includes predicting the path of the new subject in the area of real space in dependence on an interaction of the new subject with an item associated with the first location in the area of real space. The predicting of the path comprises identifying a second location, from the other locations included in the transition matrix, having a highest probability associated therewith with respect to movement of the new subject from the first location.

In one implementation, the predicting the path of the new subject in the area of real space can include identifying a third location, from the other locations included in the transition matrix, having a highest probability associated therewith with respect to movement of the new subject from the second location.

In one implementation, the method includes determining the interaction of the new subject with the item when at least one or more of the following conditions are true. An angle between a plane connecting shoulder joints of the new subject is greater than or equal to 40 degrees and less than or equal to 50 degrees corresponding to a plane representing a front side of a shelf at the first location. A speed of the subject is greater than or equal to 0.15 meters per second and less than or equal to 0.25 meters per second. A distance of the subject is less than or equal to 1 meter from the shelf at the first location.

In one implementation, the method includes incrementing a count of visits to a particular shelf whenever the interaction is determined for the particular shelf. The method includes using the count of visits to the particular shelf over a period of time to determine a shelf popularity score for the particular shelf.

The shelf popularity score can be calculated for the particular shelf at different times of a day and at different days of a week.

The method includes calculating a heatmap for the area of real space in dependence on a count of interactions of all subjects in the area of real space with all shelves in the area of real space.

The method includes re-calculating the heatmap for the area of real space in dependence upon a change of a location of at least a first shelf in the area of real space.

The method includes generating the predicted path for the new subject starting from a location of a first shelf with which the subject interacted and ending at an exit location from the area of real space.

The method includes displaying a graphical representation of connectedness of shelves in the area of real space. The graphical representation can comprise nodes representing shelves in the area of real space and comprising edges connecting the nodes representing distances between respective shelves weighted by respective elements of the transition matrix.

The method includes changing a location of a shelf in the area of real space and displaying an updated graphical representation by recalculating the edges connecting the shelf to other shelves in the area of real space.

The method includes training a machine learning model for predicting the path of the subject in the area of real space, the training of the machine learning model. The machine learning model can be trained by inputting labeled examples from training data to the machine learning mode. An example in the labeled examples comprises at least one determined path from the accumulated multiple paths for multiple subjects. The machine learning model can be trained by inputting a map of the area of real space comprising locations of shelves in the area of real space. The machine learning model can be trained by inputting labels of products associated with respective shelves in the area of real space.

A system including a hardware processor and memory storing machine instructions that implement the method presented above is also disclosed. Computer program products which can be executed by the computer system are also described herein.

Other aspects and advantages of the present invention can be seen on review of the drawings, the detailed description and the claims, which follow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The invention will be described with respect to specific embodiments thereof, and reference will be made to the drawings, which are not drawn to scale, and in which:

FIG. 1A illustrates an architectural level schematic of a system to predict paths of new subjects in an area of real space.

FIG. 1B presents a high-level architecture of a spatial analytics engine including devices to process subject tracking and subject interactions data.

FIG. 2A is a side view of an aisle in a shopping store illustrating a subject, inventory display structures and a camera arrangement in a shopping store.

FIG. 2B is a perspective view, illustrating a subject taking an item from a shelf in the inventory display structure in the area of real space.

FIG. 3A shows an example data structure for storing joints information of subjects.

FIG. 3B is an example data structure for storing a subject including the information of associated joints.

FIG. 4A presents a high-level process for using various data collected from the area of real store to analyze the data and generate heatmaps.

FIG. 4B presents various types of maps of the area of real store that can be used as input to the spatial analytics engine.

FIG. 5A presents two heatmaps using subject tracking data related to stationary and moving subjects in an area of real space.

FIG. 5B presents a heatmap using subject tracking and inventory events data related to items taken from shelves.

FIG. 5C presents heatmaps from multiple areas of the real space for comparative analysis.

FIG. 5D presents a heatmap generated using subject tracking and inventory events data in the area of real space to illustrate shopper behavior.

FIG. 6A presents a temporal analysis of various heatmaps of an area of real space to present changes in the placement of items in shelves over a period of time.

FIG. 6B presents a plurality of temporal heatmaps for an area of real space capturing subject tracking and inventory events data at the area of real space.

FIG. 6C presents a dwell heatmap indicating areas of the real space at which subjects are stationary.

FIG. 6D presents various locations in the area of real space at which subjects are stationary or moving within close proximity of a shelf or a counter.

FIG. 6E presents a heatmap illustrating joints data of subjects in the area of real space.

FIGS. 7A and 7B present different walking paths, in an area of real space, constructed based on subject tracking data.

FIGS. 8A, 8B, 8C, 8D, 8E, 8F and 8G present cluster analysis using subject tracking data and maps data of a plurality of areas of real space.

FIG. 8H presents a flowchart illustrating operations for clustering the plurality of areas of real space into clusters with similar features.

FIGS. 9A and 9B present augmented reality and virtual reality applications to visualize subject tracking and inventory events data from an area of real space.

FIG. 10 is a camera and computer hardware arrangement configured for hosting the subject persistence processing engine of FIG. 1.

FIG. 11 is a side view of an aisle in a shopping store illustrating a subject with a mobile computing device and a camera arrangement.

FIG. 12 is a top view of the aisle of FIG. 11 in a shopping store illustrating the subject with the mobile computing device and the camera arrangement.

FIG. 13 is a flowchart showing operations for identifying a subject by matching the tracked subject to a user account using a semaphore image displayed on a mobile computing device.

FIG. 14 is a flowchart showing operations for identifying a subject by matching a tracked subject to a user account using service location of a mobile computing device.

FIG. 15 is a flowchart showing operations for identifying a subject by matching a tracked subject to a user account using velocity of subjects and a mobile computing device.

FIG. 16A is a flowchart showing a first part of operations for matching a tracked subject to a user account using a network ensemble.

FIG. 16B is a flowchart showing a second part of operations for matching a tracked subject to a user account using a network ensemble.

FIG. 16C is a flowchart showing a third part of operations for matching a tracked subject to a user account using a network ensemble.

FIG. 17 is an example architecture in which the four techniques presented in FIGS. 13 to 16C are applied in an area of real space to reliably match a tracked subject to a user account.

FIGS. 18A, 18B, 18C and 18D present examples of analysis of subject tracks in the area of real space.

FIGS. 19A, 19B, 19C and 19D present examples of histogram and heatmaps that are generated based on subject tracks in the area of real space.

FIG. 20 presents various heatmaps with unique subjects identified per cell in a grid of the area of real space.

FIGS. 21A, 21B, 21C and 21D present various examples of semantic classifications of subareas or sections of the area of real space that can be performed using the technology disclosed.

FIGS. 22A, 22B, 22C, 22D, 22E, 22F, 22G, 22H, and 22I present a method for determining subject tracks and examples of subject tracks in the area of real space.

FIGS. 23A and 23B present graphs, comprising nodes and edges, illustrating connectedness of shelves in an area of real space.

FIGS. 24A and 24B present examples of transition matrix and accumulated paths of subject illustrated as heatmaps.

FIGS. 25A, 25B and 25C present examples of generating predicted paths for new subjects in the area of real space.

FIG. 26 presents a graphical representation of the shelves in the area of real space.

FIGS. 27A, 27B, 27C and 27D present impact on interactions of subjects with items on shelves when locations of shelves are changed in the area of real space.

FIG. 28 presents various features of the technology disclosed that provide useful insights related to subjects and interaction of subjects with items in the area of space.

FIG. 29 provides a flowchart presenting operations to process subject tracking data to support prediction of paths of subjects in the area of real space.

FIG. 30 is a process flowchart presenting operations for automatically generating and updating layouts of structures within a cashier-less store for autonomous checkout.

FIGS. 31A, 31B, 31C, 31D and 31E present examples of various types of maps and layouts for an area of real space.

FIGS. 32A and 32B present layouts of shelves in an area of real space and corresponding representations as network topologies.

### DETAILED DESCRIPTION

The following description is presented to enable any person skilled in the art to make and use the technology disclosed, and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

### System Overview

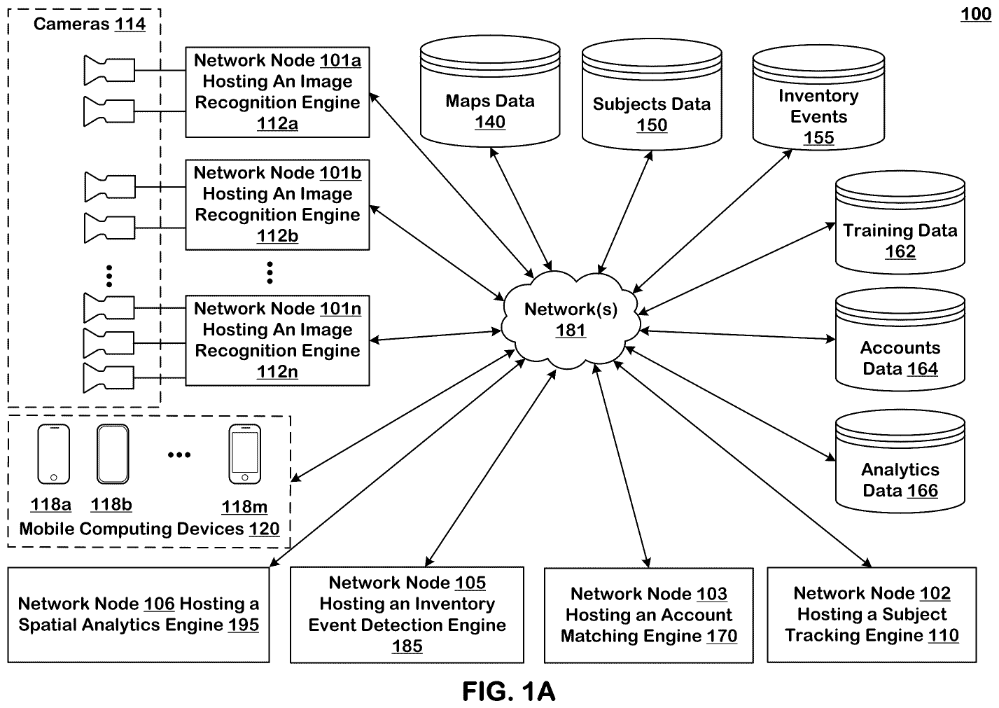

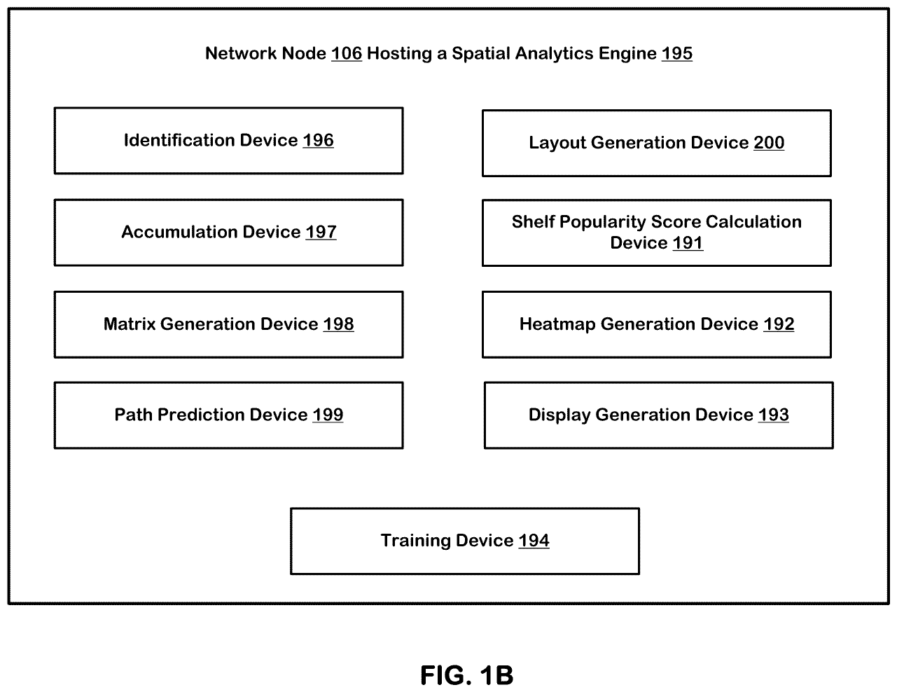

A system and various implementations of the subject technology are described with reference to FIGS. 1A-32B. The system and processes are described with reference to FIG. 1A, an architectural level schematic of a system in accordance with an implementation. Because FIG. 1A is an architectural diagram, certain details are omitted to improve the clarity of the description.

The description of FIG. 1A is organized as follows. First, the elements of the system are described, followed by their interconnections. Then, the use of the elements in the system is described in greater detail.

FIG. 1A provides a block diagram level illustration of a system 100. The system 100 includes cameras 114, network nodes 101a, 101b, and 101n hosting image recognition engines 112a, 112b, and 112n, a network node 102 hosting a subject tracking engine 110, a network node 103 hosting an account matching engine 170, a network node 105 hosting an inventory event detection 185 and a network node 106 hosting a spatial analytics engine 195. The network nodes 101a, 101b, 101n, 102, 103, 105 and/or 106 can include or have access to memory supporting tracking of subjects, matching anonymously tracked subjects to their user accounts, and analyzing subject tracks and inventory events data in the area of real space. The system 100 includes mobile computing devices 118a, 118b, 118m (collectively referred as mobile computing devices 120). The system 100 further includes, in this example, a maps database 140, a subjects database 150, an inventory events database 155, a training database 162, a user accounts database 164, an analytics database 166, and a communication network or networks 181. Each of the maps database 140, the subjects database 150, the inventory events database 155, the training database 162, the user accounts database 164 and the analytics database 166 can be stored in the memory that is accessible to the network nodes 101a, 101b, 101n. 102, 103, 105 and/or 106. The network nodes 101a, 101b, 101n, 102, 103, 105 and/or 106 can host only one image recognition engine, or several image recognition engines.

The system 100 can be deployed in a large variety of public spaces to anonymously track subjects and predict paths of new subject who enter the area of real space. For example, the technology disclosed can be used in shopping stores, airports, gas stations, convenience stores, shopping malls, sports arenas, railway stations, libraries, etc. An implementation of the technology disclosed is provided with reference to a cahier-less shopping stores also referred to as autonomous shopping stores. Such shopping stores may not have cashiers to process payments for shoppers. The shoppers may simply take items from shelves and walkout of the shopping store. In one instance, the shoppers may need to check-in or check-out from the store using their mobile devices. Some shopping stores may provide kiosks to facilitate the shoppers to check-in or check-out. The operations of a cashier-less shopping store can be improved by the store management having access to the subject tracking and inventory events data in a manner that provides information to answer questions such as which parts of the shopping store are more frequently visited, which parts of the store are rarely visited by shoppers, which inventory locations are frequently visited and which inventory locations are rarely visited. Similarly, it is beneficial for the store management to know the popular pedestrian paths in the store and how to attract the shoppers to visit the sections of the shopping store that are not frequently visited. Further, it is also beneficial for the store management to know the sections or parts of the store where shoppers frequently congregate or stand. The store management can use the information provided by the technology disclosed for arranging inventory display structures to avoid congestion in pedestrian paths and increase the flow of shoppers in the shopping store. The system 100 includes processing engines that process images captured by the sensors in the area of real space to detect subject and determine subject tracks in the area of real space. The system 100 also includes inventory event detection logic to detect which inventory items are being taken by shoppers from which inventory locations. The technology disclosed includes logic to process various types of maps of the area of real space, subject tracks and inventory events data to generate heatmaps, graphical representations and analytics data that can answer the questions listed above. The technology disclosed also includes additional processing engines such as heatmaps generator to present the analytics data as visual information overlaid on maps of the area of the real space.

The implementation described here uses cameras 114 in the visible range which can generate for example RGB color output images. In other implementations, different kinds of sensors are used to produce sequences of images. Examples of such sensors include, ultrasound sensors, thermal sensors, and/or Lidar, etc., which are used to produce sequences of images, point clouds, distances to subjects and inventory items and/or inventory display structures, etc. in the real space. The image recognition engines 112a, 112b, and 112n are also referred to as sensor fusion engines 112a, 112b, and 112n when sensors in the area of real space output non-image data such as point clouds or distances, etc. In one implementation, sensors can be used in addition to the cameras 114. Multiple sensors can be synchronized in time with each other, so that frames are captured by the sensors at the same time, or close in time, and at the same frame capture rate (or different rates). All of the implementations described herein can include sensors other than or in addition to the cameras 114.

As used herein, a network node (e.g., network nodes 101a, 101b, 101n, 102, 103, 104 and/or 105) is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Network nodes can be implemented in a cloud-based server system and/or a local system. More than one virtual device configured as a network node can be implemented using a single physical device.

The databases 140, 150, 155, 162, 164 and 166 are stored on one or more non-transitory computer readable media. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. Thus in FIG. 1, the databases 140, 150, 155, 162, 164 and 166 can be considered to be a single database. The system can include other databases such as a shopping cart database storing logs of items or shopping carts of shoppers in the area of real space, an items database storing data related to items (identified by unique SKUs) in a shopping store. The system can also include a calibration database storing various camera models with respective intrinsic and extrinsic calibration parameters for respective shopping stores or areas of real space.

For the sake of clarity, only three network nodes 101a, 101b and 101n hosting image recognition engines 112a, 112b, and 112n are shown in the system 100. However, any number of network nodes hosting image recognition engines can be connected to the subject tracking engine 110 through the network(s) 181. Similarly, the image recognition engines 112a, 112b, and 112n, the subject tracking engine 110, the account matching engine 170, the inventory event detection engine 185, the spatial analytics engine 195 and/or other processing engines described herein can execute various operations using more than one network node in a distributed architecture.

The interconnection of the elements of system 100 will now be described. Network(s) 181 couples the network nodes 101a, 101b, and 101n, respectively, hosting image recognition engines 112a, 112b, and 112n, the network node 102 hosting the subject tracking engine 110, the network node 103 hosting the account matching engine 170, the network node 105 hosting the inventory event detection engine 185, the network node 106 hosting the spatial analytics engine 195, the maps database 140, the subjects database 150, the inventory events database 155, the training database 162, the user accounts database 164, the analytics database 166 and the mobile computing devices 120. Cameras 114 are connected to the subject tracking engine 110, the account matching engine 170, the inventory event detection engine 185, and the spatial analytics engine 195 through network nodes hosting image recognition engines 112a. 112b, and 112n. In one implementation, the cameras 114 are installed in a shopping store, such that sets of cameras 114 (two or more) with overlapping fields of view are positioned to capture images of an area of real space in the store. Two cameras 114 can be arranged over a first aisle within the store, two cameras 114 can be arranged over a second aisle in the store, and three cameras 114 can be arranged over a third aisle in the store. Cameras 114 can be installed over open spaces, aisles, and near exits and entrances to the shopping store. In such an implementation, the cameras 114 can be configured with the goal that customers moving in the shopping store are present in the field of view of two or more cameras 114 at any moment in time. Examples of entrances and exits to the shopping store or the area of real space also include doors to restrooms, elevators or other designated unmonitored areas in the shopping store where subjects are not tracked.

Cameras 114 can be synchronized in time with each other, so that images are captured at the image capture cycles at the same time, or close in time, and at the same image capture rate (or a different capture rate). The cameras 114 can send respective continuous streams of images at a predetermined rate to network nodes 101a, 101b, and 101n hosting image recognition engines 112a, 112b and 112n. Images captured in all the cameras 114 covering an area of real space at the same time, or close in time, are synchronized in the sense that the synchronized images can be identified in processing engines 112a, 112b, 112n, 110, 170, 185 and/or 195 as representing different views of subjects having fixed positions in the real space. For example, in one implementation, the cameras 114 send image frames at the rates of 30 frames per second (fps) to respective network nodes 101a, 101b and 101n hosting image recognition engines 112a, 112b and 112n. Each frame has a timestamp, identity of the camera (abbreviated as “camera_id”), and a frame identity (abbreviated as “frame_id”) along with the image data. As described above other implementations of the technology disclosed can use different types of sensors such as image sensors, ultrasound sensors, thermal sensors, and/or Lidar, etc. Images can be captured by sensors at frame rates greater than 30 frames per second, such as 40 frames per second, 60 frames per second or even at higher image capturing rates. In one implementation, the images are captured at a higher frame rate when an inventory event such as a put or a take of an item is detected in the field of view of a camera 114. Images can also be captured at higher image capturing rates when other types of events are detected in the area of real space such as when entry or exit of a subject from the area of real space is detected or when two subjects are positioned close to each other, etc. In such an implementation, when no inventory event is detected in the field of view of a camera 114, the images are captured at a lower frame rate.

Cameras 114 are connected to respective image recognition engines 112a, 112b and 112n. For example, in FIG. 1A, the two cameras installed over the aisle 116a are connected to the network node 101a hosting an image recognition engine 112a. Likewise, the two cameras installed over aisle 116b are connected to the network node 101b hosting an image recognition engine 112b. Each image recognition engine 112a-112n hosted in a network node or nodes 101a-101n, separately processes the image frames received from one camera each in the illustrated example. In an implementation of a subject tracking system described herein, the cameras 114 can be installed overhead and/or at other locations, so that in combination the fields of view of the cameras encompass an area of real space in which the tracking is to be performed, such as in a shopping store.

In one implementation, each image recognition engine 112a, 112b and 112n is implemented as a deep learning algorithm such as a convolutional neural network (abbreviated CNN). In such an implementation, the CNN is trained using the training database 162. In an implementation described herein, image recognition of subjects in the area of real space is based on identifying and grouping features of the subjects such as joints, recognizable in the images, where the groups of joints (e.g., a constellation) can be attributed to an individual subject. For this joints-based analysis, a training database (not shown in FIG. 1) has a large collection of images for each of the different types of joints for subjects. In the example implementation of a shopping store, the subjects are the customers moving in the aisles between the shelves. In an example implementation, during training of the CNN, the system 100 is referred to as a “training system.” After training the CNN using the training database, the CNN is switched to production mode to process images of customers in the shopping store in real time.

In an example implementation, during production, the system 100 is referred to as a runtime system (also referred to as an inference system). The CNN in each image recognition engine produces arrays of joints data structures for images in its respective stream of images. In an implementation as described herein, an array of joints data structures is produced for each processed image, so that each image recognition engine 112a, 112b, and 112n produces an output stream of arrays of joints data structures. These arrays of joints data structures from cameras having overlapping fields of view are further processed to form groups of joints, and to identify such groups of joints as subjects. The subjects can be tracked by the system using a tracking identifier referred to as “tracking_id” or “track_ID” during their presence in the area of real space. The tracked subjects can be saved in the subjects database 150. As the subjects move around in the area of real space, the subject tracking engine 110 keeps track of movement of each subject by assigning track_IDs to subjects in each time interval (or identification interval). The subject tracking engine 110 identifies subjects in a current time interval and matches a subject from the previous time interval with a subject identified in the current time interval. The track_ID of the subject from the previous time interval is then assigned to the subject identified in the current time interval. Sometimes, the track_IDs are incorrectly assigned to one or more subjects in the current time interval due to incorrect matching of subjects across time intervals. A subject re-identification engine (not shown in FIG. 1) includes logic to detect the errors in assignment of track_IDs to subjects. The subject re-identification engine can then re-identify subjects that correctly match across the time intervals and assign correct track_IDs to subjects. Further details of the subject tracking engine 110.

Details of the various types of processing engines is presented below. These engines can comprise various devices that implement logic to perform operations to track subjects, detect and process inventory events and perform other operations related to a cashier-less store. A device (or an engine) described herein can include one or more processors. The ‘processor’ comprises hardware that runs a computer program code. Specifically, the specification teaches that the term ‘processor’ is synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

### Subject Tracking Engine

The subject tracking engine 110, hosted on the network node 102 receives, in this example, continuous streams of arrays of joints data structures for the subjects from image recognition engines 112a, 112b and 112n and can retrieve and store information from and to a subjects database 150 (also referred to as a subject tracking database). The subject tracking engine 110 processes the arrays of joints data structures identified from the sequences of images received from the cameras at image capture cycles. It then translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the subject tracking engine 110 is used to locate subjects in the area of real space during identification intervals. One image in each of the plurality of sequences of images, produced by the cameras, is captured in each image capture cycle.

The subject tracking engine 110 uses logic to determine groups or sets of candidate joints having coordinates in real space as subjects in the real space. For the purposes of analogy, each set of candidate points is like a constellation of candidate joints at each point in time. In one implementation, these constellations of joints are generated per identification interval as representing a located subject. Subjects are located during an identification interval using the constellation of joints. The constellations of candidate joints can move over time. A time sequence analysis of the output of the subject tracking engine 110 over a period of time, such as over multiple temporally ordered identification intervals (or time intervals), identifies movements of subjects in the area of real space. The system can store the subject data including unique identifiers, joints and their locations in the real space in the subjects database 150.

In an example implementation, the logic to identify sets of candidate joints (i.e., constellations) as representing a located subject comprises heuristic functions is based on physical relationships amongst joints of subjects in real space. These heuristic functions are used to locate sets of candidate joints as subjects. The sets of candidate joints comprise individual candidate joints that have relationships according to the heuristic parameters with other individual candidate joints and subsets of candidate joints in a given set that has been located, or can be located, as an individual subject.

Located subjects in one identification interval can be matched with located subjects in other identification intervals based on location and timing data that can be retrieved from and stored in the subjects database 150. Located subjects matched this way are referred to herein as tracked subjects, and their location can be tracked in the system as they move about the area of real space across identification intervals. In the system, a list of tracked subjects from each identification interval over some time window can be maintained, including for example by assigning a unique tracking identifier to members of a list of located subjects for each identification interval, or otherwise. Located subjects in a current identification interval are processed to determine whether they correspond to tracked subjects from one or more previous identification intervals. If they are matched, then the location of the tracked subject is updated to the location of the current identification interval. Located subjects not matched with tracked subjects from previous intervals are further processed to determine whether they represent newly arrived subjects, or subjects that had been tracked before, but have been missing from an earlier identification interval.

Tracking all subjects in the area of real space is important for operations in a cashier-less store. For example, if one or more subjects in the area of real space are missed and not tracked by the subject tracking engine 110, it can lead to incorrect logging of items taken by the subject, causing errors in generation of an item log (e.g., shopping list or shopping cart data) for this subject. The technology disclosed can implement a subject persistence engine (not shown in FIG. 1) to find any missing subjects in the area of real space.

Another issue in tracking of subjects is incorrect assignment of track_IDs to subjects caused by swapping of tracking identifiers (track_IDs) amongst tracked subjects. This can happen more often in crowded spaces and places with high frequency of entries and exits of subjects in the area of real space. A subject-reidentification engine (not shown in FIG. 1) includes logic to detect errors when tracking identifiers are swapped and/or incorrectly assigned to one or more subjects. The subject re-identification engine can correct the tracking errors by matching the subjects across time intervals across multiple cameras 114. The subject re-identification engine performs the matching of subjects using feature vectors (or re-identification feature vectors) generated by one or more trained machine learning models. Therefore, the subject re-identification engine processes image frames captured by cameras which is separate from the processing of image frames by the subject tracking engine 110 to match subjects across time intervals. The technology disclosed provides a robust mechanism to correct any tracking errors and incorrect assignment of tracking identifiers to tracked subjects in the area of real space.

### Inventory Event Detection Engine

In the example of a shopping store the subjects (or shoppers) move in the aisles and in open spaces. The subjects take items from inventory locations on shelves in inventory display structures. In one example of inventory display structures, shelves are arranged at different levels (or heights) from the floor and inventory items are stocked on the shelves. The shelves can be fixed to a wall or placed as freestanding shelves forming aisles in the shopping store. Other examples of inventory display structures include, pegboard shelves, magazine shelves, lazy susan shelves, warehouse shelves, and refrigerated shelving units. The inventory items can also be stocked in other types of inventory display structures such as stacking wire baskets, dump bins, etc. The customers can also put items back on the same shelves from where they were taken or on another shelf.

The inventory event detection engine 185 uses the sequences of image frames produced by cameras in the plurality of cameras 114 to identify gestures by detected subjects in the area of real space over a period of time and produce inventory events including data representing identified gestures. The inventory events can be stored as entries in the inventory events database 155. An inventory event can include a subject identifier identifying a detected subject, a gesture type (e.g., a put or a take) of the identified gesture by the detected subject, an item identifier identifying an inventory item linked to the gesture by the detected subject, a location of the gesture represented by positions in three dimensions of the area of real space and a timestamp for the gesture. The inventory event data is stored in the inventory events database 155.

### Spatial Analytics Engine

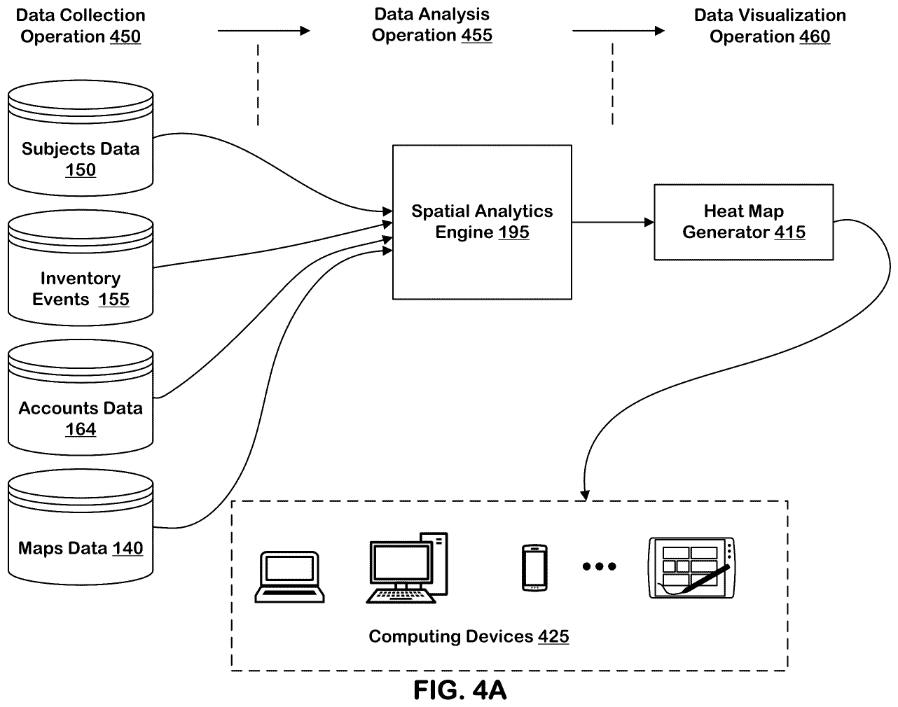

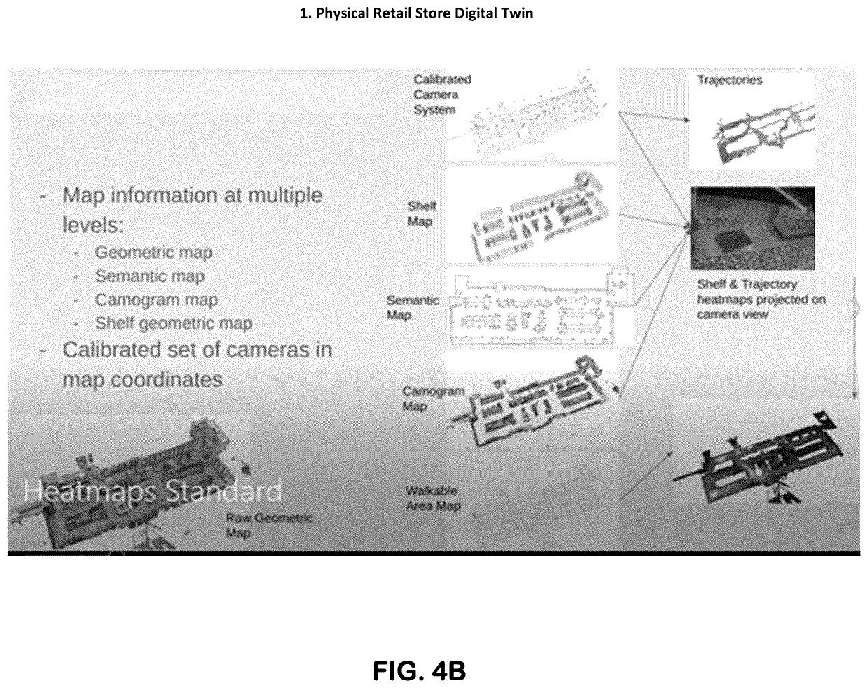

The spatial analytics engine 195 includes logic to process various types of maps of the area of real space, subject tracks of the subjects in the area of real space and inventory events data to generate heatmaps and other types of correlations between inventory items, inventory locations and subjects in the area of real space. The analytics data can then be stored in an analytics database 166 for further analysis and for generating heatmaps or other types of visualization. The analytics data can provide various types of information regarding subjects (or shoppers), inventory items, inventory locations and various sections of the area of area real space. This data can be used by store management for increasing flow of shoppers in the area of real space, arrangement of inventory display structures, and placement of items on inventory items on inventory display structures to increase the sale of items placed in various sections of the real space. The analytics data is also useful for product manufacturers and product distributors to understand the interest of shoppers in their products. The analytics data can be provided as input to other data processing engines such as a heatmap generator which is described with reference to FIG. 4A.

The analytics data can provide different types of information related to the inventory items at multiple locations in the area of real space. In the example of a shopping store, the analytics data can identify the counts of inventory events including the particular inventory item in multiple locations in a selected period of time such as an hour, a day or a week. Other examples of include percentages of inventory events including the particular inventory item at multiple locations or levels relative to a threshold count of inventory events including the particular item in multiple locations. Such information is useful for the store management to determine locations in the store from where the particular inventory item is being taken more frequently. The analytics data can be used by the heatmap generator to generate visualizations of subjects and inventory events in the area of real space. Examples of heatmaps and other types of visualizations are presented below. The store management can plan placement of inventory items, arrangement of inventory display structures and arrangement of pedestrian paths in the area of real space by using the analytics data and heatmaps of the area of real space.

### Subject Persistence Processing Engine

Tracking all subjects in the area of real space is beneficial for operations in a cashier-less store. For example, if one or more subjects in the area of real space are missed and not tracked by the subject tracking engine 110, it can lead to incorrect logging of items taken by the subject, causing errors in generation of an item log (e.g., shopping list or shopping cart data) for this subject. The technology disclosed can implement a subject persistence engine (not shown in FIG. 1) to find any missing subjects in the area of real space.

For the purposes of tracking subjects, the subject persistence processing engine compares the newly located (or newly identified) subjects in the current identification interval with one or more preceding identification intervals. The system includes logic to determine if the newly located subject is a missing tracked subject previously tracked in an earlier identification interval and stored in the subjects database but who was not matched with a located subject in an immediately preceding identification interval. If the newly located subject in the current identification interval is matched to the missing tracked subject located in the earlier identification interval, the system updates the missing tracked subject in the subject database 150 using the candidate located subject located from the current identification interval.

In one implementation, in which the subject is represented as a constellation of joints as discussed above, the positions of the joints of the missing tracked subject is updated in the database with the positions of the corresponding joints of the candidate located subject located from the current identification interval. In this implementation, the system stores information for tracked subject in the subjects database 150. This can include information such as the identification intervals in which the tracked subject is located. Additionally, the system can also store, for a tracked subject, the identification intervals in which the tracked subject is not located. In another implementation, the system can store missing tracked subjects in a missing subjects database, or tag tracked subjects as missing, along with additional information such as the identification interval in which the tracked subject went missing and last known location of the missing tracked subject in the area of real space. In some implementations, the subject status as tracked and located, can be stored per identification interval.

The subject persistence processing engine can process a variety of subject persistence scenarios. For example, a situation in which more than one candidate located subjects are located in the current identification interval but not matched with tracked subjects, or a situation when a located subject moves to a designated unmonitored location in the area of real space but reappears after some time and is located near the designated unmonitored location in the current identification interval. The designated unmonitored location in the area of real space can be a restroom, for example. The technology can use persistence heuristics to perform the above analysis. In one implementation, the subject persistence heuristics are stored in a persistence heuristics database.

### Subject Re-Identification Engine

Another issue in tracking of subjects is incorrect assignment of track_IDs to subjects caused by swapping of tracking identifiers (track_IDs) amongst tracked subjects. This can happen more often in crowded spaces and places with high frequency of entries and exits of subjects in the area of real space. The technology disclosed can implement a subject-reidentification engine (not shown in FIG. 1A) that includes logic to detect errors when tracking identifiers are swapped and/or incorrectly assigned to one or more subjects. The subject re-identification engine can correct the tracking errors by matching the subjects across time intervals across multiple cameras 114. The subject re-identification engine performs the matching of subjects using feature vectors (or re-identification feature vectors) generated by one or more trained machine learning models. Therefore, the subject re-identification engine processes image frames captured by cameras which is separate from the processing of image frames by the subject tracking engine 110 to match subjects across time intervals. The technology disclosed provides a robust mechanism to correct any tracking errors and incorrect assignment of tracking identifiers to tracked subjects in the area of real space. Details of both subject persistence and subject re-identification technologies are presented below. Note that any one of these technologies can be deployed independently in a cashier-less shopping store. Both subject persistence and subject re-identification technologies can be used simultaneously as well to address the issues related to missing subjects and swapped tracking identifiers.

The subject re-identification engine can detect a variety of errors related to incorrect assignments of track_IDs to subjects. The subject tracking engine 110 tracks subjects represented as constellation of joints. Errors can occur when tracked subjects are closely positioned in the area of real space. One subject may fully or partially occlude one or more other subjects. The subject tracking engine 110 can assign incorrect track_IDs to subjects over a period of time. For example, track_ID “X” assigned to a first subject in a first time interval can be assigned to a second subject in a second time interval. A time interval can be a period of time such as from a few milli seconds to a few seconds. There can be other time intervals between the first time interval and the second time interval. Any image frame captured during any time interval can be used for analysis and processing. A time interval can also represent one image frame at a particular time stamp. If the errors related to incorrect assignment of track_IDs are not detected and fixed, the subject tracking can result in generation of incorrect item logs associated with subjects, resulting in incorrect billing of items taken by subjects. The subject re-identification engine detects errors in assignment of track_IDs to subjects over multiple time intervals in a time duration during which the subject is present in the area of real space, e.g., a shopping store, a sports arena, an airport terminal, a gas station, etc.

The subject re-identification engine can receive image frames from cameras 114 with overlapping fields of view. The subject re-identification engine can include logic to pre-process the image frames received from the cameras 114. The pre-processing can include placing bounding boxes around at least a portion of the subject identified in the image. The bounding box logic attempts to include the entire pose of the subject within the boundary of the bounding box e.g., from the head to the feet of the subject and including left and right hands. However, in some cases, a complete pose of a subject may not be available in an image frame due to occlusion, location of the camera (e.g., the field of view of the camera) etc. In such instance, a bounding box can be placed around a partial pose of the subject. In some cases, a previous images frame or a next image frame in a sequence of image frames from a camera can be selected for cropping out images of subjects in bounding boxes. Examples of poses of subjects that can be captured in bounding boxes include a front pose, a side pose, a back pose, etc.

The cropped out images of subjects can be provided to a trained machine learning model to generate re-identification feature vectors. The re-identification feature vector encodes visual features of the subject's appearance. The technology disclosed can use a variety of machine learning models. ResNet (He et al. CVPR 2016 available at <<arxiv.org/abs/1512.03385>>) and VGG (Simonyan et al. 2015 available at <<arxiv.org/abs/1409.1556>>) are examples of convolutional neural networks (CNNs) that can be used to identify and classify objects. In one implementation, ResNet-50 architecture of ResNet Model (available at <<github.com/layumi/Person_reID_baseline_pytorch>>) is used to encode visual features of subjects. The model can be trained using open source training data or custom training data. In one implementation, the training data is generated using scenes (or videos) recorded in a shopping store. The scenes comprise different scenarios with a variety of complexity. For example, different scenes are generated using one person, three persons, five persons, ten persons, and twenty five persons, etc. Image frames are extracted from the scenes and labeled with tracking errors to generate ground truth data for training of the machine learning model. The training data set can include videos or sequences of image frames captured by cameras in the area of real space. The labels of the training examples can be subject tracking identifiers per image frame for the subjects detected in respective image frames. In one implementation, the training examples can include tracking errors (e.g., swap error, single swap error, split error, enter-exit swap error, etc.) detected per image frame. In this case, the labels of the training examples can include errors detected in respective image frames. The training dataset can be used to train the subject re-identification engine.

The subject re-identification engine includes logic to match re-identification feature vectors for a subject in a second time interval with re-identification feature vectors of subjects in a first time interval to determine if the tracking identifier is correctly assigned to the subject in the second time interval. The matching includes calculating a similarity score between respective re-identification feature vectors. Different similarity measures can be applied to calculate the similarity score. For example, in one case the subject re-identification engine calculates a cosine similarity score between two re-identification feature vectors. Higher values of cosine similarity scores indicate a higher probability that the two re-identification feature vectors represent a same subject in two different time intervals. The similarity score can be compared with a pre-defined threshold for matching the subject in the second time interval with the subject in the first time interval. In one implementation, the similarity score values range from negative 1.0 to positive 1.0 [−1.0, 1.0]. The threshold values can be set at 0.5 or higher than 0.5. Different values of the threshold can be used during training of the machine learning model to select a value for use in production or inference. The threshold values can dynamically change in dependence upon time of day, locations of camera, density (e.g., number) of subjects within the store, etc. In one implementation, the threshold values range from 0.35 to 0.5. A specific value of the threshold can be selected for a specific production use case based on tradeoff between model performance parameters such as precision and recall for detecting errors in subject tracking. Precision and recall values can be used to determine performance of a machine learning model. Precision parameter indicates proportion of errors that are correctly detected as errors. A precision of 0.8 indicates that when a model or a classifier detects an error, it correctly detects the error 80 percent of the time. Recall on the other hand indicates the proportion of all errors that are correctly detected by the model. For example, a recall value of 0.1 indicates that the model detects 10 percent of all errors in the training data. As threshold values are increased, the subject re-identification engine can detect more tracking errors but such errors can include false positive detections. When threshold values are reduced fewer tracking errors are detected by the subject re-identification engine. Therefore, higher values of threshold result in better recall results and lower threshold values result in better precision results. Threshold values are selected to strike a balance between the two performance parameters. Other ranges of threshold values that can be used include, 0.25 to 0.6 or 0.15 to 0.7.

In one implementation, the image analysis is anonymous, i.e., a unique tracking identifier assigned to a subject created through joints analysis does not identify personal identification details (such as names, email addresses, mailing addresses, credit card numbers, bank account numbers, driver's license number, etc.) of any specific subject in the real space. The data stored in the subjects database 150 does not include any personal identification information. The operations of the technology disclosed including subject tracking, subject persistence and subject re-identification do not use any personal identification including biometric information associated with the subjects.

### Account Matching Engine

In one implementation, the tracked subjects are identified by linking them to respective “user accounts” containing for example preferred payment method provided by the subject. When linked to a user account, a tracked subject is characterized herein as an identified subject. Track subjects are linked with items picked up on the store, and linked with a user account, for example, and upon exiting the store, an invoice can be generated and delivered to the identified subject, or a financial transaction executed online to charge the identified subject using the payment method associated to their accounts. The identified subjects can be uniquely identified, for example, by unique account identifiers or subject identifiers, etc. In the example of a cashier-less store, as the customer completes shopping by taking items from the shelves, the system processes payment of items bought by the customer.

The system includes the account matching engine 170 (hosted on the network node 103) to process signals received from mobile computing devices 120 (carried by the subjects) to match the identified subjects with user accounts. The account matching can be performed by identifying locations of mobile devices executing client applications in the area of real space (e.g., the shopping store) and matching locations of mobile devices with locations of subjects, without use of personal identifying biometric information from the images.

The actual communication path to the network node 102 hosting the subject tracking engine 110, the network node 103 hosting the account matching engine 170, the network node 105 hosting the inventory event detection engine 185 and the network node 106 hosting the spatial analytics engine 195, through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming. MPI primitives, etc. or different scalable batch and stream management systems like Apache Storm™, Apache Spark™, Apache Kafka™, Apache Flink™, Truviso™, Amazon Elasticsearch Service™, Amazon Web Services™ (AWS), IBM Info-Sphere™, Borealis™, and Yahoo! S4™.

FIG. 1B presents components (such as devices) of the spatial analytics engine 195. The spatial analytics engine comprises various devices that implement logic for predicting path of new subjects in the area of real space (such as the shopping store). A device (or an engine) described herein can include one or more processors. The ‘processor’ comprises hardware that runs a computer program code. Specifically, the specification teaches that the term ‘processor’ is synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

An identification device 196 comprises logic to identify, for a particular subject, a determined path in the area of real space over a period of time using the sequences of frames produced by sensors in the plurality of sensors. The determined path can be described by a subject track or subject tracking data. The determined path (or the subject track) can include a subject identifier, one or more locations in the area of real space and one or more timestamps. The subject track can also include other information such as total accumulated time for which the subject is in the area of real space at any given point in time. The subject track can also include data about interaction of subject with items placed on shelves or at other types of inventory display structures. The interactions can include touching an item, taking an item, putting a taken item back on a shelf, handing over an item to another subject, putting an item in a shopping cart or a shopping basket etc.

An accumulation device 197 comprises logic to accumulate multiple determined paths for multiple subjects over a period of time. The period of time can range from five minutes to six months or more. The accumulation device can also accumulate determined paths for different time periods such as morning (6 AM to 12 Noon), afternoon (12 Noon to 6 PM), evening (6 PM to 12 AM), etc. Time periods smaller than six hours or greater than six hours can be used. This information can provide useful data for store owners or store managers about which areas of the store are busier in different time periods of the day. Such analysis can be performed for days of the week to determine shoppers behavior during different days of the week.

A matrix generation device 198 comprises logic to generate a transition matrix using the accumulated determined paths. An element in the transition matrix identifies a probability of a new subject moving from a first location to at least one of other locations in the area of real space. By repeatedly applying the above logic, a complete path of a subject starting from a first shelf visited to a last shelf visited can be generated using the transition matrix.

A path prediction device 199 comprises logic to predict the path of a new subject in the area of real space in dependence on an interaction of the new subject with an item associated with the first location in the area of real space. The predicting of the path comprises identifying a second location, from the other locations included in the transition matrix, having a highest probability associated therewith with respect to movement of the new subject from the first location. The second location can be identified having a second highest probability associated therewith with respect to movement of the new subject from the first location. The second location can also be identified having a third highest probability associated therewith with respect to movement of the new subject from the first location. It is understood that the path prediction device can select any shelf as a second location for predicting the path of the subject. The path prediction device further includes logic to identify a third location, from the other locations included in the transition matrix, having a highest probability associated therewith with respect to movement of the new subject from the second location. The third location can be identified having a second highest probability associated therewith with respect to movement of the new subject from the first location. The third location can also be identified having a third highest probability associated therewith with respect to movement of the new subject from the first location. It is understood that the path prediction device can select any shelf as a third location for predicting the path of the subject. The path prediction device further includes logic to determine the interaction of the new subject with the item when an angle between a plane connecting shoulder joints of the new subject is greater than or equal to 40 degrees and less than or equal to 50 degrees corresponding to a plane representing a front side of a shelf at the first location and when a speed of the subject is greater than or equal to 0.15 meters per second and less than or equal to 0.25 meters per second and when a distance of the subject is less than or equal to 1 meter from the shelf at the first location. The path prediction device comprises logic to generate the predicted path for the new subject starting from a location of a first shelf with which the subject interacted and ending at an exit location from the area of real space. The path prediction device further comprises logic to generate the predicted path for the new subject starting from an entrance to the area of real space and ending at an exit location from the area of real space.

A layout generation device 200 comprises logic to change a preferred placement of a particular item, in dependence on the predicted path, from an existing location to a new location in the area of real space to increase interaction of future subjects with the particular item. The layout generation device further includes logic to change a preferred placement of a shelf containing the particular item, in dependence on the predicted path, from an existing location to a new location in the area of real space to increase interaction of the future subjects with the particular item contained within the shelf.

A shelf popularity score calculation device 191 includes logic to increment a count of visits to a particular shelf whenever the interaction is determined for the particular shelf. The shelf popularity score calculation device can use the count of visits to the particular shelf over a period of time to determine a shelf popularity score for the particular shelf. The shelf popularity score can be calculated for the particular shelf at different times of a day and at different days of a week.

A heatmap generation device 192 includes logic to generate a heatmap for the area of real space in dependence on a count of interactions of all subjects in the area of real space with all shelves in the area of real space.

A display generation device 193 includes logic to display a graphical representation of connectedness of shelves in the area of real space. The graphical representation can comprise nodes representing shelves in the area of real space and edges connecting the nodes representing distances between respective shelves weighted by respective elements of the transition matrix. In response to changing a location of a shelf in the area of real space, the display generation device further includes logic to display an updated graphical representation by recalculating the edges connecting the shelf to other shelves in the area of real space.

A training device 194 includes logic to train a machine learning model for predicting the path of the subject in the area of real space. The training device includes logic to provide as input, to the machine learning model, labeled examples from training data, wherein an example in the labeled examples comprises at least one determined path from the accumulated multiple paths for multiple subjects. The training device includes logic to provide as input to the machine learning mode, a map of the area of real space comprising locations of shelves in the area of real space. The training device includes logic to provide as input to the machine learning model, labels of products associated with respective shelves in the area of real space. The trained machine learning model can be used to predict the path of the new subject in the area of real space by providing by providing, as input to the trained machine learning model, at least one interaction of the new subject with an item associated with the first location in the area of real space.

### Camera Arrangement

The cameras 114 are arranged to track subjects (or entities) in a three dimensional (abbreviated as 3D) real space. In the example implementation of the shopping store, the real space can include the area of the shopping store where items for sale are stacked in shelves. A point in the real space can be represented by an (x, y, z) coordinate system. Each point in the area of real space for which the system is deployed is covered by the fields of view of two or more cameras 114.

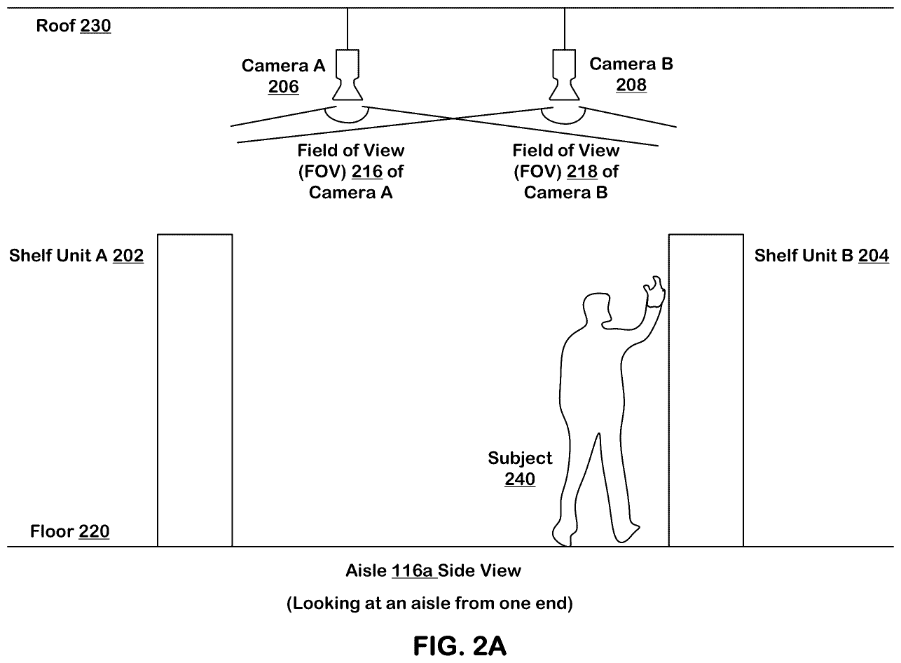

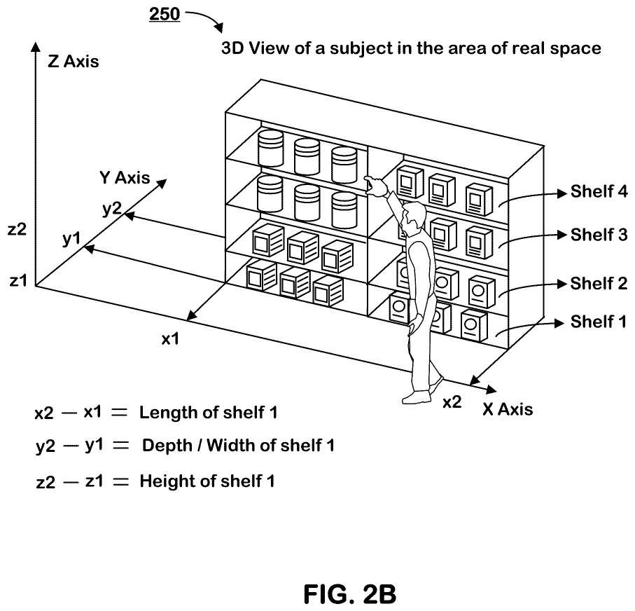

In a shopping store, the shelves and other inventory display structures can be arranged in a variety of manners, such as along the walls of the shopping store, or in rows forming aisles or a combination of the two arrangements. FIG. 2A shows an arrangement of shelf unit A 202 and shelf unit B 204, forming an aisle 116a, viewed from one end of the aisle 116a. Two cameras, camera A 206 and camera B 208 are positioned over the aisle 116a at a predetermined distance from a roof 230 and a floor 220 of the shopping store above the inventory display structures, such as shelf units A 202 and shelf unit B 204. The cameras 114 comprise cameras disposed over and having fields of view encompassing respective parts of the inventory display structures and floor area in the real space. For example, the field of view 216 of camera A 206 and field of view 218 of camera B 208 overlap as shown in FIG. 2A. The locations of subjects are represented by their positions in three dimensions of the area of real space. In one implementation, the subjects are represented as constellation of joints in real space. In this implementation, the positions of the joints in the constellation of joint are used to determine the location of a subject in the area of real space. The cameras 114 can be any of Pan-Tilt-Zoom cameras, 360-degree cameras, and/or combinations thereof that can be installed in the real space.

In the example implementation of the shopping store, the real space can include the entire floor 220 in the shopping store. Cameras 114 are placed and oriented such that areas of the floor 220 and shelves can be seen by at least two cameras. The cameras 114 also cover floor space in front of the shelves 202 and 204. Camera angles are selected to have both steep perspective, straight down, and angled perspectives that give more full body images of the customers. In one example implementation, the cameras 114 are configured at an eight (8) foot height or higher throughout the shopping store. In one implementation, the area of real space includes one or more designated unmonitored locations such as restrooms.

Entrances and exits for the area of real space, which act as sources and sinks of subjects in the subject tracking engine, are stored in the maps database. Also, designated unmonitored locations are not in the field of view of cameras 114, which can represent areas in which tracked subjects may enter, but must return into the area being tracked after some time, such as a restroom. The locations of the designated unmonitored locations are stored in the maps database 140. The locations can include the positions in the real space defining a boundary of the designated unmonitored location and can also include location of one or more entrances or exits to the designated unmonitored location. Examples of entrances and exits to the shopping store or the area of real space also include doors to restrooms, elevators or other designated unmonitored areas in the shopping store where subjects are not tracked.

### Three Dimensional Scene Generation

In FIG. 2A, a subject 240 is standing by an inventory display structure shelf unit B 204, with one hand positioned close to a shelf (not visible) in the shelf unit B 204. FIG. 2B is a perspective view of the shelf unit B 204 with four shelves, shelf 1, shelf 2, shelf 3, and shelf 4 positioned at different levels from the floor. The inventory items are stocked on the shelves.

A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration. The system combines 2D images from two or more cameras to generate the three dimensional positions of joints in the area of real space. This section presents a description of the process to generate 3D coordinates of joints. The process is also referred to as 3D scene generation.

Before using the system 100 in training or inference mode to track the inventory items, two types of camera calibrations: internal and external, are performed. In internal calibration, the internal parameters of the cameras 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000.

In external calibration, the external camera parameters are calibrated in order to generate mapping parameters for translating the 2D image data into 3D coordinates in real space. In one implementation, one subject (also referred to as a multi-joint subject), such as a person, is introduced into the real space. The subject moves through the real space on a path that passes through the field of view of each of the cameras 114. At any given point in the real space, the subject is present in the fields of view of at least two cameras forming a 3D scene. The two cameras, however, have a different view of the same 3D scene in their respective two-dimensional (2D) image planes. A feature in the 3D scene such as a left-wrist of the subject is viewed by two cameras at different positions in their respective 2D image planes.

A point correspondence is established between every pair of cameras with overlapping fields of view for a given scene. Since each camera has a different view of the same 3D scene, a point correspondence is two pixel locations (one location from each camera with overlapping field of view) that represent the projection of the same point in the 3D scene. Many point correspondences are identified for each 3D scene using the results of the image recognition engines 112a, 112b, and 112n for the purposes of the external calibration. The image recognition engines identify the position of a joint as (x, y) coordinates, such as row and column numbers, of pixels in the 2D image space of respective cameras 114. In one implementation, a joint is one of 19 different types of joints of the subject. As the subject moves through the fields of view of different cameras, the subject tracking engine 110 receives (x, y) coordinates of each of the 19 different types of joints of the subject used for the calibration from cameras 114 per image.

For example, consider an image from a camera A and an image from a camera B both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one subject in the field of view of camera A and camera B during calibration, key joints of this subject are identified, for example, the center of left wrist. If these key joints are visible in image frames from both camera A and camera B then it is assumed that these represent corresponding points. This process is repeated for many image frames to build up a large collection of corresponding points for all pairs of cameras with overlapping fields of view. In one implementation, images are streamed off of all cameras at a rate of 30 FPS (frames per second) or more and a resolution of 720 pixels in full RGB (red, green, and blue) color. These images are in the form of one-dimensional arrays (also referred to as flat arrays).

The large number of images collected above for a subject is used to determine corresponding points between cameras with overlapping fields of view. Consider two cameras A and B with overlapping field of view. The plane passing through camera centers of cameras A and B and the joint location (also referred to as feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the subject tracking engine 110 to identify the same joints in outputs (arrays of joint data structures, which are data structures that include information about physiological and other types of joints of a subject) of different image recognition engines 112a, 112b and 112n, processing images of cameras 114 with overlapping fields of view. The results of the internal and external camera calibration are stored in a calibration database.

A variety of techniques for determining the relative positions of the points in images of cameras 114 in the real space can be used. For example, Longuet-Higgins published, “A computer algorithm for reconstructing a scene from two projections” in Nature, Volume 293, 10 Sep. 1981. This paper presents computing a three-dimensional structure of a scene from a correlated pair of perspective projections when spatial relationship between the two projections is unknown. Longuet-Higgins paper presents a technique to determine the position of each camera in the real space with respect to other cameras. Additionally, their technique allows triangulation of a subject in the real space, identifying the value of the z-coordinate (height from the floor) using images from cameras 114 with overlapping fields of view. An arbitrary point in the real space, for example, the end of a shelf unit in one corner of the real space, is designated as a (0, 0, 0) point on the (x, y, z) coordinate system of the real space.

In an implementation of the technology, the parameters of the external calibration are stored in two data structures. The first data structure stores intrinsic parameters. The intrinsic parameters represent a projective transformation from the 3D coordinates into 2D image coordinates. The first data structure contains intrinsic parameters per camera as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the cameras 114.

```
{
  1: {
    K: [[x, x, x], [x, x, x], [x, x, x]],
    distortion_coefficients: [x, x, x, x, x, x, x, x]
  },
}
```

The camera recalibration method can be applied to 360 degree or high field of view cameras. The radial distortion parameters described above can model the (barrel) distortion of a 360 degree camera. The intrinsic and extrinsic calibration process described here can be applied to the 360 degree cameras. However, the camera model using these intrinsic calibration parameters (data elements of K and distortion coefficients) can be different.

The second data structure stores per pair of cameras: a 3×3 fundamental matrix (F), a 3×3 essential matrix (E), a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two images of the same scene that constrains where the projection of points from the scene can occur in both images. Essential matrix is also a relationship between two images of the same scene with the condition that the cameras are calibrated. The projection matrix gives a vector space projection from 3D real space to a subspace. The rotation matrix is used to perform a rotation in Euclidean space. Translation vector “t” represents a geometric transformation that moves every point of a figure or a space by the same distance in a given direction. The homography_floor_coefficients are used to combine images of features of subjects on the floor 220 viewed by cameras with overlapping fields of views. The second data structure is shown below. Similar data is stored for all pairs of cameras. As indicated previously, the x's represents numeric floating point numbers.

```
{
  1: {
    2: {
      F: [[x, x, x], [x, x, x], [x, x, x]],
      E: [[x, x, x], [x, x, x], [x, x, x]],
      P: [x, x, x, x], [x, x, x, x], [x, x, x, x]],
      R: [[x, x, x], [x, x, x], [x, x, x]],
      t: [x, x, x],
      homography_floor_coefficients: [x, x, x, x, x, x, x, x]
    }
  },
  .......
}
```

### Two Dimensional and Three Dimensional Maps

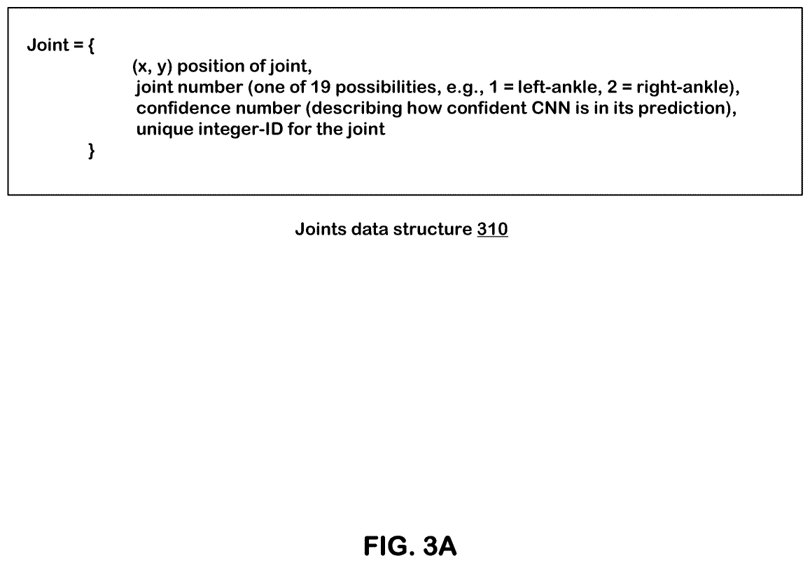

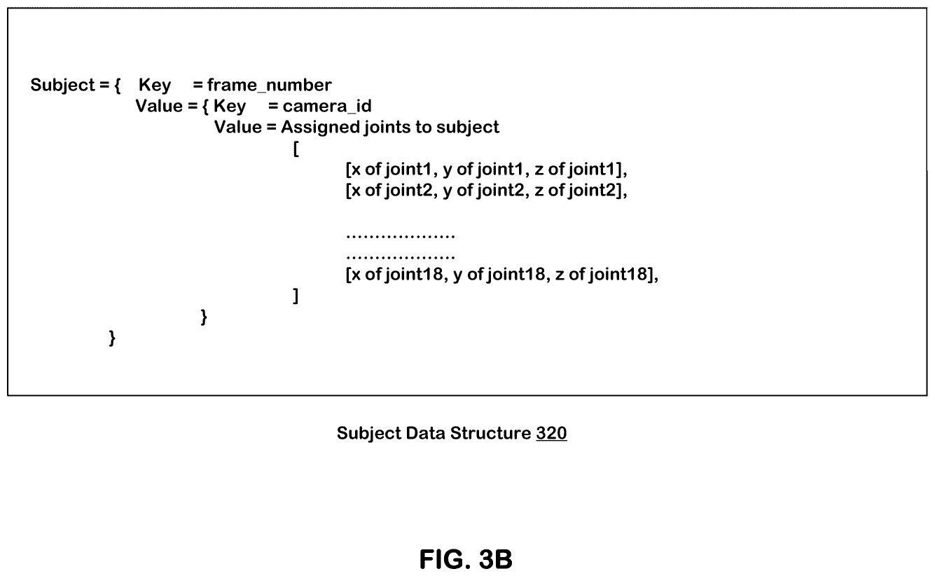

An inventory location, such as a shelf, in a shopping store can be identified by a unique identifier in a map database (e.g., shelf_id). Similarly, a shopping store can also be identified by a unique identifier (e.g., store_id) in a map database. The two dimensional (2D) and three dimensional (3D) maps database 140 identifies inventory locations in the area of real space along the respective coordinates. For example, in a 2D map, the locations in the maps define two dimensional regions on the plane formed perpendicular to the floor 220 i.e., XZ plane as shown in FIG. 2B. The map defines an area for inventory locations where inventory items are positioned. In FIG. 3, a 2D location of the shelf unit shows an area formed by four coordinate positions (x1, y1), (x1, y2), (x2, y2), and (x2, y1). These coordinate positions define a 2D region on the floor 220 where the shelf is located. Similar 2D areas are defined for all inventory display structure locations, entrances, exits, and designated unmonitored locations in the shopping store. This information is stored in the maps database 140.

In a 3D map, the locations in the map define three dimensional regions in the 3D real space defined by X, Y, and Z coordinates. The map defines a volume for inventory locations where inventory items are positioned. In FIG. 2B, a 3D view (250) of shelf 1 in the shelf unit shows a volume formed by eight coordinate positions (x1, y1, z1), (x1, y1, z2), (x1, y2, z1), (x1, y2, z2), (x2, y1, z1), (x2, y1, z2), (x2, y2, z1), (x2, y2, z2) defining a 3D region in which inventory items are positioned on the shelf 1. Similar 3D regions are defined for inventory locations in all shelf units in the shopping store and stored as a 3D map of the real space (shopping store) in the maps database 140. The coordinate positions along the three axes can be used to calculate length, depth and height of the inventory locations as shown in FIG. 2B.

In one implementation, the map identifies a configuration of units of volume which correlate with portions of inventory locations on the inventory display structures in the area of real space. Each portion is defined by starting and ending positions along the three axes of the real space. Like 2D maps, the 3D maps can also store locations of all inventory display structure locations, entrances, exits and designated unmonitored locations in the shopping store.

The items in a shopping store are arranged in some implementations according to a planogram which identifies the inventory locations (such as shelves) on which a particular item is planned to be placed. For example, as shown in an illustration 250 in FIG. 2B, a left half portion of shelf 3 and shelf 4 are designated for an item (which is stocked in the form of cans).

### Joints Data Structure

The image recognition engines 112a-112n receive the sequences of images from cameras 114 and process images to generate corresponding arrays of joints data structures. The system includes processing logic that uses the sequences of images produced by the plurality of camera to track locations of a plurality of subjects (or customers in the shopping store) in the area of real space. In one implementation, the image recognition engines 112a-112n identify one of the 19 possible joints of a subject at each element of the image, usable to identify subjects in the area who may be moving in the area of real space, standing and looking at an inventory item, or taking and putting inventory items. The possible joints can be grouped in two categories: foot joints and non-foot joints. The 19th type of joint classification is for all non-joint features of the subject (i.e. elements of the image not classified as a joint). In other implementations, the image recognition engine may be configured to identify the locations of hands specifically. Also, other techniques, such as a user check-in procedure or biometric identification processes, may be deployed for the purposes of identifying the subjects and linking the subjects with detected locations of their hands as they move throughout the store.

```
Foot Joints:
  Ankle joint (left and right)
Non-foot Joints:
  Neck
  Nose
  Eyes (left and right)
  Ears (left and right)
  Shoulders (left and right)
  Elbows (left and right)
  Wrists (left and right)
  Hip (left and right)
  Knees (left and right)
Not a joint
```

An array of joints data structures for a particular image classifies elements of the particular image by joint type, time of the particular image, and the coordinates of the elements in the particular image. In one implementation, the image recognition engines 112a-112n are convolutional neural networks (CNN), the joint type is one of the 19 types of joints of the subjects, the time of the particular image is the timestamp of the image generated by the source camera 114 for the particular image, and the coordinates (x, y) identify the position of the element on a 2D image plane.

The output of the CNN is a matrix of confidence arrays for each image per camera. The matrix of confidence arrays is transformed into an array of joints data structures. A joints data structure 310 as shown in FIG. 3A is used to store the information of each joint. The joints data structure 310 identifies x and y positions of the element in the particular image in the 2D image space of the camera from which the image is received. A joint number identifies the type of joint identified. For example, in one implementation, the values range from 1 to 19. A value of 1 indicates that the joint is a left ankle, a value of 2 indicates the joint is a right ankle and so on. The type of joint is selected using the confidence array for that element in the output matrix of CNN. For example, in one implementation, if the value corresponding to the left-ankle joint is highest in the confidence array for that image element, then the value of the joint number is “1”.

A confidence number indicates the degree of confidence of the CNN in predicting that joint. If the value of confidence number is high, it means the CNN is confident in its prediction. An integer-Id is assigned to the joints data structure to uniquely identify it. Following the above mapping, the output matrix of confidence arrays per image is converted into an array of joints data structures for each image. In one implementation, the joints analysis includes performing a combination of k-nearest neighbors, mixture of Gaussians, and various image morphology transformations on each input image. The result comprises arrays of joints data structures which can be stored in the form of a bit mask in a ring buffer that maps image numbers to bit masks at each moment in time.

### Subject Tracking Using a Data Structure Including Joint Information

The tracking engine 110 is configured to receive arrays of joints data structures generated by the image recognition engines 112a-112n corresponding to images in sequences of images from cameras having overlapping fields of view. The arrays of joints data structures per image are sent by image recognition engines 112a-112n to the tracking engine 110 via the network(s) 181. The tracking engine 110 translates the coordinates of the elements in the arrays of joints data structures from 2D image space corresponding to images in different sequences into candidate joints having coordinates in the 3D real space. A location in the real space is covered by the field of views of two or more cameras. The tracking engine 110 comprises logic to determine sets of candidate joints having coordinates in real space (constellations of joints) as located subjects in the real space. In one implementation, the tracking engine 110 accumulates arrays of joints data structures from the image recognition engines for all the cameras at a given moment in time and stores this information as a dictionary in a subject database, to be used for identifying a constellation of candidate joints corresponding to located subjects. The dictionary can be arranged in the form of key-value pairs, where keys are camera ids and values are arrays of joints data structures from the camera. In such an implementation, this dictionary is used in heuristics-based analysis to determine candidate joints and for assignment of joints to located subjects. In such an implementation, a high-level input, processing and output of the tracking engine 110 is illustrated in table 1. Details of the logic applied by the subject tracking engine 110 to create subjects by combining candidate joints and track movement of subjects in the area of real space are presented in U.S. patent application Ser. No. 15/847,796, entitled, “Subject Identification and Tracking Using Image Recognition Engine,” filed on 19 Dec. 2017, now issued as U.S. Pat. No. 10,055,853, which is fully incorporated into this application by reference.

TABLE 1
Inputs, processing and outputs from subject tracking
engine 110 in an example implementation.

| Inputs | Processing | Output |
|---|---|---|
| Arrays of joints data | Create joints dictionary | List of located subjects |
| structures per image and for | Reproject joint positions | located in the real space |
| each joints data structure | in the fields of view of | at a moment in time |
| Unique ID | cameras with overlapping | corresponding to an |
| Confidence number | fields of view to | identification interval |
| Joint number | candidate joints | |
| 2D (x, y) position in | | |
| image space | | |

### Subject Data Structure

The subject tracking engine 110 uses heuristics to connect joints identified by the image recognition engines 112a-112n to locate subjects in the area of real space. In doing so, the subject tracking engine 110, at each identification interval, creates new located subjects for tracking in the area of real space and updates the locations of existing tracked subjects matched to located subjects by updating their respective joint locations. The subject tracking engine 110 can use triangulation techniques to project the locations of joints from 2D image space coordinates (x, y) to 3D real space coordinates (x, y, z). FIG. 3B shows the subject data structure 320 used to store the subject. The subject data structure 320 stores the subject related data as a key-value dictionary. The key is a “frame_id” and the value is another key-value dictionary where key is the camera_id and value is a list of 18 joints (of the subject) with their locations in the real space. The subject data is stored in the subjects database 150. A subject is assigned a unique identifier that is used to access the subject's data in the subject database.

In one implementation, the system identifies joints of a subject and creates a skeleton (or constellation) of the subject. The skeleton is projected into the real space indicating the position and orientation of the subject in the real space. This is also referred to as “pose estimation” in the field of machine vision. In one implementation, the system displays orientations and positions of subjects in the real space on a graphical user interface (GUI). In one implementation, the subject identification and image analysis are anonymous, i.e., a unique identifier assigned to a subject created through joints analysis does not identify personal identification information of the subject as described above.

For this implementation, the joints constellation of a subject, produced by time sequence analysis of the joints data structures, can be used to locate the hand of the subject. For example, the location of a wrist joint alone, or a location based on a projection of a combination of a wrist joint with an elbow joint, can be used to identify the location of hand of a subject.

### Data Analytics Process

The spatial analytics engine 195 includes logic to process subject tracking data, inventory events data, user accounts data and maps of the area of real space from the maps database to generate information about subjects, inventory items and inventory locations in the area of real space. This information can be generated over multiple time intervals for the area of real space and/or across multiple areas of real space. FIG. 4A presents a high-level process for data analytics using various types of data collected by the technology disclosed. The data is collected and saved in one or more databases such as the subjects database 150, inventory events database 155, accounts database 164, and maps database 140 (operation 450). The data analytics method can access other databases containing data related to operations of the shopping store. The spatial analytics engine 195 includes logic to process the data from the various databases in which the data is stored (operation 455) and generate various analytics related to operations of the shopping store.

FIG. 4B presents some examples of analytics that can be generated regarding the area of real space using geometric data of the map of the area of real space. The geometric data can include two-dimensional and three-dimensional maps of the area of the real space. Different types of maps of the area of real space can be used by the spatial analytics engine 195 as input, e.g., camera maps, shelf maps, semantic maps, camogram maps, and walkable area maps. The camera maps can include details of locations of the cameras and/or other types of sensors that are placed in the area of real space. The camera maps can also include camera calibration and camera orientation data. The shelf maps can include placement of shelves and other types of inventory display structures in the area of real space. Semantic maps can include additional information about various locations in the area of real space such as inventory display structures, bins, baskets, stands, counters, open spaces, exit and entrance areas etc. Camogram maps can include placement of items in shelves indicating which inventory item is placed on which location on a shelf. The location of the item may be described by a location in a two-dimensional or three-dimensional coordinates of the area of real space. Walkable area maps can include locations of walking paths in the area of real space.

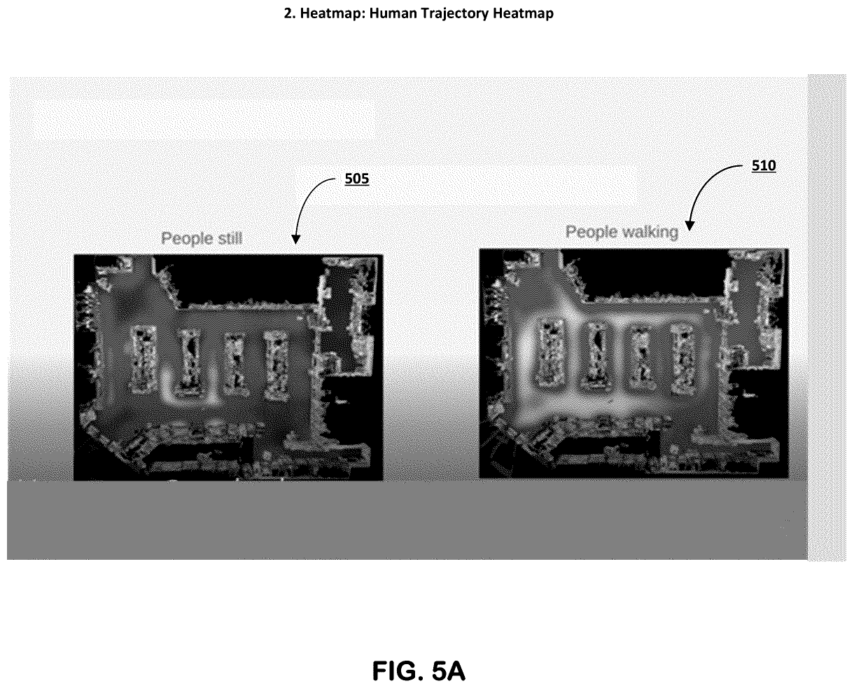

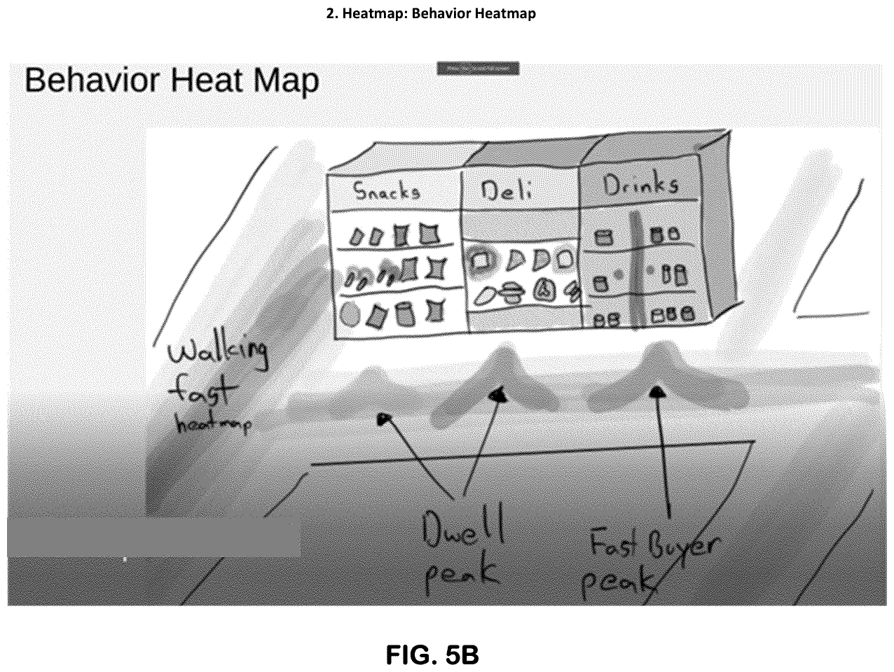

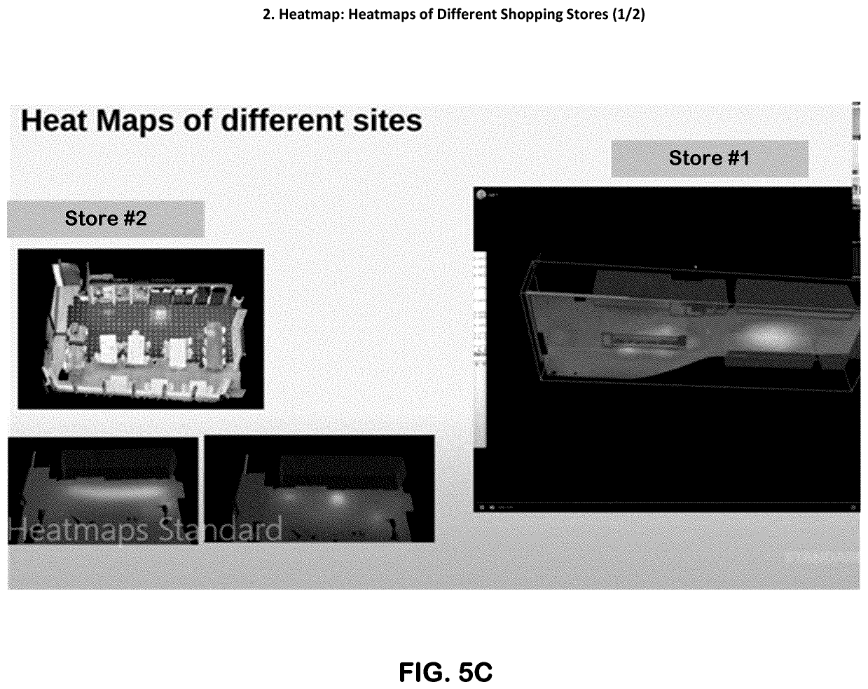

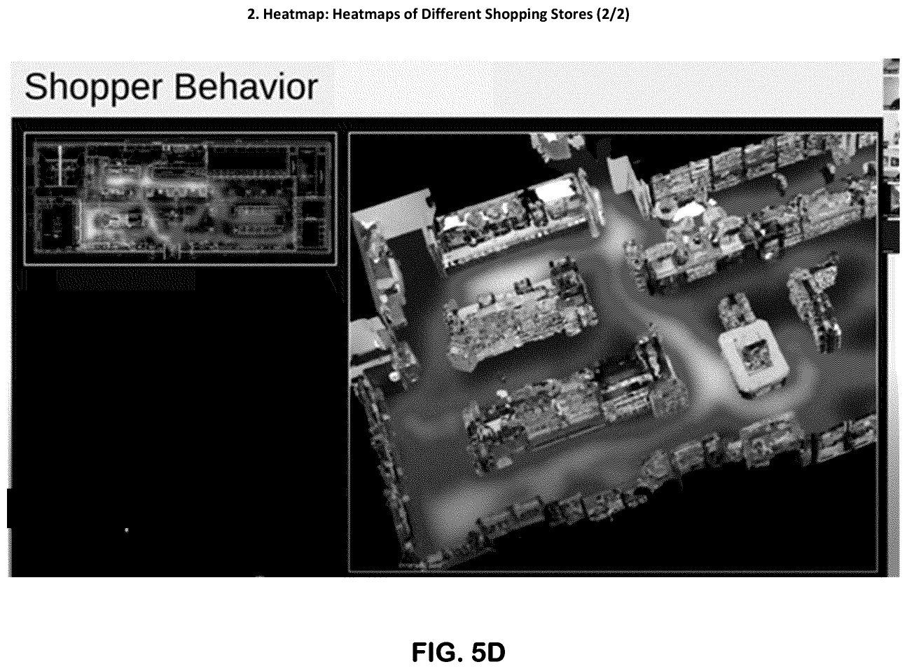

The analysis logic can combine data from two or more databases for generating analytics data (operation 455). The output from the spatial analytics engine 195 is provided as input to a heatmap generator 415 which can process the data to generate heatmaps for the area of real space in a data visualization operation 460. The heatmaps can be displayed on computing devices 425 as shown in FIG. 4A. The heatmap generator 415 can generate heatmaps and overlay the heatmaps on one or more types of maps of the area of real space presented above. FIG. 4B shows some example heatmaps such as trajectories of paths of subjects in the area of real space, and trajectory heatmaps overlaid on the camera view map of the area of real space. The technology disclosed can thus generate a digital twin of the area of real space or a shopping store by combining various maps with subject tracks and inventory events in the area of real space. Examples of different types of heatmaps that can be generated by the heatmap generator 415 are presented in FIGS. 5A to 9B.

### Examples of Heat Maps Related to Subject Tracking and Inventory Events

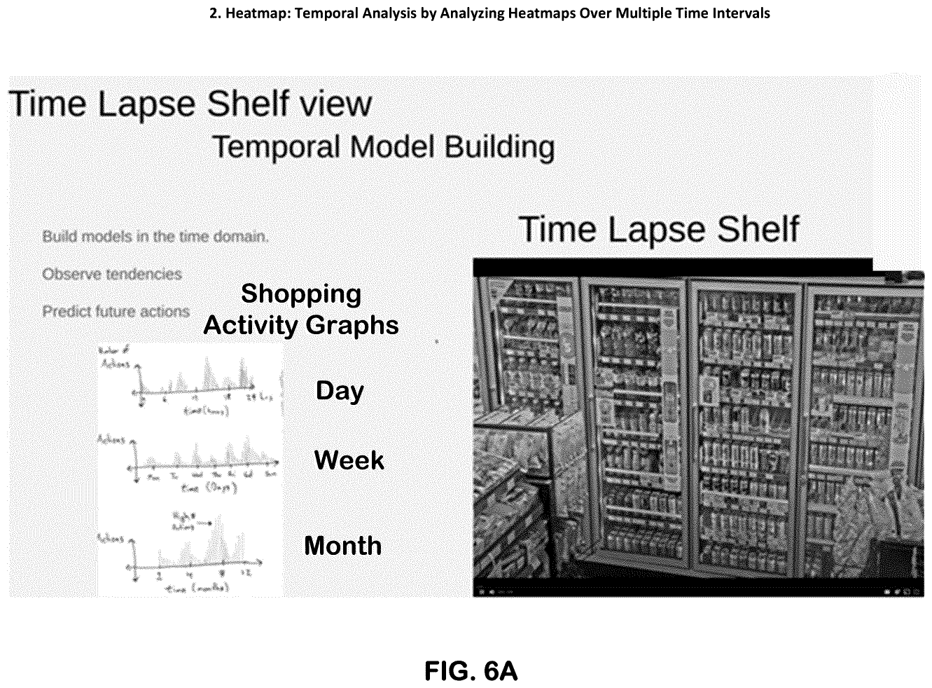

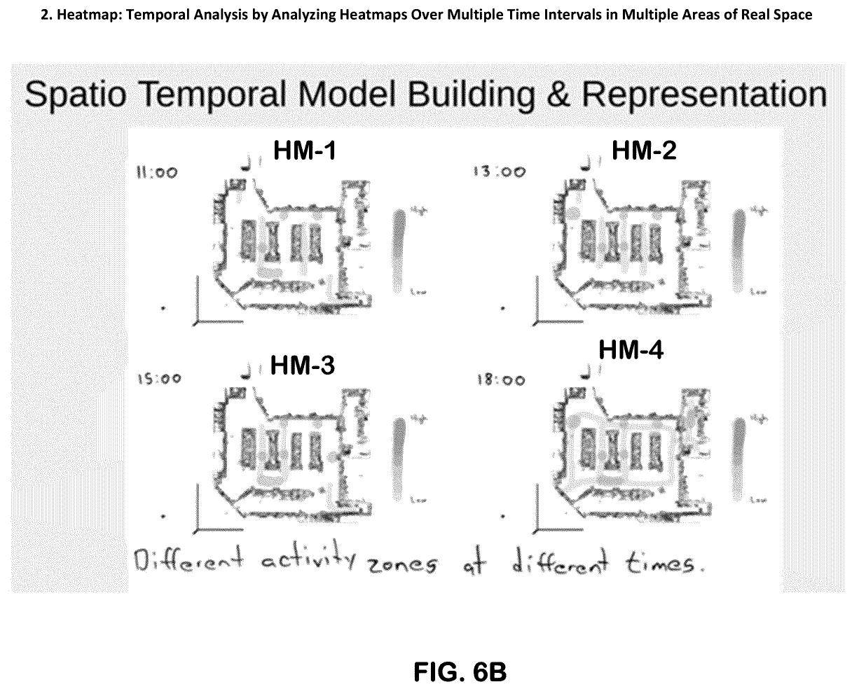

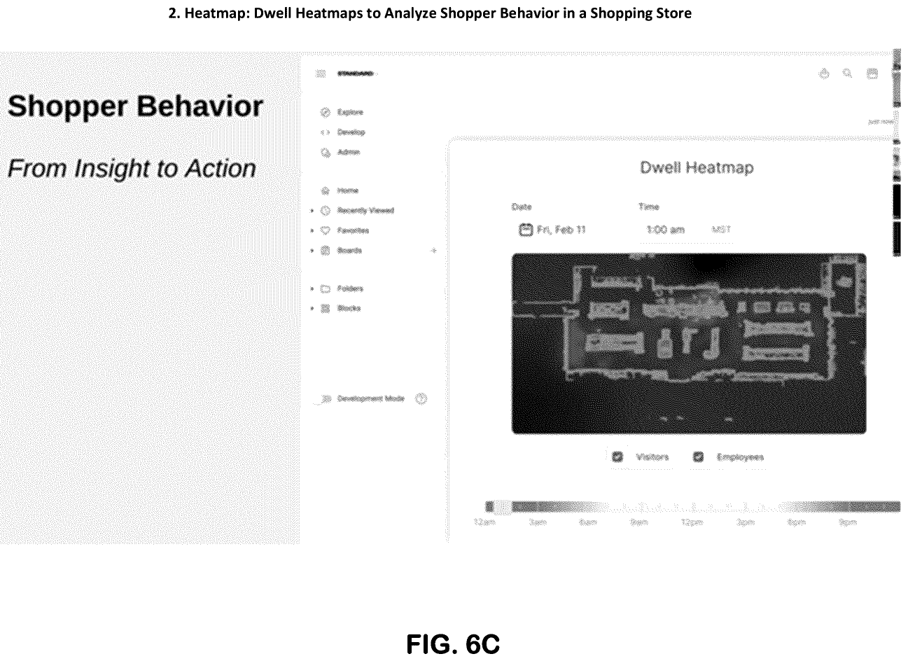

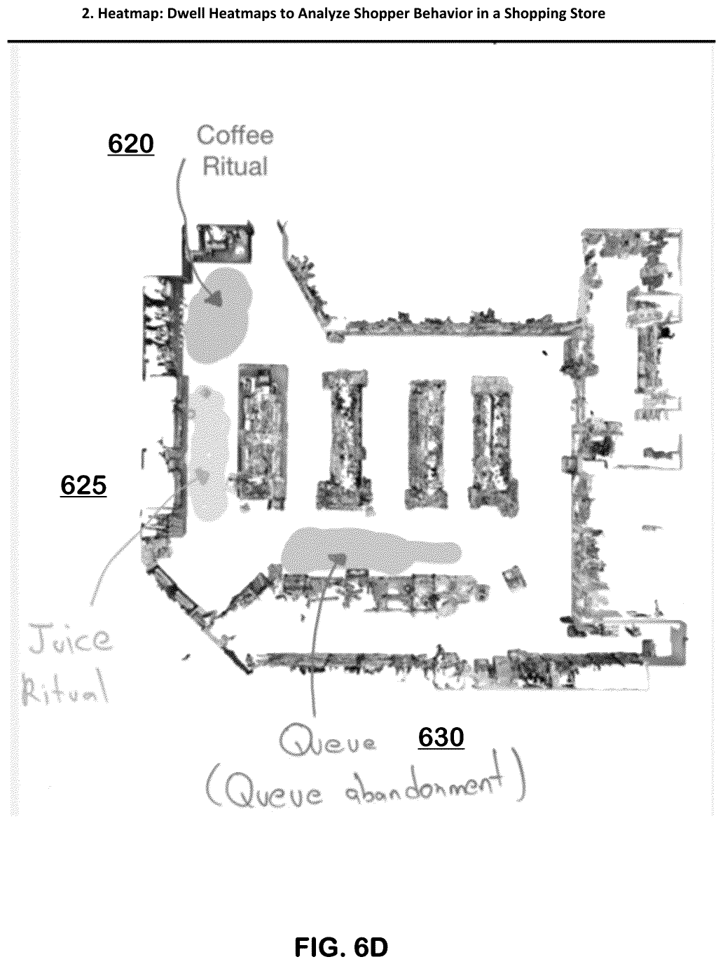

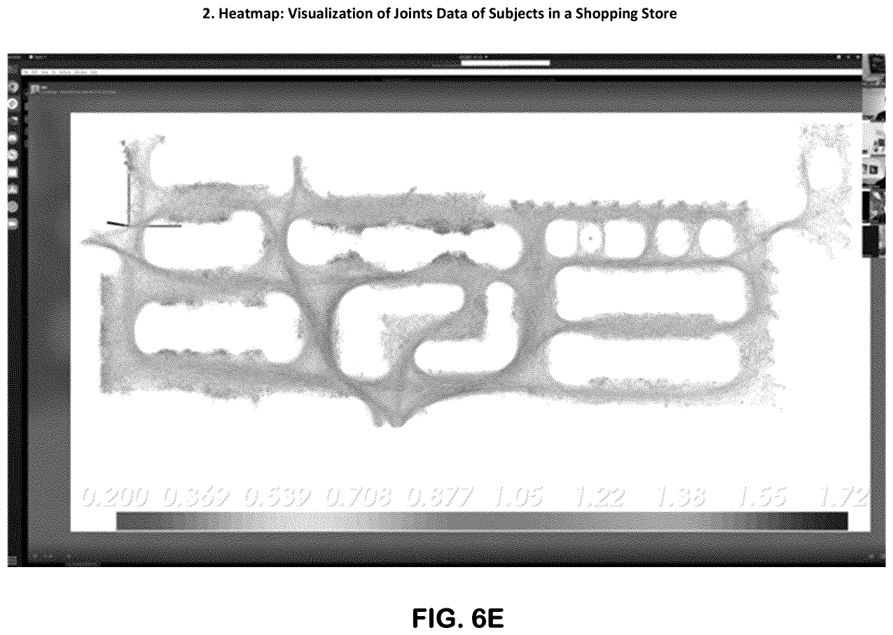

FIGS. 5A to 6E present examples of heatmaps that can be generated by the heatmap generator 415. Different colors can be used in the heatmaps to show areas with high traffic or areas where higher number of subjects are present. High traffic areas can be illustrated in red color and low traffic areas can be shown in blue colors. For example, a red color can indicate areas where tracks of more than 10 subjects per minute are detected whereas an area in which two or less than two subjects are detected per minute can be shown in blue color on a heatmap. A range of colors such as orange, yellow, green, etc. can be used to show subjects in between the high traffic (more than ten subject tracks) and low traffic (two or less than two subject tracks) areas. It is understood that other ranges of subject tracks can be used for illustrations in the heatmaps. Different time durations can also be used when calculating heatmaps such as one minute, five minutes, 10 minutes, 30 minutes, one hour, one day (24 hours), one week, one month, or more.

FIGS. 5A to 5D show heatmaps based on subject tracks in the area of real space. These heatmaps indicates sections in the area of real space that are more popular or receive more pedestrian traffic.

FIG. 5A presents heatmaps of subjects' paths or trajectories in the area of real space. An illustration 505 presents a heatmap of subjects standing (or stationary) at a place in the area of real space. The subjects maybe stationary or moving within a small area such as in a radius of 1 meter or less. In some cases, an area greater than 1 meter may be considered in which subjects are located. This heatmap can indicate the areas where subjects spend more time standing in a same place for a longer duration of time such as greater than 2 minutes or greater than 5 minutes or greater than 10 minutes, etc. These places can correspond to areas in a shopping store where subjects can order drinks such as coffee, tea, juices, etc. An illustration 510 shows a heatmap of walking trajectories or walking paths of subjects in the area of real space. It can be seen that some areas have a higher number of subject tracks as compared to other areas. Therefore, the heatmap can be used to determine which aisles, inventory display structures, shelves, and/or bins etc. contain products that are more popular with shoppers.

FIG. 5B shows a subject or shopper behavior heatmap. Three inventory display structures are shown in the map labeled as “snacks”, “deli” and “drinks”. The dwell heatmap displayed below each inventory display structure indicates the number of subjects who stand in front of a shelf for at least a pre-defined minimum amount of time. The time threshold can be set by the store management, for example, at least thirty seconds, at least one minute, at least two minutes, etc. The heatmaps show that a higher number of subjects dwell in front of “deli” and “drinks” inventory display structures as compared to “snacks” inventory display structure.

FIG. 5C shows heatmaps for various areas of real space for comparative analysis.

FIG. 5D shows two views of a same heatmap of an area of real store. The view of the left is a two-dimensional heatmap while the view on the right in a larger window is a three-dimensional heatmap of the area of real space.

FIGS. 6A to 6E present further examples heatmaps that show shopper behavior in the area of real space.

FIG. 6A presents a time lapse view of an inventory display structure in the area of real space. FIG. 6A presents three shopping activity graphs to illustrate shopping activity in multiple time intervals for a same inventory display structure. For example, a first graph at the top shows shopping activity in a twenty four hour duration (or one day). The second graph shows shopping activity in a week and the third graph at the bottom shows shopping activity in a month. The spikes in the graph indicate times at which more shoppers took items from the inventory display structure.

FIG. 6B shows heatmaps for subject tracks in an area of real space at various times of the day. Four heatmaps are shown at four different times of day. A first heatmap HM-1 shows shopper traffic at 11 AM, a second heatmap HM-2 shows shopper traffic at 1 PM, a third heatmap HM-3 shows shopper traffic at 3 PM and a fourth heatmap shows shopper traffic at 6 PM. A legend along each heatmap shows the color variation on a scale with dark red color indicating high shopper traffic and a light yellow color indicating fewer shoppers. It can be seen that shopper activity increases in the area of real space in the afternoon and becomes high in the evening. Dark circles in subject tracks in heatmaps indicate locations at which subjects stand for a longer period of time. These areas can indicate checkout locations, coffee, juice counters etc.

FIG. 6C shows a subject dwell heatmap for an area of real space. The technology disclosed provides a user interface with user interface elements from which an analyst can select a time duration by selecting a date and time to view the heatmaps for the subject and events data during that time interval. The results in the heatmap can include subject tracks for both shoppers and employees in the area of real space. The technology disclosed can include logic to differentiate amongst the shoppers and employees and show separate heatmaps for each or combined heatmap for both shoppers and employees. The technology disclosed provides user interface elements to select shoppers (visitors) and employees to display respective heatmaps.

The technology disclosed can implement logic to distinguish tracks of shoppers from tracks of employees moving in the shopping store. This separation of tracks is helpful to get useful data about employees in the shopping store such as related to customer support, re-stocking of shelves, customer identification when handing over age-restricted items such as alcoholic beverages, tobacco-based products, etc. The technology disclosed can implement several different techniques to distinguish between the shoppers and the store employees. In one implementation, the store employees' check-in to the store at the start of their shifts using their mobile devices. The store employees can scan their badges, or codes displayed on their cell phone devices to check-in using a check-in kiosk. The check-in can be performed using NFC (near field communication) technology or ultra-wideband technology or other such technologies. In another implementation, the check-in can be performed using one of the account matching techniques implemented by the account matching engine 170. After check-in, the actions performed by the store employees are linked to their respective tracks. When generating heatmaps, the heatmap generator 415 can filter out the employee tracks and not include the employees' tracking data in heatmaps. In another implementation, the store employees wear store uniforms that can include store branding including colors, symbols, letters, etc. The technology disclosed can process the information captured from employees' uniforms to classify them as employees of the shopping store. The machine learning model can be trained using trained data that includes images of store uniforms. Note that the classification is anonymous and facial recognition is not performed to identify a subject. The images of the subjects can be cropped to remove the neck and head portion of the subject and remaining part of the image can be provided to a trained machine learning model to classify a subject as a store employee. In one implementation, the store employees wear nametags that are ultra-wideband enabled. The technology disclosed can scan the nametags to determine that a subject is an employee of the store. In another implementation, the technology disclosed can use the reidentification technique to match the reidentification feature vectors of the subjects with previously stored reidentification vectors of store employees. Matching reidentification feature vectors can identify a subject as a store employee. When implementing reidentification technique, the technology disclosed can use images from the same cameras in a same portion of the area of real space to calculate the reidentification vectors of subjects. Note that the reidentification technique matches the subject using anonymously and no biometric or facial recognition data is used to match the subjects. In one implementation, the store employees enter the area of real space from designated entrances such as one or more doors of the shopping store. The technology disclosed includes logic to assign the subject tracks that start from the employees' designated entrances as belonging to store employees. Therefore, the technology disclosed can separate the shopper tracks from employee tracks in the area of real space.

FIG. 6D presents a heatmap that shows shopper behavior in the area of real space. A dark colored region 620 shows a section in the area of real space where shoppers congregate for buying coffee. The heatmap is therefore useful to know the sections or portions of the area of real space in which more subjects are present as compared to other sections of the area of real space. Similarly, dark colored regions 625 and 630 on the heatmap show sections of the area of real space where more subjects are positioned. The region 625 is near a counter at which juices are sold and the region 630 is near checkout counters. The heatmaps are therefore, useful for planning flow of shoppers in the area of real space. The store management can review the heatmaps and arrange inventory display structures and various counters for smooth flow of shoppers. The various counters such as for coffee and juice, etc. can be positioned in sections of the area of real space to attract subjects towards areas of the real space which are not frequently visited by shoppers. Such arrangement of inventory display structures can increase the flow of shoppers and increase the sale of inventory items in less frequently visited sections of the shopping store.

FIG. 6E shows trajectory data of joints data of subjects in the area of real space that can be used to build heatmaps of subject tracks in the area of real space. The heatmap generated using data in FIG. 6E can show flow of subjects walking in the area of real space. Dark colored regions in FIG. 6E show more subjects as detected by joints analysis. The technology disclosed can extract other useful information related to operations of the shopping store from the data shown in FIG. 6E. For example, the position of shoulder joints and neck joints of subjects can be used to infer gaze directions of subjects. The gaze directions of subjects can be determined throughout the track of a subject in the area of real space. The gaze directions can be used to determine the products and display structures that received more view time from the subject. The gaze directions data can be used for planning of placement of items on inventory display structures and placement of inventory display structures in the area of real space.

### Topological Representation of Subject Tracks

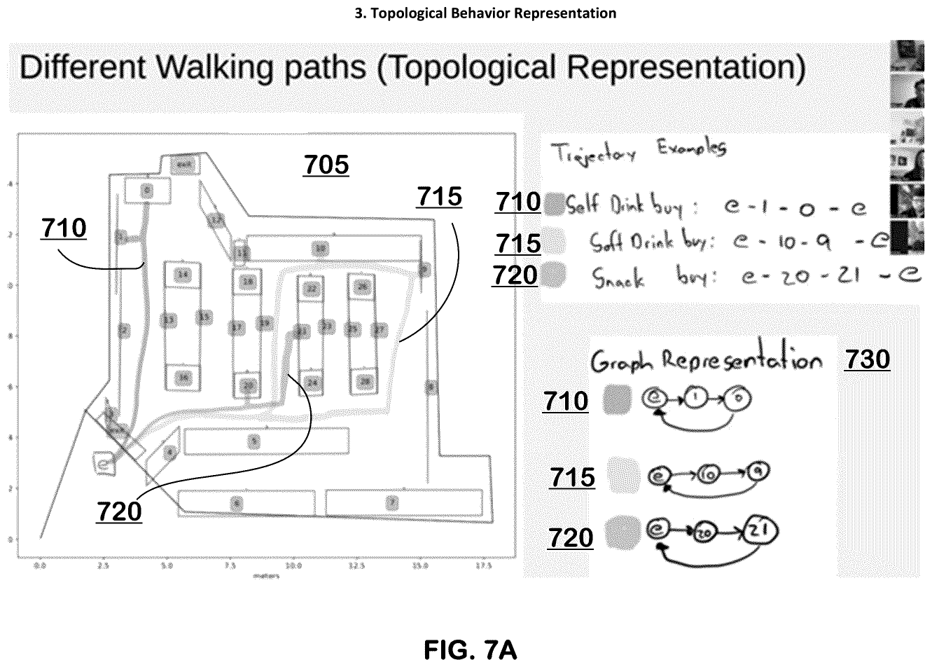

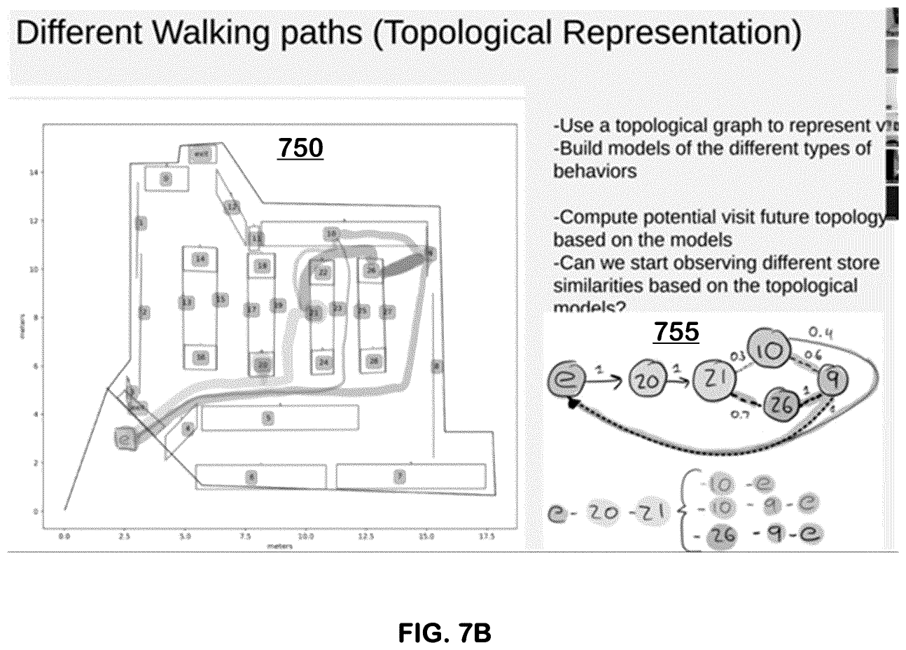

FIGS. 7A and 7B present analysis of walking paths of subjects in the area of real space. The technology disclosed can generate various topological representations of subject tracks or pedestrian paths in the area of real space. Such data can be used for planning placement of inventory display structures in the area of real space. Some examples of subject trajectories and corresponding topological representations are presented in FIGS. 7A and 7B.

FIG. 7A shows a map 705 including paths of subjects in the area of real space. The labels with numbers on the map indicate shelves in the area of real space. Entrances and exits are also indicated on the map (705) of the area of real space. Three example trajectories 710, 715 and 720 are shown on the map (705) of the area of real space. The technology disclosed can implement a probabilistic model to generate various possible paths of subjects. A first path 710 illustrates an example trajectory for a shopper who only visits the area of real space for buying a drink from a self-service drink counter such as a coffee machine or a soft drink dispenser. The subject enters the area of real space through the entrance marked with a label “e”, visits the self-serve drink counter labeled “1” and fills a cup of coffee or a glass of soft drink, etc. The shopper then visits another nearby inventory location labeled “0” and then exits the area of real space. The second location “0” in the trajectory (or path) 710 can be an amenities counter location from where the subject takes milk, sugar, etc. for the coffee. A second path 715 illustrates an example trajectory for a shopper who visits the area of real space to buy a drink from a shelf such as from a refrigerator. The shopper enters the store through entrance “e”, visits the shelf at the end of the store which is labeled “10”. The shelf “10” can be a refrigerator. The shopper takes out a drink from the shelf and then visits another location labeled “9” before exiting the area of real space. The second location labeled “9” can be another shelf from where the shopper takes another drink. In one implementation, the location labeled as “9” can be scanner where shopper can scan a code such as a QR code displayed on their cell devices for initiating the checkout process. The shopper can then exit the area of real space. A third path 720 illustrates an example trajectory for a shopper who visits the shopping store to buy a snack. The path 720 starts at the entrance “e”, the shopper visits shelves “20” and “21” to take snacks from these shelves. The shopper then exits the area of real space. The three trajectories are shows as a sequence of labels in the top right corner of FIG. 7A and as graphs 730 in the bottom right corner of FIG. 7A. The graphs show inventory locations or entrances/exits to the area of real space as nodes. The nodes are connected via edges. The edges can be directed indicating the path of the shopper from a first location to a second location.

FIG. 7B presents multiple possible paths of a shopper that buys snacks and drinks from the shopping store on a map 750. The paths shown in FIG. 7B combine the three paths from FIG. 7A such that there is a common part of the path which includes visits to shelves “20” and “21” for taking snacks. After the shopper has taken the snacks from the two locations (“20”, “21”) the shopper can follow one of the three alternative paths as shown in a graph 755. The nodes in the graph are labeled with shelf locations in the area of real space. A label “e” indicates the entrance and exit location from the area of real space. A first alternative path includes visits to shelf “10” and the shelf (or counter) “9”. A second alternative path includes visits to shelf “26” and the shelf (or counter) “9”. A third alternative path includes exit from the area of real space after visit to location “10” and does not include visit to location “9” as in the first alternative path. The model can also indicate probabilities for each path. The probability values are placed as labels on the edges connecting the nodes in the graph 755. The probability from entrance “e” to location “20 and then to location “21” is 1 as shown on the edges between the nodes “e”, “20” and “21” in a graph 755 on the bottom right part of FIG. 7B. The probability of a shopper to visit location “10” after visiting the location “21” is 0.3 while the probability of the shopper to visit location “26” after visiting the location “21” is 0.7. Similarly, the shopper can visit the location “9” after visiting the location “10” with a probability of 0.6 while there is a 0.4 probability that the shopper will exit from the area of real space after visiting the location “10”. Various probabilities on the multiple paths can be used to determine likely paths of subjects in a future visit. Such modeling of pedestrian paths can be used to arrange the shelves in a manner that enables smooth flow of subjects through the area of real space.

### Cluster Analysis of Shopping Stores

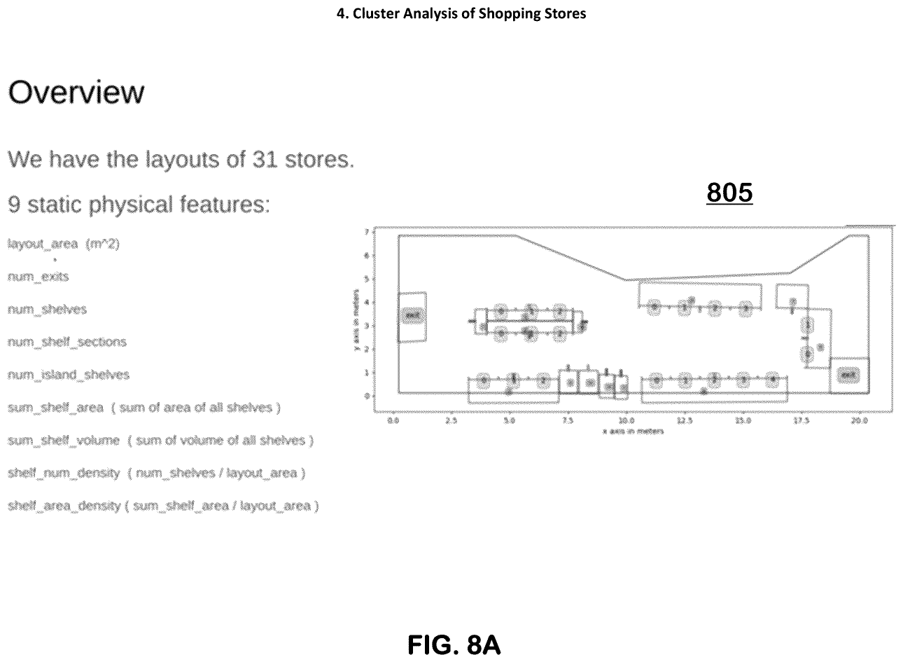

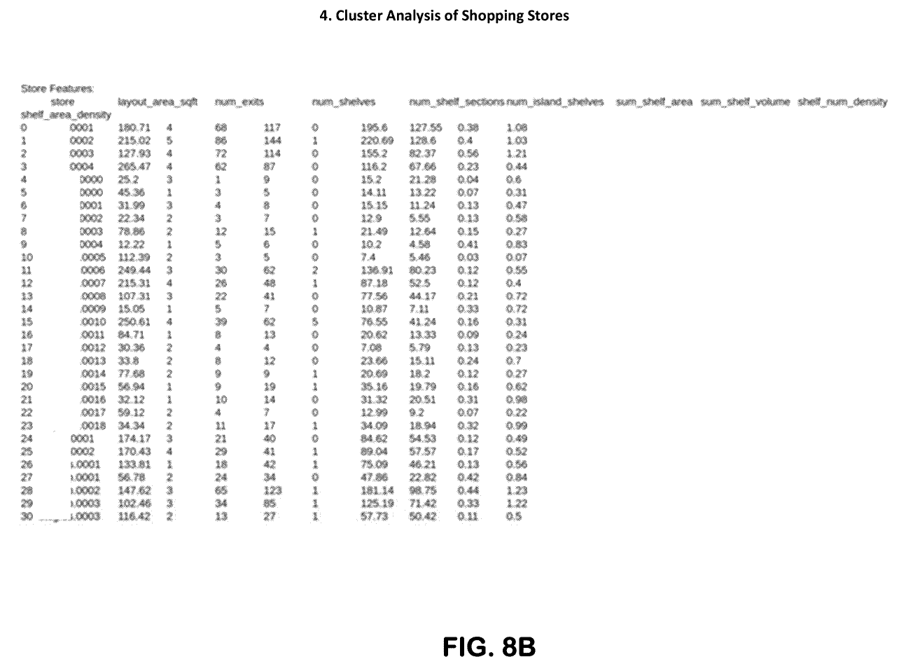

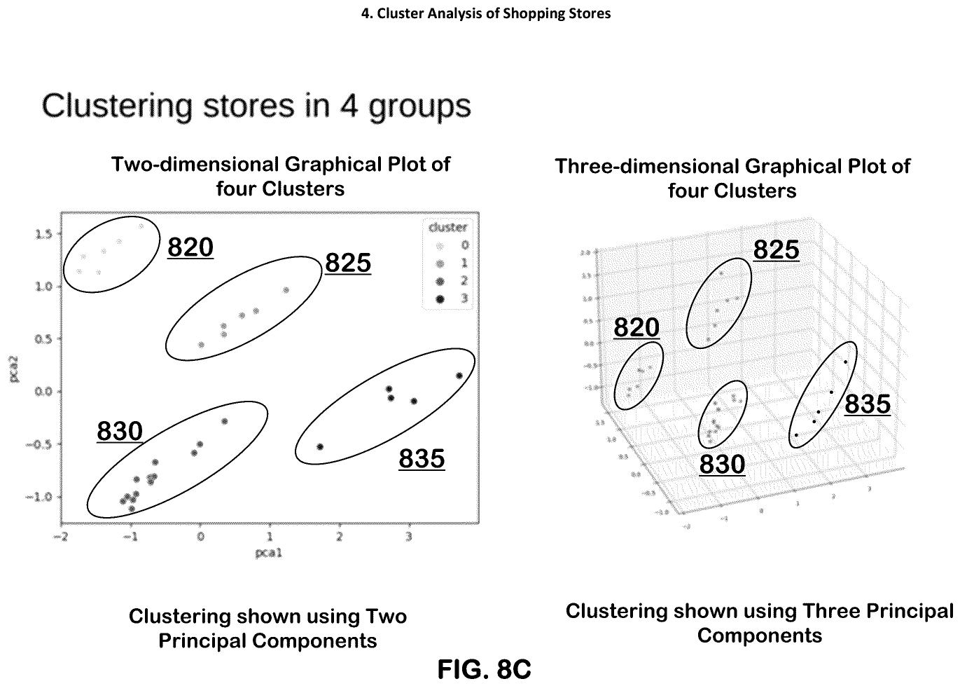

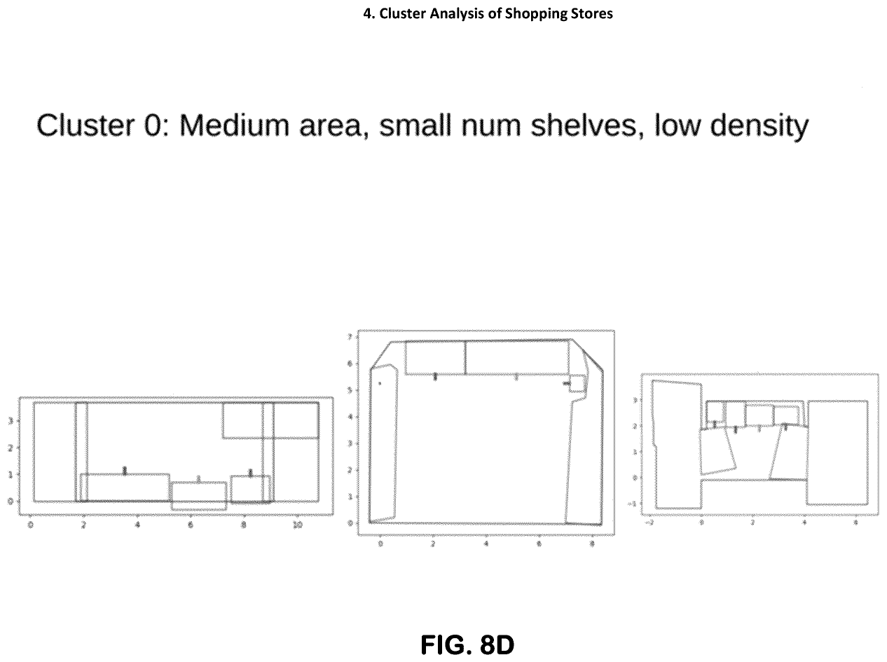

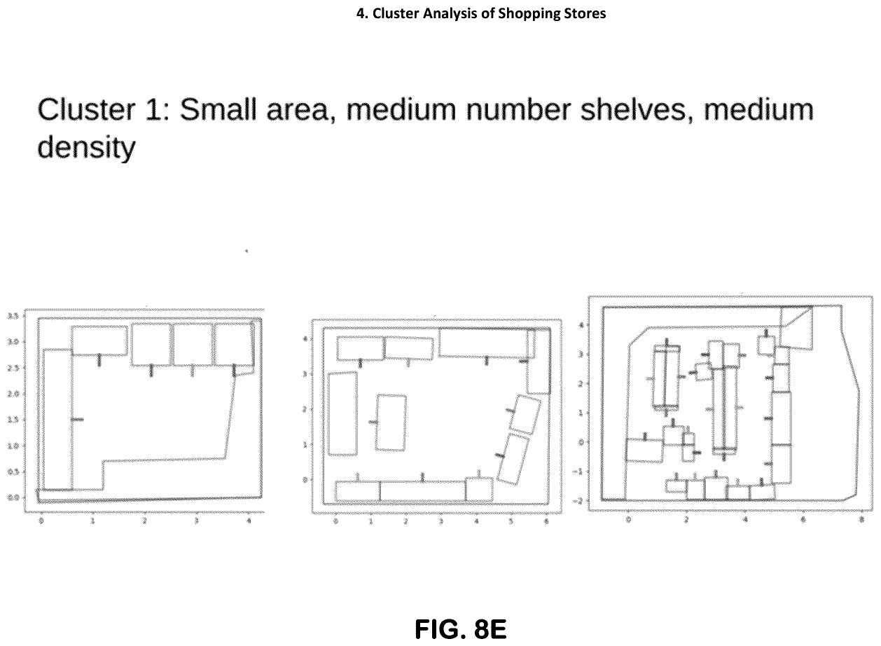

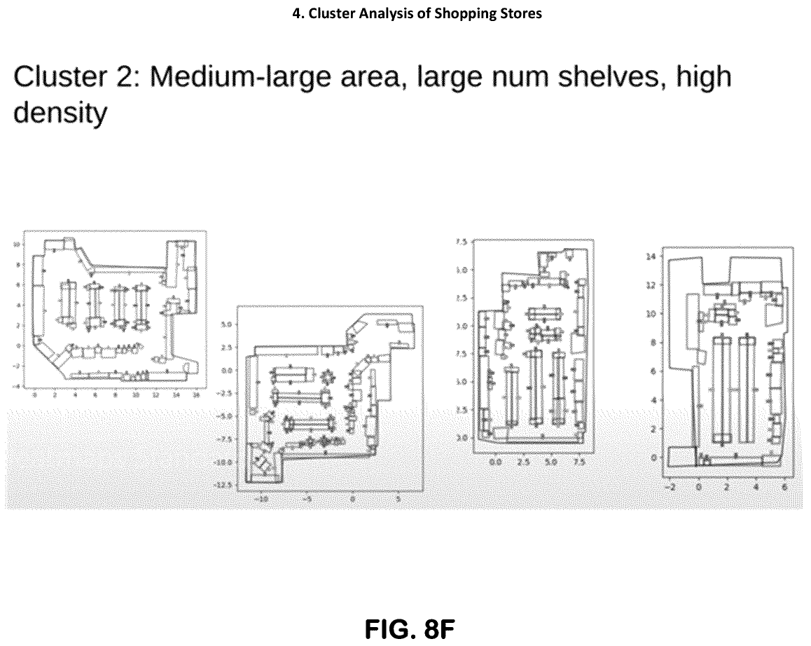

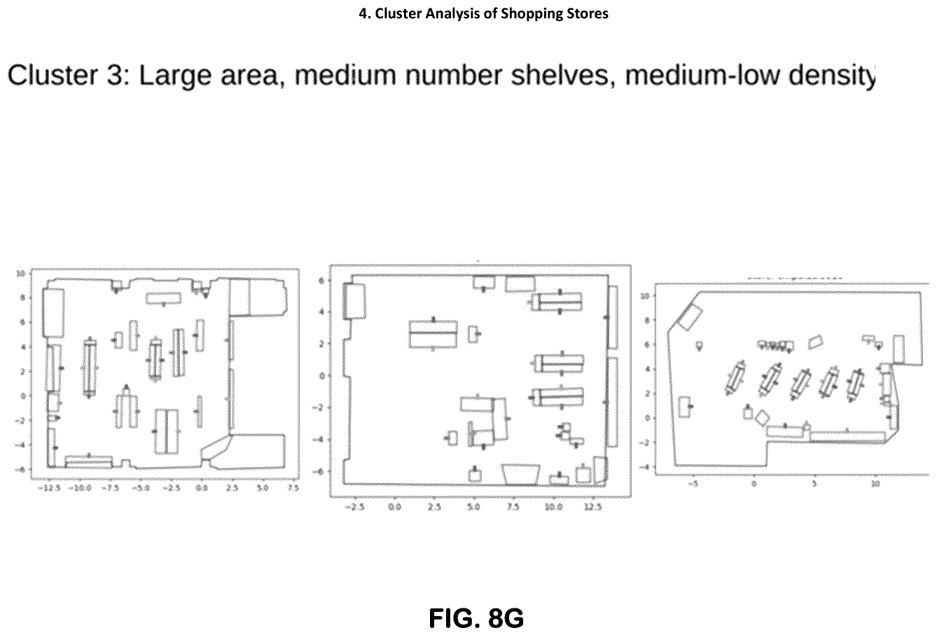

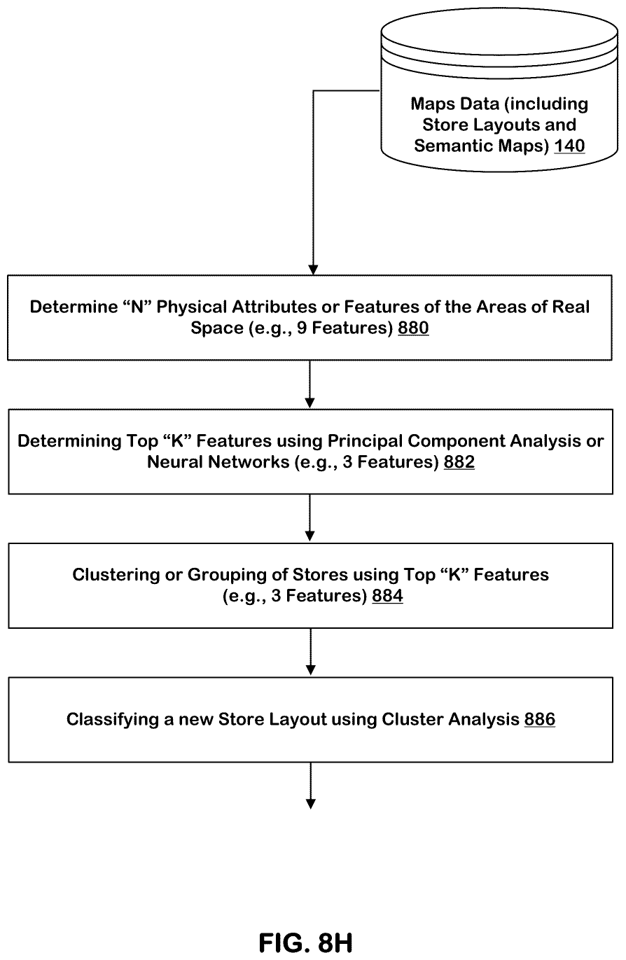

The technology disclosed includes logic to determine characteristics or features that can be used to cluster or group shopping stores (e.g., clustering or grouping layouts of stores). Cluster analysis can be applied to classify new shopping stores (or layouts thereof) to at least one cluster. Cluster analysis can help store management to organize inventory display structures and pedestrian paths in a similar manner as other shopping stores in the cluster that have similar characteristics. The technology disclosed can store the physical layout features of areas of real space in a training data set. For example, in one implementation the technology disclosed determines nine (9) physical features of stores using examples in a training data set comprising a plurality of shopping stores. In one implementation, static physical features of the shopping stores are determined. A static physical feature is a characteristic of the store that does not change very often or remains the same over a long duration of time such as over months, years, etc. Static features can include an area of the shopping store, a number of exits/entrances to the shopping store, a number of shelves and sections, a number of island shelves, a sum of shelf area, a sum of shelf volume, etc. Other static features can be determined using the above listed features such a density of shelves in the area of real space. Density can be calculated for the number of shelves (number of shelves divided by shopping store area) and shelf area (sum of shelf area divided by shopping store area). Examples of nine static physical features of a shopping store are present in FIG. 8A.

The technology disclosed can use machine learning techniques to determine features that are more important for cluster analysis to group or cluster shopping stores. The technology disclosed can determine a type (or a group or cluster) of a new store based on groups or clusters of shopping stores in the training data set. The clusters or groups of shopping store can be used to predict the costs of running a new shopping store based on costs of running similar stores in the clusters. Other predictions related to the new shopping store can also be made using data related to existing stores in the cluster. A process for cluster analysis is presented in FIG. 8H.

FIGS. 8A to 8G shows results of cluster analysis to analyze multiple shopping stores to determine their characteristics. The technology disclosed can determine useful information about shopping stores by clustering stores using their features. Some examples of features (or static physical features) that can be used to cluster the shopping stores include an area of the shopping store (layout_area), number of exits and entrances to the shopping store (num_exits), number of shelves or inventory display structures in the shopping store (num_shelves), number of shelf sections or store sections (num_shelf_sections), number of island shelves (num_island_shelves), sum of area of all shelves (sum_shelf_area), sum of volume of all shelves (sum_shelf_volume), density of shelves in the area of real space which is calculated by dividing the number of shelves by the area of the shopping store (shelf_num_density=num_shelves/layout_area), and density of shelf area (shelf_area_density=sum_shelf_area/layout_area). These features are shown as examples, other features can be used by the technology disclosed when clustering shopping stores.

FIG. 8A presents a map 805 of a shopping store. The exits (or entrances) to the shopping store are marked on the map with “exit” labels. The length and width of the store can be calculated using the scale (in meters) along X-axis and Y-axis on the map. Various shelves placed in the shopping store are also shown in the map of the store. In one implementation, the cluster analysis is performed using data related to thirty one shopping stores.

FIG. 8B shows values for some of the features listed above for thirty one shopping stores. The shopping stores are clustered using the data presented in FIG. 8B.

FIG. 8C shows a graphical plot in which thirty one shopping stores are grouped in four groups or clusters labeled as 820 (cluster 0), 825 (cluster 1), 830 (cluster 2) and 835 (cluster 3). The graphical plot on the left in FIG. 8C presents clustering of shopping stores in four clusters that are represented using two principal components. The graphical plot on the right in FIG. 8C present clustering of shopping stores in four clusters that are represented using three principal components. The principal components are the features that have been identified as more important for clustering of the shopping stores. The technology disclosed can use Principal Component Analysis (PCA) to determine a ranking of features. The features that are ranked at the top can be considered more important than others and thus selected for clustering of shopping stores. In one implementation, the technology disclosed can use dynamic features extracted from areas of real spaces for cluster analysis. Examples of dynamic features include, movement of subjects in the area of real space such as represented in heatmaps, transaction data related to items purchased by subjects and changes in placement of shelves in the shopping store. A detailed process for cluster analysis is presented below with reference to FIG. 8H.

FIG. 8D shows further details of shopping stores grouped in cluster 0. The shopping stores in cluster 0 include stores with small number of shelves as shown in some example maps of stores in FIG. 8D. There are two to four shelves in the stores in cluster 0. The area of the shopping stores is also small to medium in size and the stores have low density of shelves.

FIG. 8E presents details of shopping stores in cluster 1. Maps of some of the shopping stores in cluster 1 are shown in FIG. 8E. The stores in this cluster can have up to 25 shelves. The area of these stores is small and the density of shelves in stores is medium.

FIG. 8F presents details of shopping stores in cluster 2. Maps of some of the shopping stores in cluster 2 are presented in FIG. 8F. The shopping stores in this cluster can have more than 25 shelves. The area of the stores is medium to large and the density of shelves in the shopping stores is high as it can be seen in the example maps in FIG. 8F.

FIG. 8G presents details of shopping stores in cluster 3. Maps of some of the shopping stores in cluster 3 are presented in FIG. 8G. The shopping stores in this cluster have a larger area with medium number of shelves i.e., the number of shelves can be around 25 or less. The density of shelves in the area is medium to low as the shelves are placed farther apart or arranged in aisles or other types of arrangements. Therefore, shoppers have a larger space to move around in the store.

FIG. 8H presents a flowchart including operations for clustering shopping stores and classification of a new shopping store in at least one cluster. The process can include accessing one or more databases storing data related to shopping stores. For example, maps of the shopping stores can be accessed from the maps database 140. The maps database can store various types of maps such as semantic maps, shelf maps, camogram maps, walkable area maps, etc. Data from one or maps can be used for clustering of shopping stores. The flowchart in FIG. 8H shows that the technology disclosed accesses store layout maps and semantic maps for clustering of shopping stores. The technology disclosed includes logic to determine various (e.g., “N”) physical attributes or physical features of the area of space from the maps (operation 880). Examples of nine physical features or attributes are presented above with reference to FIG. 8A. Physical features can include the area of the shopping store, the number of exits/entrances to the shopping store, the number of shelves and sections, the number of island shelves, the sum of shelf area, the sum of shelf volume, etc. The technology disclosed can apply machine learning or neural network techniques such as Principal Component Analysis (PCA) to rank the physical features for selection of “K” features that have a higher impact on clustering of shopping stores (operation 882). PCA is often used to reduce the dimensions of a N-dimensional dataset by projecting it onto a K-dimensional subspace where K<N. The technology disclosed can select the top 2, top 3 or top K features for clustering of shopping stores. In the flowchart in FIG. 8H, top three features are selected for clustering of stores in the dataset of stores (operation 884). During planning of a new shopping store, the technology disclosed can classify the planned new shopping store in one of the existing clusters (operation 886). The characteristics or attributes of the shopping stores in the cluster can then be used by the planners of the new shopping store when determining placement of inventory display structures, pedestrian paths, sections and other facilities in the new shopping store.

The technology disclosed can use analytics data and heatmaps to guide store management for product placement on shelves in inventory display structures to increase takes of inventory items. The technology disclosed can also use data analytics and heatmaps to determine arrangement of shelves in the shopping store such that flow of subjects to all areas of shopping store is increased. The technology disclosed can use optimal placement of cameras or sensors in the area of real space as input when generating placement of products, placement of shelves and pedestrian paths in the area of real space. The data analytics and heatmaps can identify areas of the shopping store or inventory display structures that have a higher subject dwell time. Inventory display structures with a high dwell time can be offered as premium product locations for product manufacturers or distributors who like to increase the sales of their products.

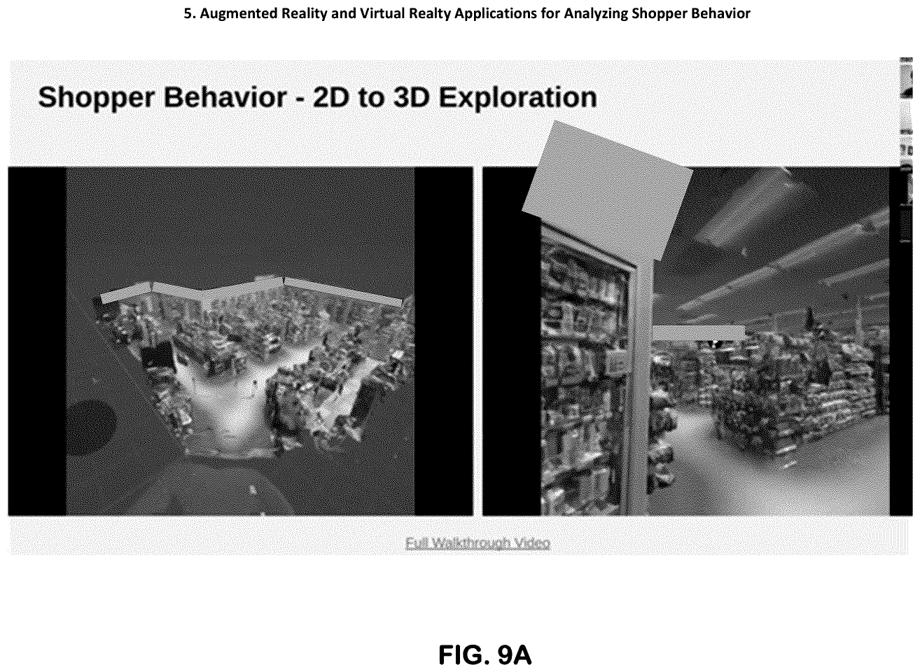

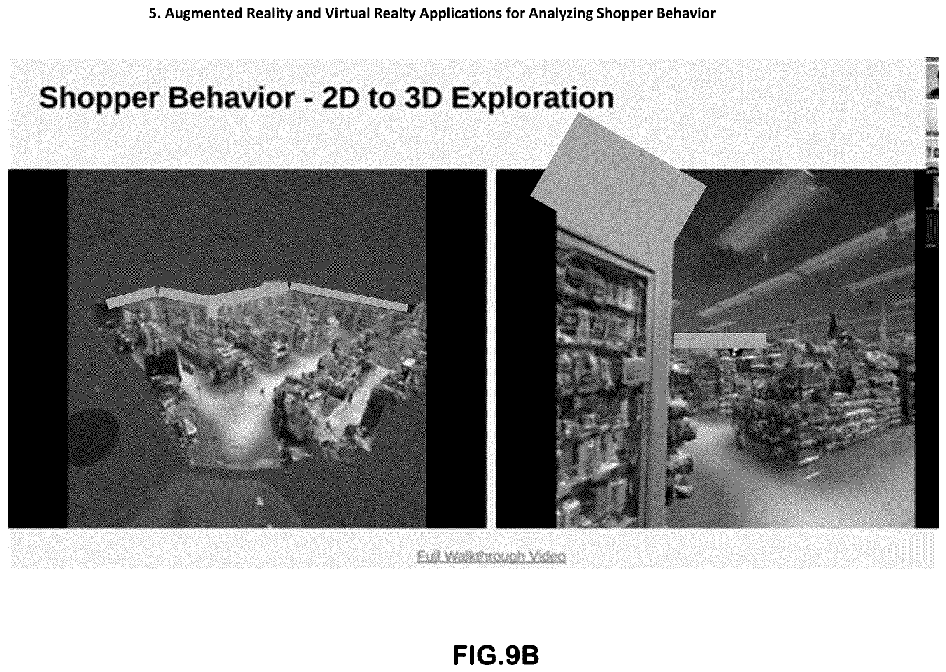

FIGS. 9A and 9B present examples of heatmaps that include three-dimensional or two-dimensional maps of the area of real space. The technology disclosed can combine these maps with augmented reality or virtual reality applications to provide further details about the shopping stores or other types of area of real space. A store owner, an architect or another person planning the layout of a shopping store or another type of area of real space

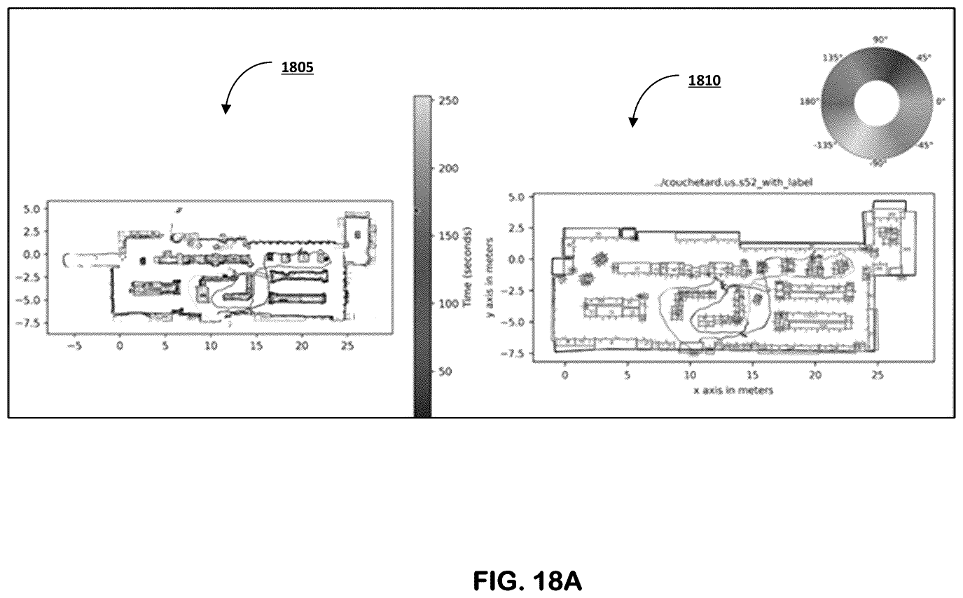

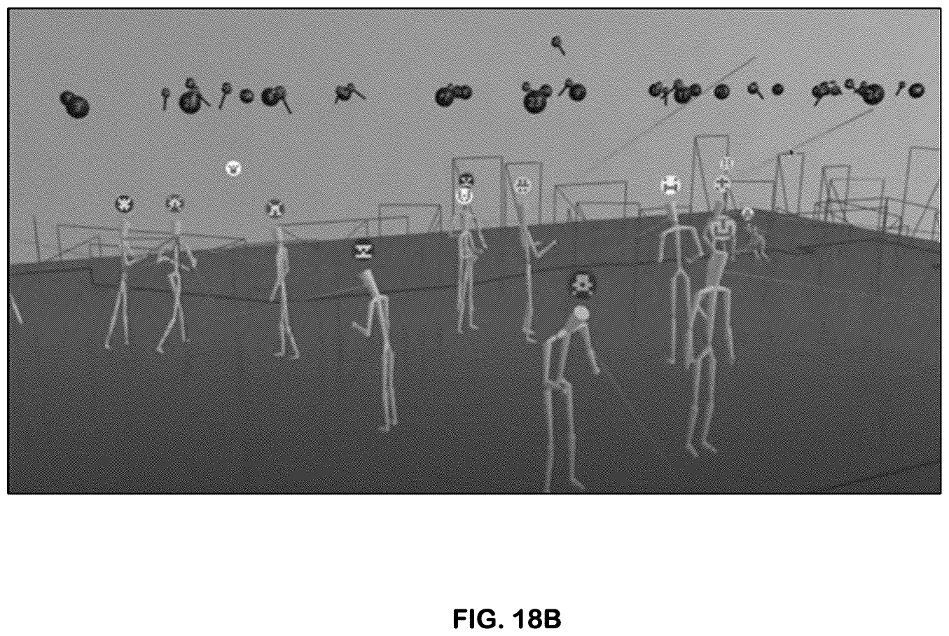

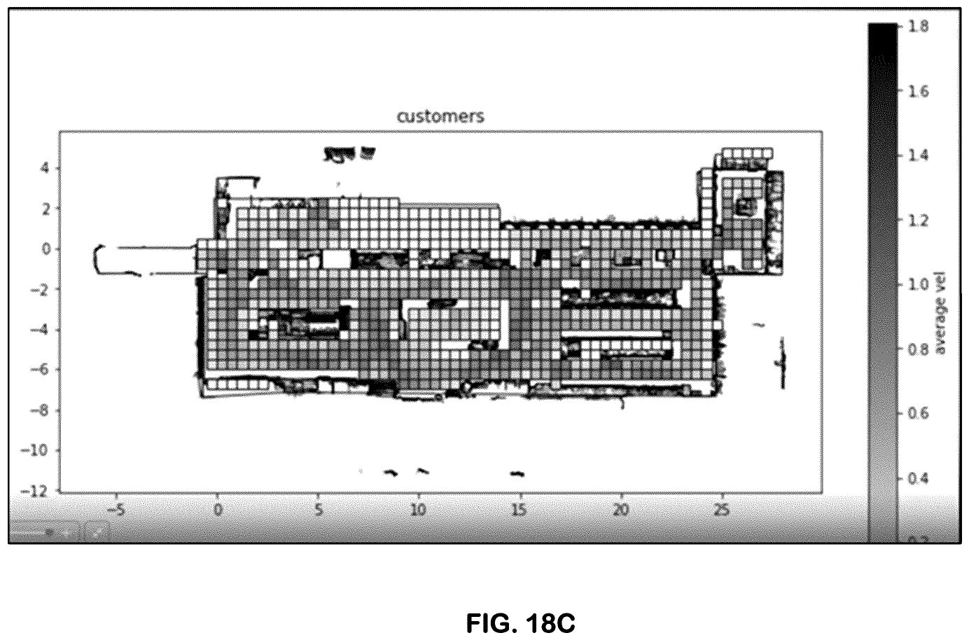

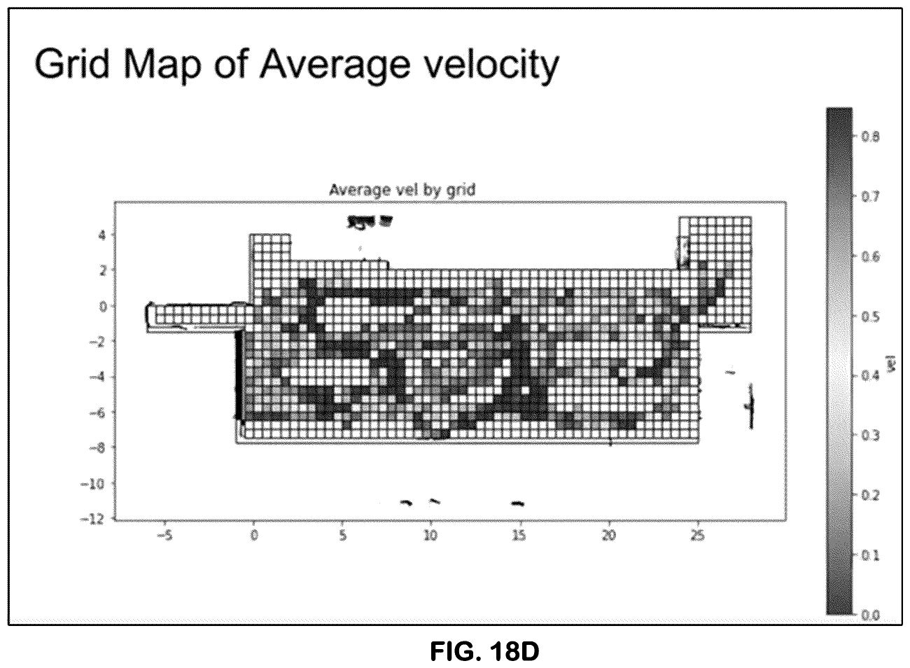

FIGS. 18A to 18D present further examples of analysis of subject tracks in the area of real space. The technology disclosed provides systems and methods to systematically analyze behavior of subjects (i.e., customers or shoppers) in the area of real space to predict their paths and actions in the area of real space. This analysis is useful for product placement and store layout planning for efficient use of the shopping store space and to increase the takes of items by subjects. The technology disclosed applies spatial analytics to analyze the area of real space and determines placement of products in shelves, placement of shelves in various areas or sections of the space and arrangement of various of sections in the area of real space. The technology disclosed can use digital twins (or 3-dimensional maps) of physical shopping stores for analyzing the spatial data i.e., 3-dimensional maps including placement of shelves, subject tracks and inventory events in the area of real space, etc.

The technology disclosed includes logic to the patterns of pedestrian paths in the area of real space. Once pedestrian patterns are determined, models can be built that can fit these patterns or this pedestrian data. Using these models, the technology disclosed can predict expected outcome of a customer visiting a store. For example, expected path of subject and likely items that the subject will take from shelves. This type of analysis can then be used for planning layouts for new shopping stores.

It is understood that the technology disclosed can be applied to various types of areas of real space without any limitations. For example, the technology disclosed can be applied to small and large shopping malls, supermarkets, train stations, airports, clubs, outdoor shopping areas, fairs, amusement parks, movie theaters, sports arenas, etc. The same technology can be applied to smaller locations such as kiosks and larger superstores or very large shopping complexes, etc.

FIG. 18A presents two graphs 1805 and 1810 illustrating tracking of a subject in the area of real space with different metadata. For example, the graph 1805 on the left is a timeline presenting track of the subject after the subject entered the area of real space and while the subject remained in the area of real space. The vertical scale bar on the right side of the graph 1805 provides a color code corresponding to the time a subject has spent in the area of real space at various locations. The time scale starts from zero (0) seconds at the bottom which is dark color and lighter color indicates more time spent by the subject such as up to 250 seconds. The graph 1810 on the right side in FIG. 18A provides gaze direction of the subject (or the direction in which the subject is looking) in the area of real space. The color of the line (subject track) indicates the direction in which the subject is viewing items in the store. The color of the subject track can be matched to a color in a circular legend at the top right corner of FIG. 18A to determine the gaze direction of the subject at a particular location in the arear of real space.

In one implementation, location of shoulder joints and neck joints of subjects can be used to predict the gaze direction. In another implementation, a nose position and shoulder joints can be used to predict the gaze direction of subjects. Other implementations can use additional features of subjects such as eyes, neck and/or feet joints to predict the gaze directions of subjects. The technology disclosed might not perform facial recognition or use of other personal identifying information (PII) to detect and/or track subjects and predict their gaze directions. In some implementations, shoulder, neck, eyes etc. can be used to create an orientation of the subject to determine the gaze direction. The technology disclosed can use gaze directions determined using logic presented in U.S. patent application Ser. No. 16/388,772, entitled, “Directional Impression Analysis using Deep Learning,” filed on 18 Apr. 2019, now issued as U.S. Pat. No. 10,853,965, which is fully incorporated into this application by reference.

FIG. 18B presents an example illustration in which skeletons of anonymously tracked subjects are generated by a pose detection technique using images captured from the cameras installed in the area of real space. The skeletons are generated by clustering joints of subjects as detected by the subject tracking engine 110. The orientations of subjects can be determined using the gaze detection technique and represented by positions and orientation of skeletons as shown in FIG. 18B.

The technology disclosed can generate aggregate heatmaps by combining data from hundreds, thousands or more tracks of subjects in the area of real space. The heatmap shown in FIG. 18C represents average speed or average velocity of subjects at various locations in the area of real space. The average velocity can be calculated by averaging velocities of thousands (such as 1000 to 5000 or more subject tracks) of tracks of subjects in a shopping store. The graphical illustration in FIG. 18C shows on average in which parts of the store the subjects walk fast and in which parts of the store the subjects walk slowly. There are some regions in the area of real space in which color of the heatmap is very light, this can indicate locations where the subjects are stationary e.g., waiting in a line for payment to a cashier, waiting in a line to use an ATM machine, or waiting to get their coffee, etc. A similar heatmap can be generated to show average accumulated time of subjects in the shopping store. Such heatmap is useful to know the locations where subjects spend more time as compared to other locations of the area of real space.

FIG. 18D presents average velocity or average speed of subject per tile (or cell) in a grid of the area of real space. In one implementation, the grid comprises 10 cm by 10 cm tiles. In some implementations the grid can comprise 20 cm by 20 cm tiles. Other sizes of tiles greater or less than 20 cm by 20 cm can be used to create the grid. The scale on the left shows that tiles with dark red color indicate lower average velocity while tiles with dark green color indicate higher average velocity.

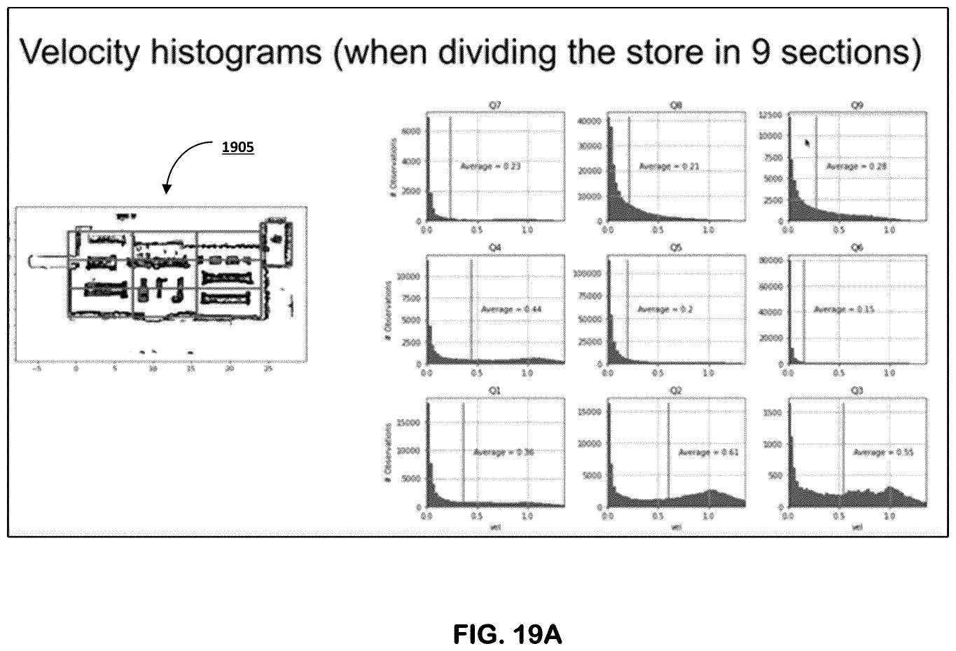

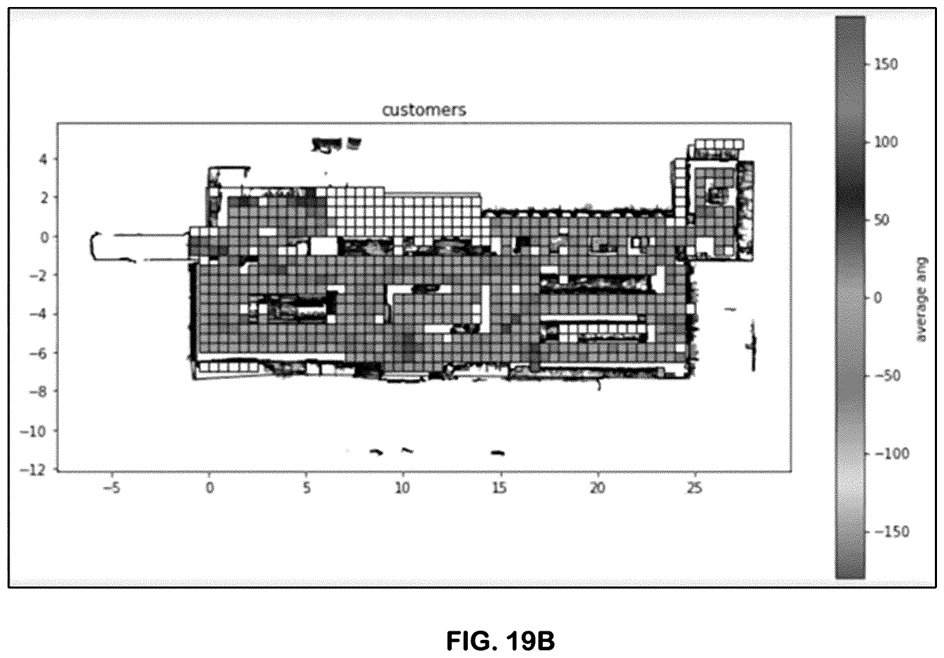

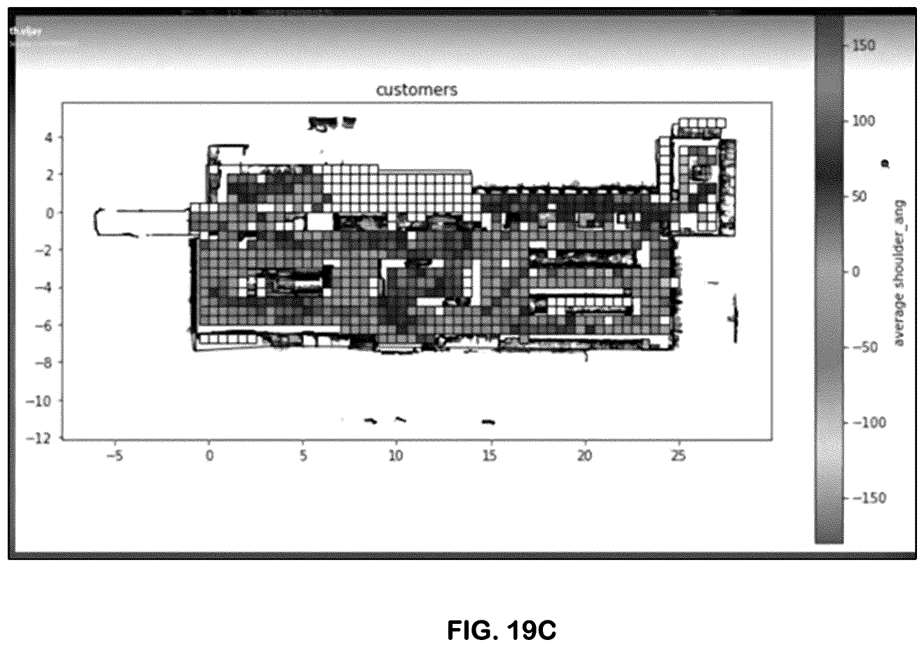

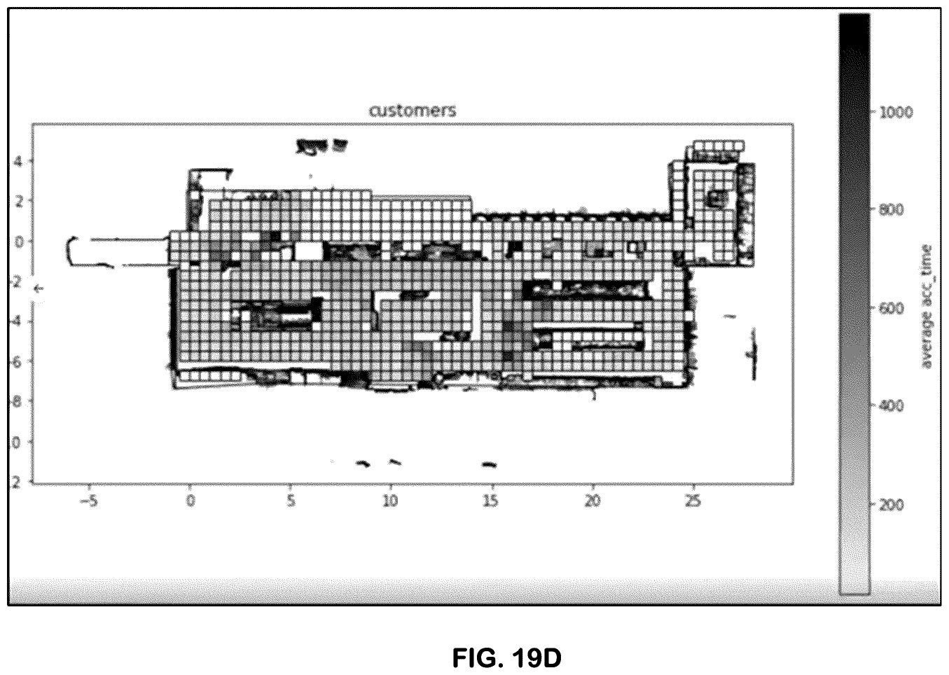

FIG. 19A presents histograms of average velocities of subjects when the store is divided in nine sections as shown in illustration 1905. It is understood that larger number of sections or smaller number of sections of stores can be created for generating velocity histograms as shown in FIG. 19A. Such histograms can be used to analyze behavior of subjects (such as velocity, gaze directions, etc.) per section or subspace of the area of real space.

FIG. 19B presents a heatmap with average angle of orientation of subjects in the area of real space. The angle of orientation is the angle at which the subject's shoulders are facing with respect to a vertical axis or a horizontal axis representing respectively the vertical or horizontal boundary of the area of real space or the boundary of a section of the area of real space. The technology disclosed can compute the locations of the left and right shoulder joints of a subject as viewed from the top by the cameras installed on the ceiling of the area of real space. It is assumed that the neck joint is located in between the left and the right shoulder joints. The angle of orientation of the subject can be calculated as an angle formed between a line connecting the left and right shoulders and a line representing either the vertical axis or the horizontal axis of the area of real space. A gaze direction of the subject can be determined using the angle of orientation. In one instance it is assumed that gaze direction of the subject is perpendicular to the line connecting the left and right shoulder of the subject. As the subject can turn her eyes towards left or right while standing at the same position, the items positioned up to 50 degrees or more on the left and the right side of the perpendicular can be included in the field of view of the subject. The average angle of orientation can be calculated by taking an average of orientations of subjects per tile in the grid over thousands of tracks of subjects in the area of real space.

FIG. 19C presents a heatmap with average shoulder angle of orientation of subjects in the area of real space. The angle of orientation of the subjects (or the angle of orientation of the shoulder joints of the subjects) can be calculated as presented above. The average shoulder angle of orientation can be calculated by taking an average of shoulder angle of orientations per tile in the grid over thousands of tracks of subjects in the area of real space.

FIG. 19D presents a heatmaps that shows average time spent in the shopping store per tile in the grid. The dark colored area near the middle portion of image is where an ATM is positioned in the area of real space. Subjects spend a large amount of time in the ATM area. On the top left portion of the image there is an entrance to restrooms. Subjects spend some time in front the entrance as shown by the dark colored regions. The analysis presented in this illustration and other illustrations presented earlier can identify most common patterns of subjects' behavior in shopping stores.

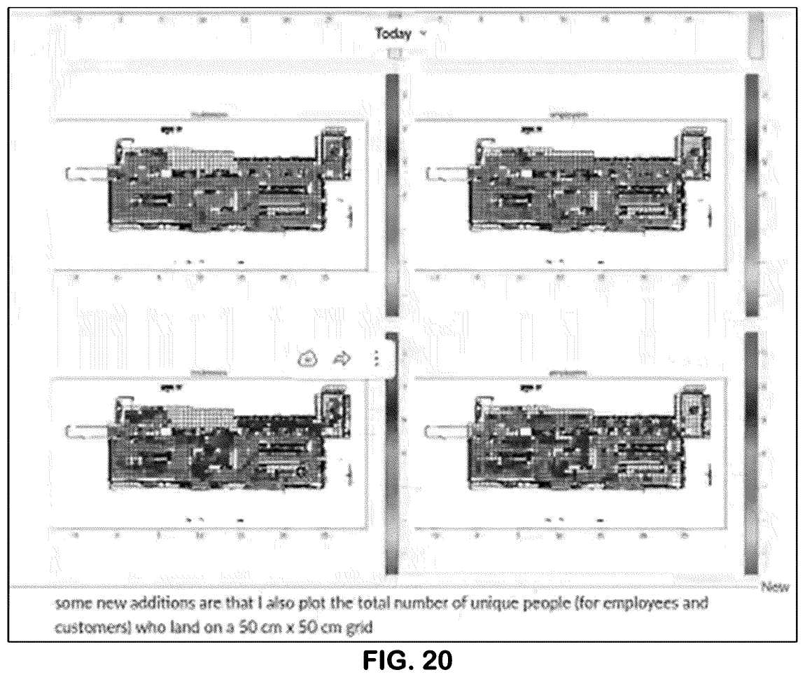

FIG. 20 presents various heatmaps with unique subjects identified per tile (or cell) in the grid of the area of real space. A tiles size of 50 cm by 50 cm can be used to generate illustrations presented in FIG. 20. Other sizes of tiles greater than 50 cm by 50 cm or smaller than 50 cm by 50 cm can be used to generate similar results.

The technology disclosed can build a pedestrian model using the spatial data analytics presented above. Such pedestrian model can be used to predict paths of subjects in the area of real space. For example, when a subject enters the area of real space and turns right for example, the model can generate a predicted path of the subject that can identify the potential shelves where the subject will go and the potential items that the subject will likely purchase. The technology disclosed can then provide targeted advertisement, coupons, promotions, etc. to the subject to increase takes of items along the subject's predicted path as the subject moves in the area of real space. As the model can predict where the subject is likely to go next, the technology disclosed can provide targeted advertisements and promotions to the subjects for items positioned along the predicted path of the subject. Using such information from path prediction models, the technology disclosed can guide subjects to purchase certain items or provide suggestions for items that the subject is likely to purchase. The technology disclosed can therefore provide targeted advertisement and promotions to subjects thus increasing the number of items that the subject will likely take from shelves or other inventory display structures.

The technology disclosed can perform the above analysis and operations using anonymous subject tracking data related to subjects in the area of real space as no personal identifying information (PII), facial recognition data or biometric information about the subject may be collected or stored. If the subject has checked in to the store app, the technology disclosed can use certain information such as gender, age range, etc. when providing targeted promotions to the subjects if such data is voluntarily provided by the subject when registering for the app.

In one implementation, the technology disclosed can implement trained machine learning models that can detect the gender of a subject or detect whether a subject is an adult or a child using anonymized image processing. The anonymized image processing may not process facial features of the subject that may uniquely identify a subject but rather user other features extracted from non-facial regions of the images of subjects to detect gender or detect whether a subject is an adult or a child. The technology disclosed may not store the images of subjects captured from sensors in the area of real space to protect their privacy. Rather the feature vectors generated by processing non-facial images of subjects may be stored for generating various spatial analytics. It is therefore not possible to uniquely identify a subject from such data and such data may not be reverse engineered to generate a real world identity of a subject.

In one implementation, purchase history of subjects may be available in a store app which the subjects use to checkout from the shopping store. Such data can be analyzed by the technology disclosed to provide suggested items to subjects while they are moving in the area of real space.

In one implementation, shopping cart data for the subjects can be used to correlate the pedestrian paths with takes of items from the shelves. Such shopping cart data can be correlated with velocity or dwell heatmaps.

The spatial analytics presented above can help the store owners or store management to generate more revenue from popular sections of areas in a shopping store. Shelves or sections with high dwell time or hotspots in the store can be sold at a higher cost to vendors for placing their items as it is more likely that subjects will purchase an item from those shelves.

In one implementation, the subject tracks and heatmaps can be filtered based on various criteria such as employees vs. shoppers, subjects who have checked in vs. the ones who have not checked in. The technology disclosed can categorize subjects based on different criteria (e.g., age, sex, demographic, height, weight, etc.). The technology disclosed can then filter out the subject tracks, or heatmaps based on these criteria. The technology disclosed can distinguish between subjects who made purchase and subjects who did not make a purchase. Some of the criteria (e.g., sex, age or age range, etc.) can be determined using images from camera. The images of subjects may not be stored rather the feature vectors or other encoded data generated from images may be stored.

The technology disclosed includes logic to classify subjects (such as shoppers) into various categories (e.g., gender, age range, etc.) for filtering out the subject tracks and generating spatial analytics per category of subjects in the area of real space.

In one implementation, the technology disclosed includes logic to enable shoppers to virtually visit an area of real space and move in aisles and other spaces. The technology disclosed can track subjects who are virtually (e.g., in a metaverse) shopping and use that data for generating the various analytics and heatmaps presented herein. In one implementation, the subject may use virtual headsets, digital goggles, or digital glasses to track gaze directions of subjects while they are virtually moving in the area of real space. The technology disclosed can also collect other data from virtual shopping of subjects e.g., from digital headsets, digital glasses, goggles, etc. for use in spatial analytics.

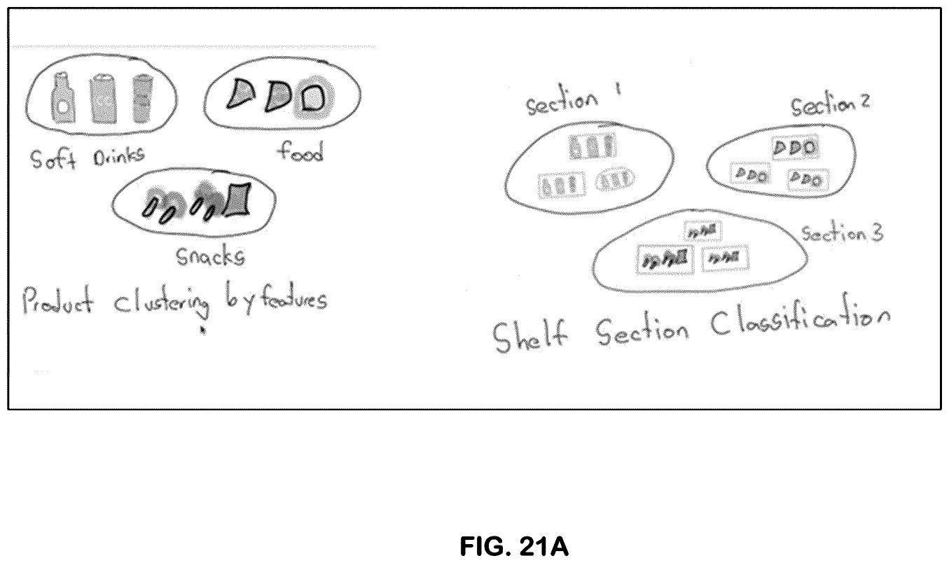

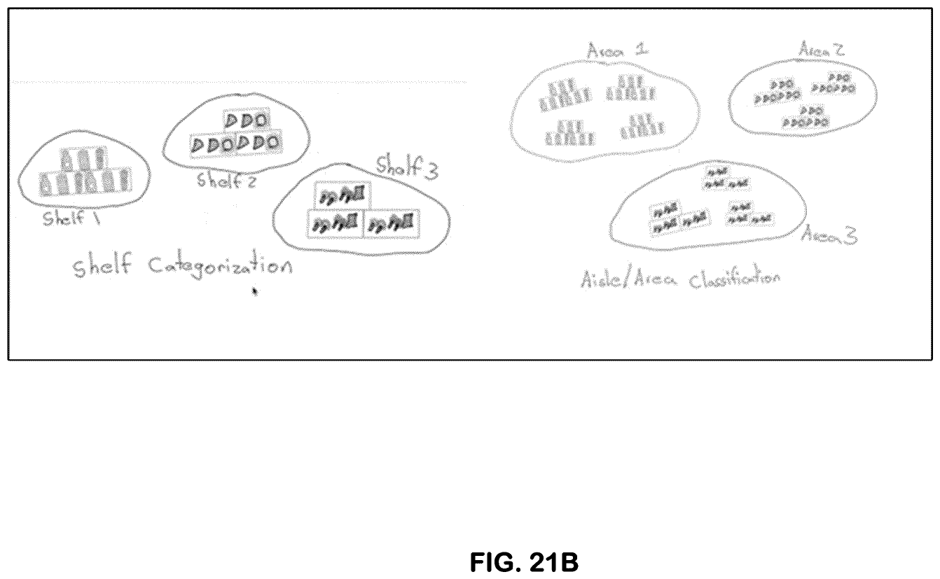

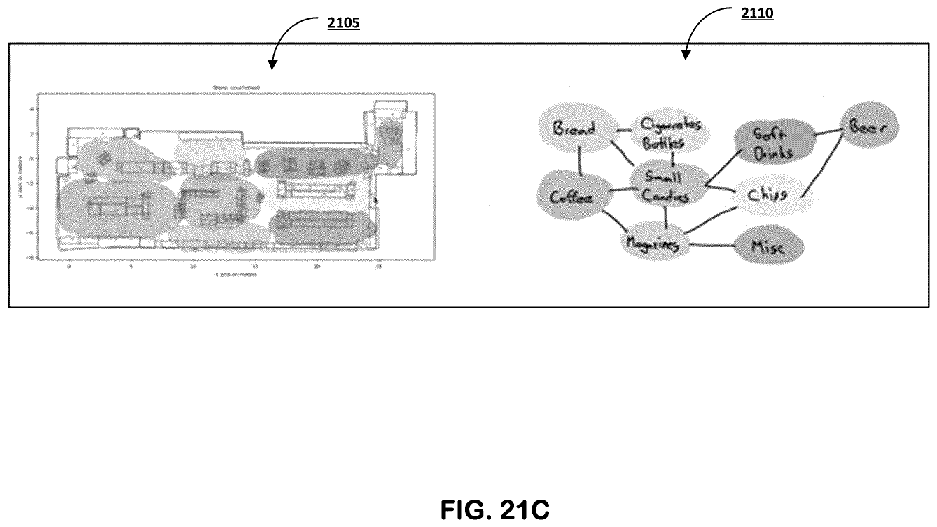

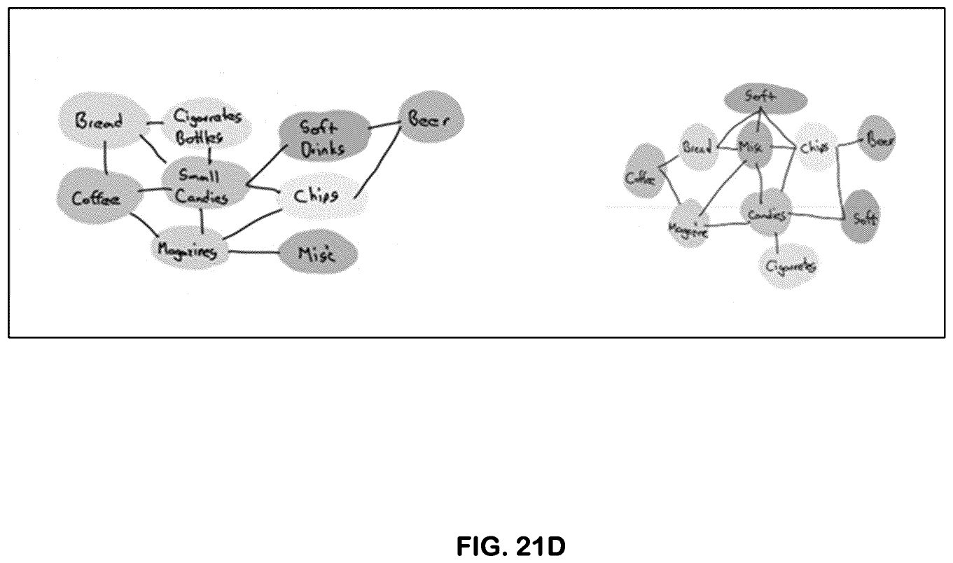

FIGS. 21A to 21D present various types of classifications that be performed by the technology disclosed for semantic classification subspaces in the area of real space. The semantic classification of subspaces classifies the subspaces in the area of real space based on their meaning such as based on types of products in subareas of the real space. The technology disclosed can use the pedestrian paths to learn about trajectories of subject within and across different subspaces in the area of real space. This analysis can help store owners or store management to learn about transitions of subjects between different subspaces and how different subspaces can be arranged to improve the shopping experience for subjects and increase takes of items by subjects.

The basic unit in the area of real space is an inventory item (or an item) that can be identified by data such as brand, variety, size, UPC (universal product code), category, subcategory etc. For example, an inventory item can be defined as below in an item data structure:
Brand=Powerade™
Variant=Mountain Berry
Size=28 oz.
Category=Packaged Beverages
Subcategory=Sports Drinks

FIG. 21A presents product clustering (or item clustering, or item grouping) using features of the products. Some examples of features are presented in the inventory item data structure above. For example, items can be clustered by subcategory, category, brands, etc. Similarly, shelves in the area of real space can be grouped or clustered based on the types of product groups displayed on respective shelves. For example, section 1 of shelves can contain drinks, section 2 of shelves may contain snacks, section 3 may contain food items, etc.

FIG. 21B presents further categorization of shelves using the groups or clusters of products displayed on shelves. Shelves displaying items from one group or a selected product groups may be placed in one section or subspace of the area of real space. These subspaces are labeled as Area 1, Area 2, Area 3 in FIG. 21B. The technology disclosed can use the pedestrian paths to learn about trajectories of subjects within and across different areas or subspaces in the area of real space. The technology disclosed can learn about transitions between different areas and how different areas can be arranged to improve the shopping experience for the subjects and increase takes of items by subjects. Patterns of pedestrian paths and their respective success in terms of takes of items can be determined. Such patterns can be replicated across different shopping stores.

FIG. 21C presents mapping of areas or sections that are determined using the above presented classification technique to physical areas in the store (labeled as 2105). The connected graph 2110 presents clusters or groups of products as nodes and connected via edges that represent connecting paths between the areas in which those groups or clusters of products are placed in the area of real space.

FIG. 21D presents another variation of placement of sections or subspaces in the area of real space. The technology disclosed enables store owners or store management to try various arrangements of shelves in sections and various arrangements of sections in the shopping store improve flow of subjects and takes of items from shelves. Such analysis can also help to reduce or remove any areas where congestion happens in the store.

### Predicting Path of New Shoppers in a Shopping Store

The technology disclosed includes logic to predict paths of subjects in the area of real space. The area of real space can represent a shopping store, an airport, a sports arena, a library, a train station, a shopping mall, a warehouse or goods distribution center, etc. In the following example, features of the technology disclosed are illustrated using the example of a shopping store. However, these features can be applied for tracking subjects, detecting interactions of subjects with their surroundings and predicting paths of new subjects that enter the area of real space other types of environments. Further, the technology disclosed performs these operations without using personally identifying information (PII) such as biometric information of subjects. Examples of personally identifying information (PII) include features detected from face recognition, iris scanning, fingerprints scanning, voice recognition and/or by detecting other such identification features. Even though PII may not be used, the system can still identify subjects in a manner so as to track and predict their trajectories and/or paths in an area of space. The shopping store can include inventory display structure such as shelves, baskets, etc. The shelves can be arranged in aisles or along the walls of shopping store. A shelf can be divided into multiple sections. A section of a shelf can be used to store one type of inventory items or inventory items that belong to a same product family. Sections of shelves such as up to 10 inches or more can be used to display particular inventory items. The items can be arranged according to a product placement plan such as a planogram etc.

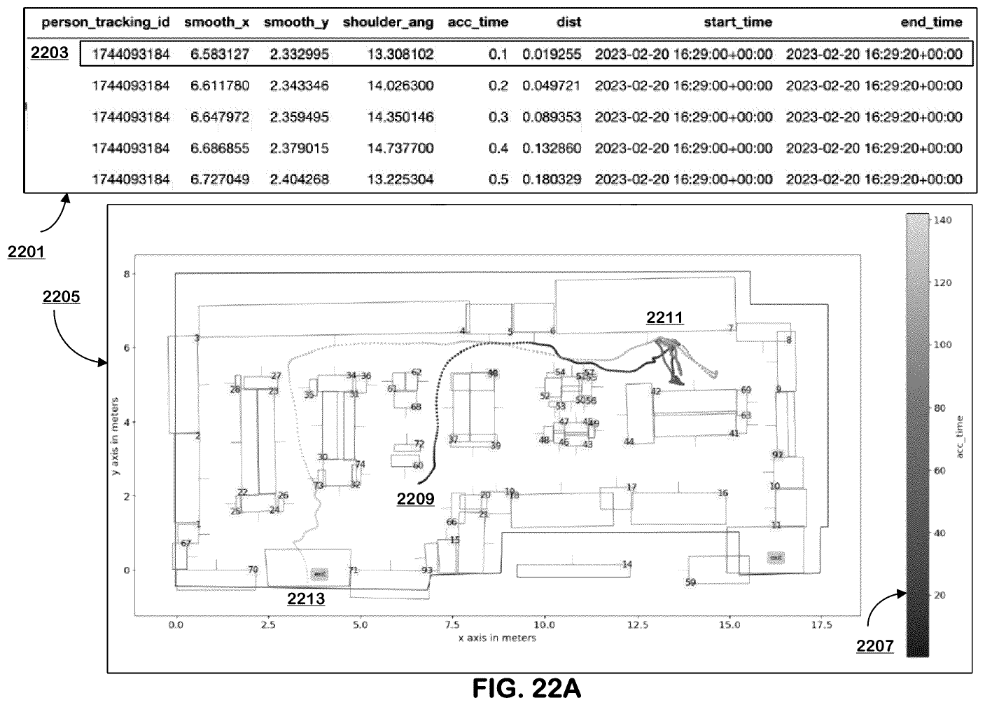

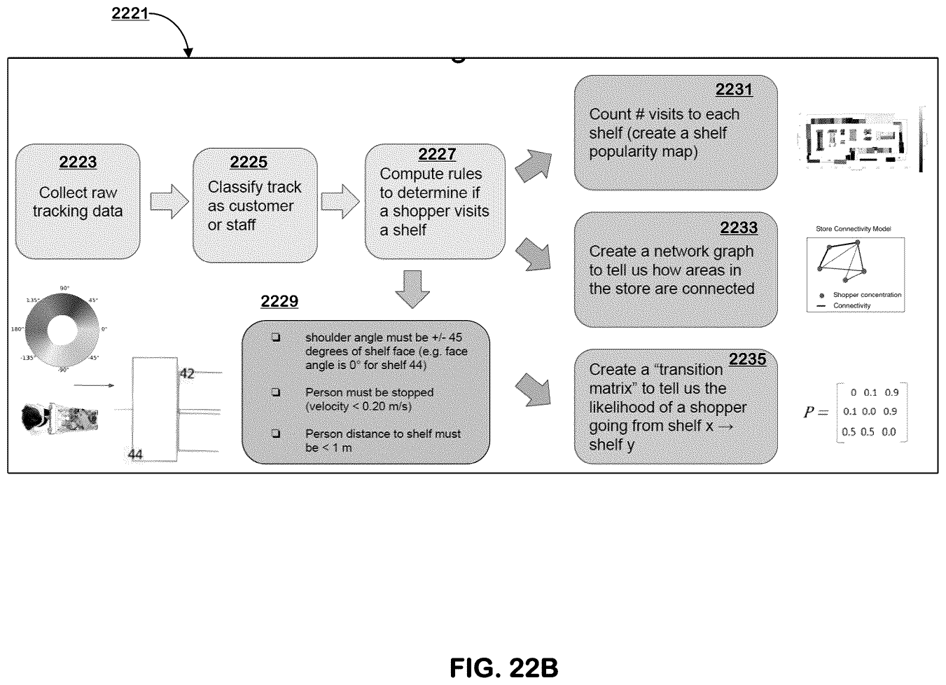

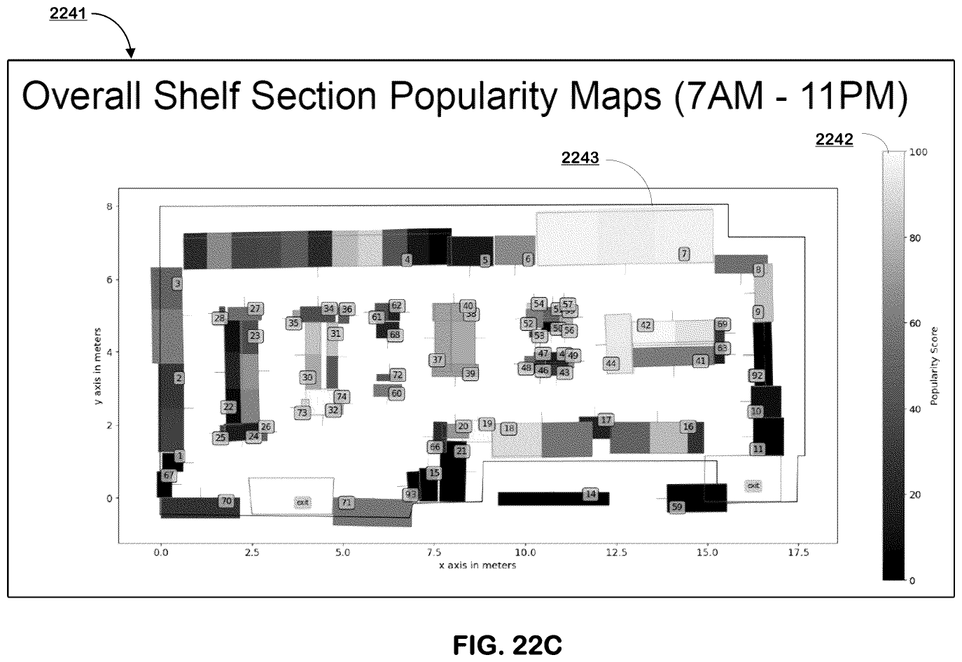

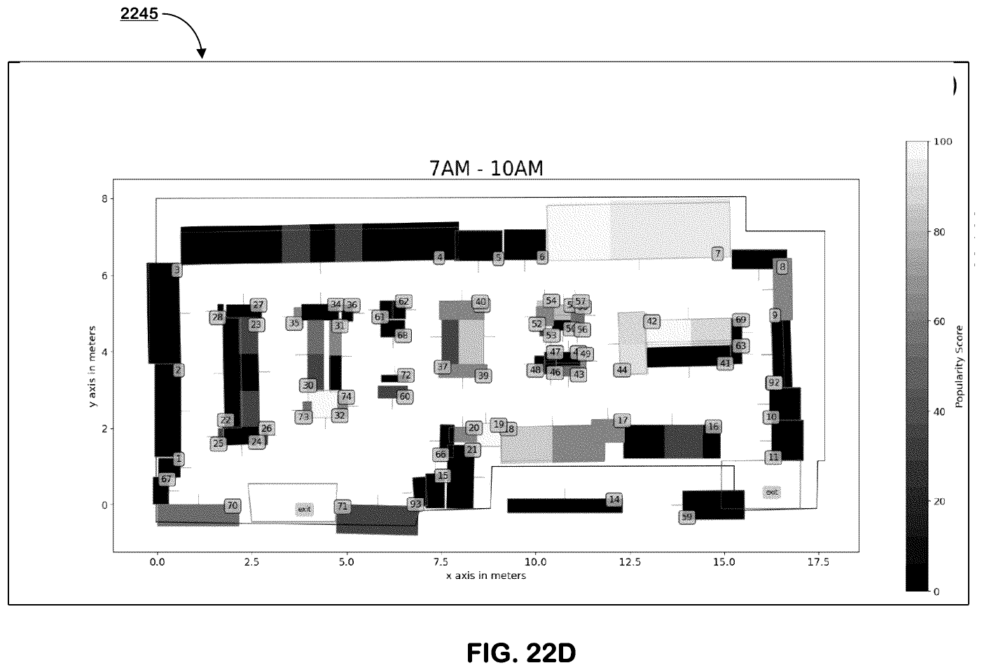

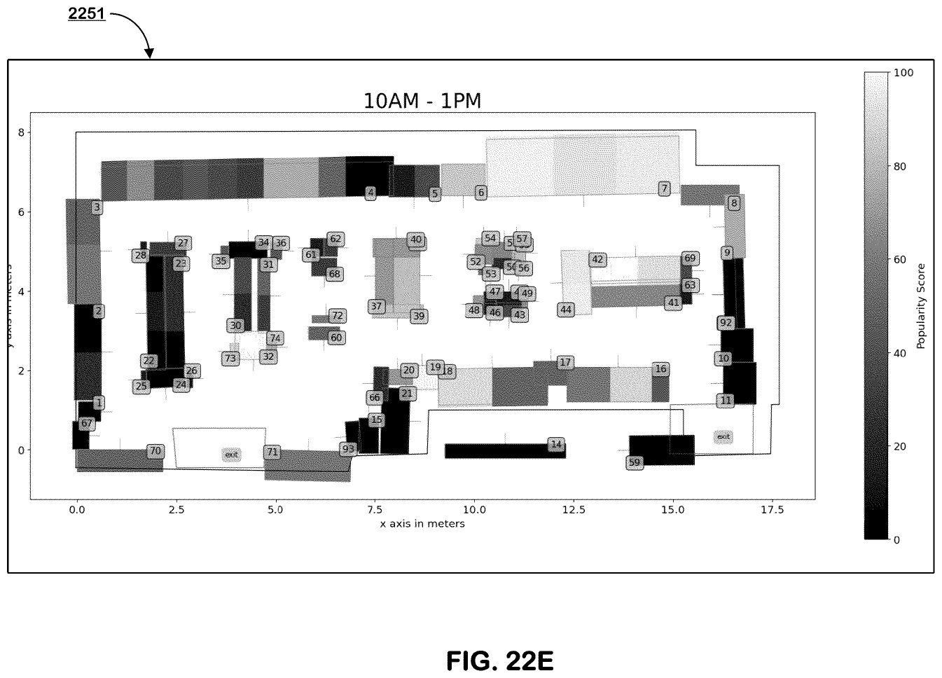

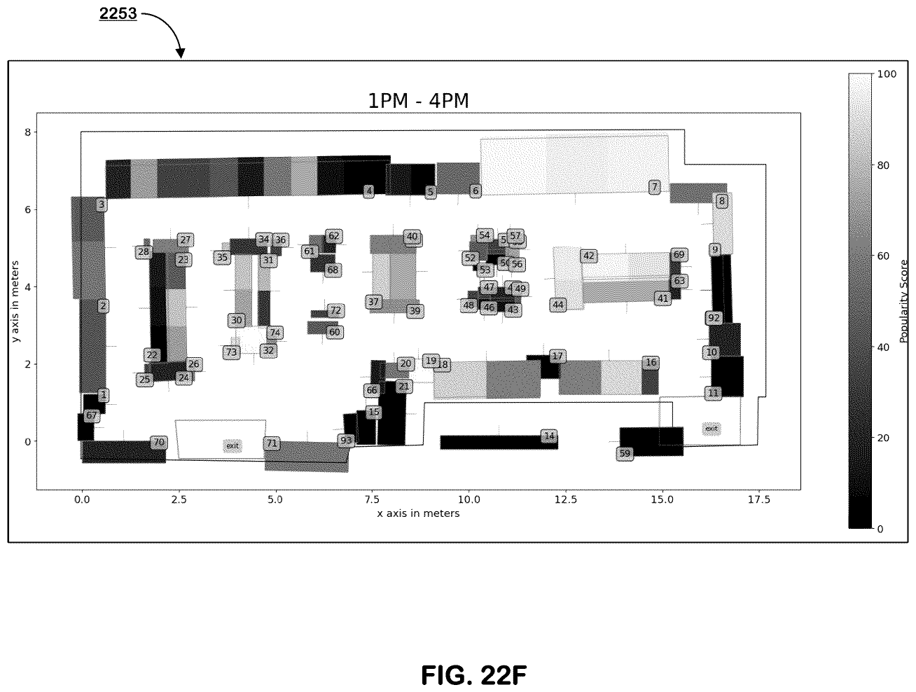

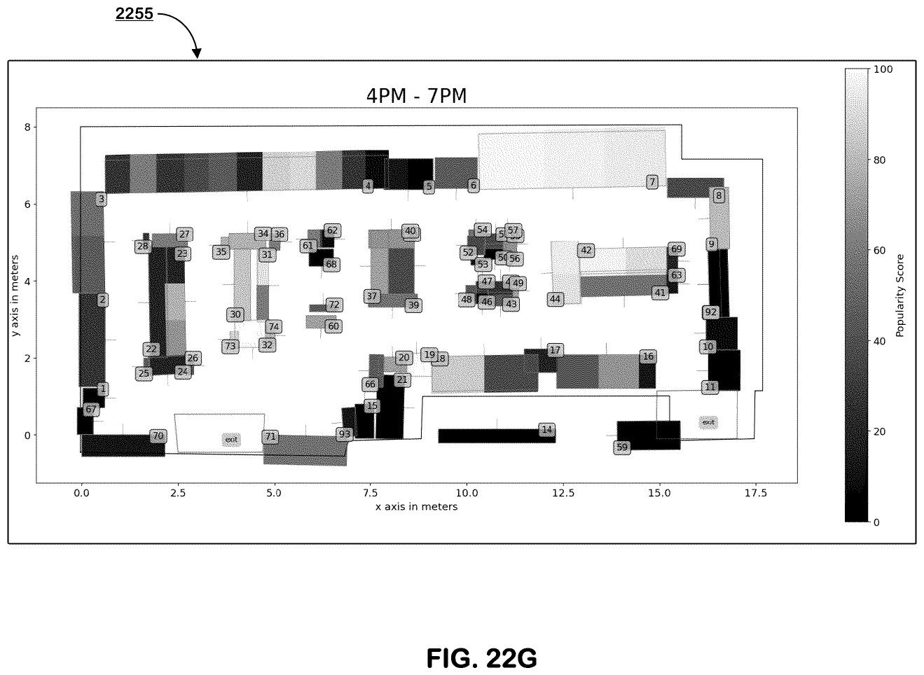

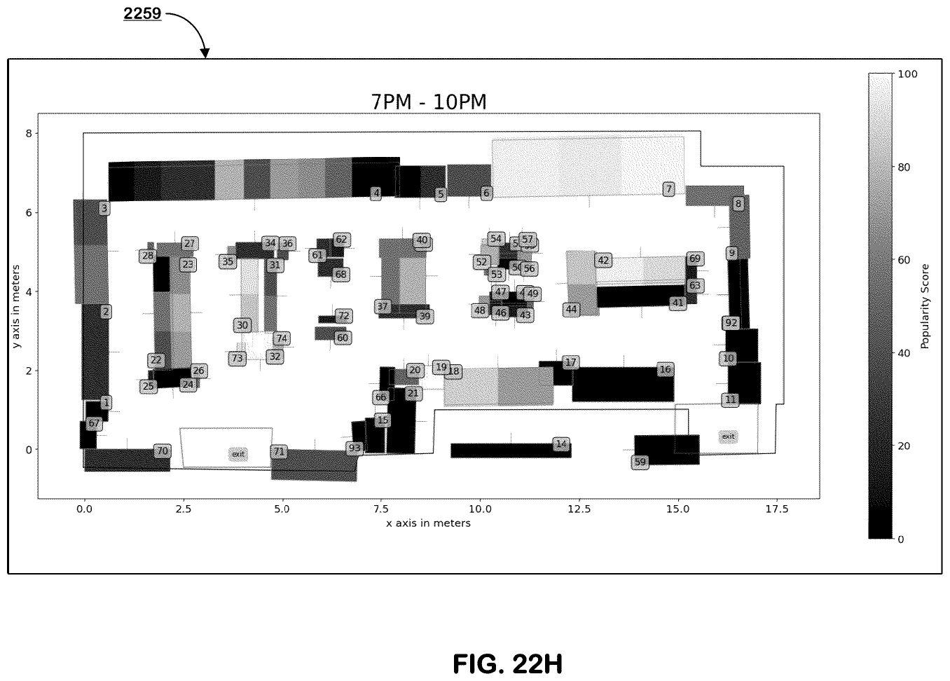

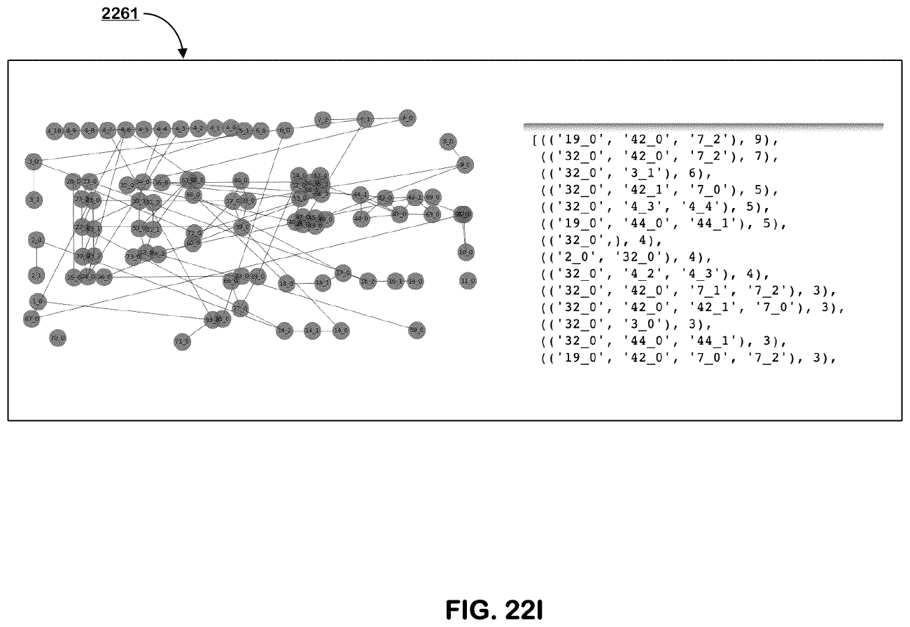

FIG. 22A presents subject tracking data or subject track representing path of a subject (such as a shopper) in the area of real space. A table 2201 presents data from subject tracking logic as described herein. A subject is assigned an identifier referred to as a subject identifier (or person identifier or “person_tracking_id”). This identifier is used to track subjects in the area of real space over a period of time. Note that the technology disclosed anonymously tracks subjects (such as shoppers or employees) in the area of real space. The subjects can be tracked by identifying their respective joints over a period of time as described herein. Other non-biometric identifiers such as the color of a shirt or a color of hair, etc., can be used to disambiguate subjects who are positioned close to each other. The technology disclosed does not use biometric data of subjects or other personal identification information (PII) to identify and/or track subjects. The technology disclosed does not store biometric or PII data to preserve privacy of subjects including shoppers and employees. A row 2203 in the table 2201 represents a location of a tracked subject in the area of real space. The technology disclosed comprises a plurality of sensors (such as wide-field view (WFV) and/or narrow field view (NFW) cameras installed in the area of real space. The sensors can produce respective sequences of frames of corresponding fields of view in the real space. The identification device 196 comprises logic to identify, for a particular subject, a determined path in the area of real space over a period of time. The determined path can comprise a plurality of data points, collectively forming the determined path of the particular subject. Each data point can include data such as a subject identifier, one or more locations in the area of real space as identified by positions along X, Y and Z coordinates and one or more timestamps. An example of a data point is represented by a row of data in the table 2201. A row 2203 includes a tracking identifier of the subject being tracked, an x and y location of the subject on a two-dimensional surface representing the floor of the area of real space. The row 2203 can also include a shoulder angle of the subject with respect to a shelf location closest to the current location of the subject. The row 2203 can also include a total time accrued since the tracking of the subject has started in the area of real space. The row 2203 can include a start time timestamp and end time timestamp during which the subject tracking data is generated. This duration can range from one hundredth of a second to one tenth of a second or up to half a second. Longer duration ranges such as up to one second or more can also be used. In one implementation, the technology disclosed can use a selected frame from this time duration for identifying and tracking a subject. In another implementation, the technology disclosed can use a plurality of frames from the time durations to identify and track subjects. In such an implementation, the technology disclosed can combine the plurality of frames, e.g., by taking an average across the plurality of frame to determine the location, and shoulder angle values for the subject. A graphical illustration 2205 shows the path of the subject by plotting each row in table 2201 on a two-dimensional map of the area of the real space. The tracking starts from a location 2209 and ends at a location 2213 representing an exit from the area of real space. The subject spends more time closer to a location 2211 representing a coffee counter. The technology disclosed can present the path of the subject in a color-coded format according to a legend 2207. The darker colors (close to the bottom of the legend 2207) represent less accumulated time and lighter colors indicate more accumulated time in the area of space. The path of the subject starting from location 2209 is illustrated in darker color. The path is represented in a lighter color as the subject spends more time in the area of real space. The accumulation device 197 includes logic to accumulate multiple determined paths in the area of real space for multiple subjects over a period of time. This period of time can range from a few minutes to several months and years.

FIG. 22B presents an example process 2221 for generating various types of analytics for a shopping store using the subject tracking data of FIG. 22A. The subject tracking data is collected at an operation 2223. The technology disclosed includes logic to classify the tracks of shoppers from tracks of store employees using various types of techniques as described with reference to FIG. 6C (operation 2225). It is understood that the technology disclosed can use additional techniques to distinguish shoppers from employees. For example, in one implementation, the technology disclosed can use a dedicated zone (or area) for employees. The employees once detected from the employees only areas are then tracked as they move in other parts of the shopping store. The technology disclosed includes logic to apply rule-based classification to determine visits of shoppers to shelves (operation 2227). Some examples of rules that can applied to determine if a shopper visits a shelf are presented in a box 2229. These rules are used by the matrix generation device 198 to determine interaction of shoppers (also referred to as subjects) with items placed on shelves or other types of inventory display structures. A first rule is based on an orientation of a subject with respect to a shelf (or a front plane of a shelf). When the logic implemented by the matrix generation device 198 determines that the angle between a plane formed by joining shoulder joints of a shopper and the plane representing the front-side of the shelf is 45 degrees or less than an interaction between the shopper and an item placed on a shelf occurred. Note that an interaction of a subject with an item can include the subject taking the item from the shelf (or another type of inventory display structure). An interaction can also indicate a subject placing an item back on the shelf. An interaction of a subject with an item can include the subject touching the item on the shelf but not taking it from the shelf. An interaction can also include a subject looking at the item placed on the shelf indicating an interest of the subject in the item. A second rule for determining if an interaction occurred between a subject and an item, determines whether a subject stopped at a location in the area of real space. In one implementation, the technology disclosed considers that the subject has stopped when the subject's speed of movement becomes slower than a predefined threshold. For example, when the speed of movement of the subject is below 0.20 meters per second, the technology disclosed considers that the subject has stopped at a location and interacted with an item. Other values of this threshold such as less than 0.25 meters per second or less than 0.30 meters per second can be used to determine that a subject has interacted with the item. Other threshold values will be apparent to a person of ordinary skill in the art that would indicate that a subject has slowed down enough to take interest and/or interact with an item. A third rule for determining if an interaction of a subject occurred with an item uses a distance of the subject from the shelf. If the distance of the subject from the shelf is less than 1 meter then it is determined that an interaction of the subject has occurred with the item on the shelf. In one implementation, all three rules (or conditions) described above must be true for determining that an interaction of the subject has occurred with the item. In another implementation, at least two rules of the three rules described above must be true for determining that an interaction of the subject has occurred with the item. The shelf popularity score calculation device 191 can generate the count of visits to each shelf (or a section of a shelf) using the subject tracking data presented above. The number of counts of visits to shelves can be used to determine a shelf popularity map indicating the shelves that are more popular i.e., the shelves that contain items receiving more interaction from subjects as compared to other items (operation 2231). In one implementation, the technology disclosed can include logic to train a machine learning model and use the trained machine learning model to perform detect interactions of shoppers with shelves and/or inventory items and to predict path of new subjects in the shopping store. The training device 194 includes logic to train a machine learning model for predicting the path of the subject in the area of real space. The training device 194 includes logic to input, to the machine learning model, labeled examples from training data. An example in the labeled examples comprises at least one determined path from the accumulated multiple paths for multiple subjects. The training device 194 includes logic to input to the machine learning model a map of the area of real space comprising locations of shelves in the area of real space. The training device 194 includes logic to input to the machine learning model labels of products associated with respective shelves in the area of real space. The technology disclosed can include logic to use the trained machine learning model to predict the path of the new subject in the area of real space by providing, as input, at least one interaction of the new subject with an item associated with the first location in the area of real space. The one interaction can include interaction (such as take, put, view, touch, etc.) with an item on the shelf.

The layout generation device 200 includes logic to create a network graph to show how different areas of the shopping store are connected (operation 2233). The nodes in the graph can represent sections of shelves, shelves, groups of two or more shelves, etc. The nodes can also represent departments in a shopping store such as dairy, vegetable and fruits, drinks, apparel, electronics, etc. The connections can indicate the flow of shoppers from one shelf (or section) to another shelf. The connections can also include additional information such as a probability of a shopper moving from a node to another node. The higher the probability values, the higher the likelihood that a new shopper will move from a source node to a destination node. This information can be used by shop owners or managers to arrange shelves in such a way that shoppers move across most areas of a shopping store. This can help increase the sales as shoppers move from one area to another, they can pick items along their path. The layout generation device 200 comprises logic to change a preferred placement of a particular item, in dependence on the predicted path, from an existing location to a new location in the area of real space to increase interaction of future subjects with the particular item. The layout generation device 200 further includes logic to change a preferred placement of a shelf containing the particular item, in dependence on the predicted path, from an existing location to a new location in the area of real space to increase interaction of the future subjects with the particular item contained within the shelf.

The matrix generation device 198 includes logic to generate a transition matrix using the subject tracking data based on the accumulated tracks of subjects in the shopping store (operation 2235). An element in the transition matrix identifies a probability of a new subject moving from a first location to at least one of other locations in the area of real space. For example, a value of 0.8 in an element (i, j) at the intersection of ith row and jth column of the transition matrix indicates that there is an 80% likelihood that a new shopper in the shopping store will move from shelf “i” to shelf “j”.

FIGS. 22C to 22H present various examples of shelf popularity scores calculated using the technology disclosed. The shelf popularity score calculation device 191 includes logic to calculate the popularity of a shelf, a section or a portion of a shelf in dependence on the interactions of users with the shelf. The shelf popularity score can be calculated for a period of time such as for a one-hour period, a three-hour period, a six-hour period, a twelve-hour period or a twenty-four hour period. Other durations less than an hour or a greater than twenty-four hours can also be used when determining a popularity of shelf. The count of visits of subjects (such as shoppers) to the particular shelf over a desired period of time can be used to determine the popularity score for a shelf.

FIG. 22C presents shelf popularity scores for shelves of a shopping store in a map 2241 of the shopping store, illustrating placement of shelves. The colors of shelves indicate their respective shelf popularity scores. A legend 2242 shows popularity scores as represented by a range of colors. A dark colored shelf indicates lower shelf popularity score while a lighter colored shelf indicates a highly popular shelf. The scores range from zero (“0”) for dark colored shelves and gradually increase for lighter colored shelves up to a shelf popularity score of one hundred (“100”). The shelf popularity score can be normalized to a range between zero (“0”) and one hundred (“100”). Other scales can be used to illustrate shelf popularity scores such as zero to ten or zero to two hundreds, zero to one thousands, etc. The shelf popularity score can be displayed on the map without normalizing the score to a range between zero and one hundred. A light colored shelf (labeled “7”) in the map 2242 appears to be popular amongst shoppers as illustrated by a light color indicating a high shelf popularity score. The shelf (2243) labeled as “7” is a coffee counter where self-serve coffee machines are placed. The shelves (labeled “42” and “44”) opposite to the coffee shelf (“7”) contain pastries. The shoppers usually take pastries after taking their coffee therefore, these shelves also have a higher shelf popularity score. The illustration of shelf popularity scores as shown in FIG. 22C represent visits to shoppers to between 7 AM to 11 PM. The technology disclosed can generate shelf popularity scores for shelves of a shopping store for smaller periods of time such as one hour, two hour, three hours, etc. For example, FIGS. 22D to 22H present shelf popularity scores for shelves of the same store as shown in FIG. 22C for three-hour time intervals at different times of the day. This type of data can help store owners and/or store managers to view how shoppers interact with products at different times in a day. The shelf popularity maps can be generated for different days of the week or different months in a year.

FIG. 22D presents shelf popularity scores for the same shopping store as in FIG. 22C. The illustration 2245 presents a shelf popularity score map for shopper visits for a period of three hours from 7 AM to 10 AM.

FIG. 22E presents shelf popularity scores for the same shopping store as in FIG. 22C. The illustration 2251 presents a shelf popularity score map for shopper visits for a period of three hours from 10 AM to 1 PM.

FIG. 22F presents shelf popularity scores for the same shopping store as in FIG. 22C. The illustration 2253 presents a shelf popularity score map for shopper visits for a period of three hours from 1 PM to 4 PM.

FIG. 22G presents shelf popularity scores for the same shopping store as in FIG. 22C. The illustration 2255 presents a shelf popularity score map for shopper visits for a period of three hours from 4 PM to 7 PM.

FIG. 22H presents shelf popularity scores for the same shopping store as in FIG. 22C. The illustration 2259 presents a shelf popularity score map for shopper visits for a period of three hours from 7 PM to 10 PM.

FIG. 22I presents a graphical illustration 2261 representing connectedness of shelves in the area of real space. The graph 2261 comprises nodes representing shelves in the area of real space. The nodes are connecting via edges. The edges can represent distances between respective shelves. The edges can also represent a strength of connection between two shelves by weighting distances between shelves with values from respective transition matrix elements from the transition matrix. The transition matrix elements represent the probability of a shopper going from a source shelf (represented as a node in the graph) to a destination shelf (represented as a node in the graph). Higher values of transition elements will increase the weight of edge thus indicating a higher strength of connection between shelves.

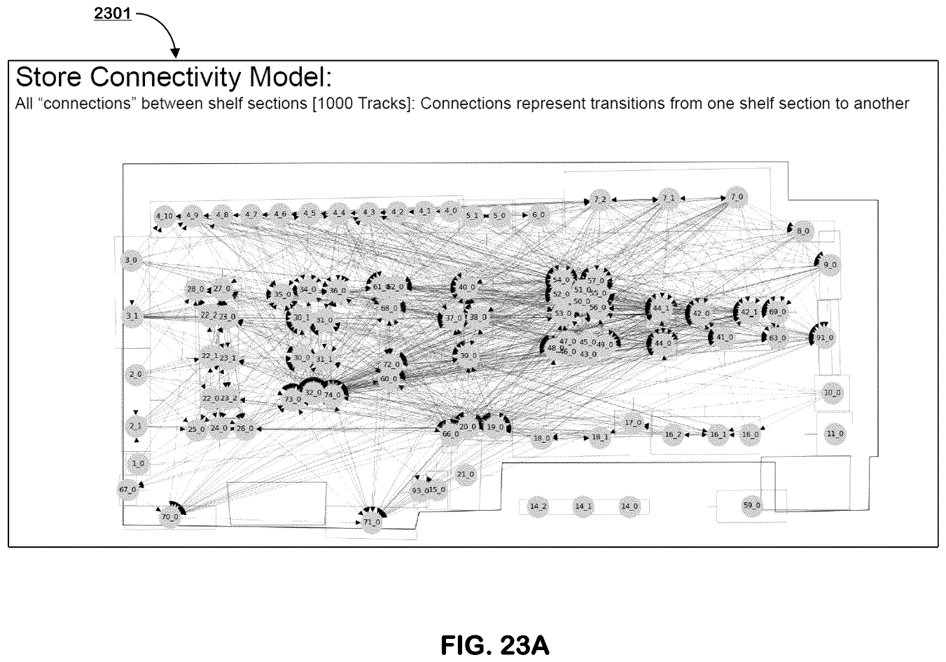

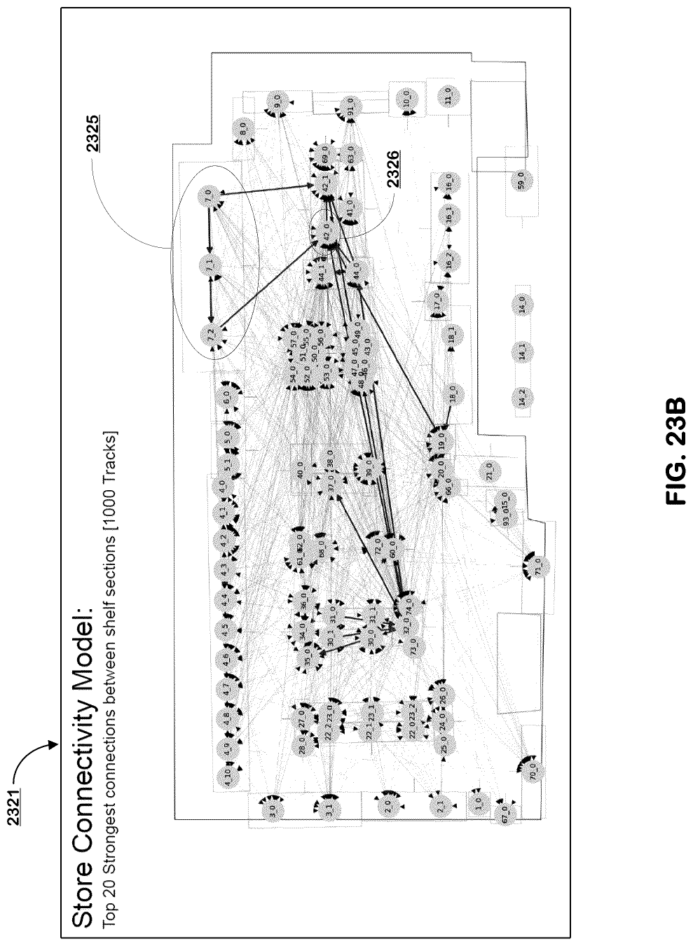

FIGS. 23A and 23B present graphical illustration of connectedness of shelves in a shopping store. A graph 2301 comprising nodes and edges. The nodes represent shelves and edges represent connections between shelves. Two shelves have a higher connectedness or a higher coupling when the distance between the shelves is less and the likelihood of a shopping visiting a second shelf from a first shelf is high. The likelihood of a shopper visiting a second shelf (destination shelf) from a first shelf (source shelf) is presented in a transition matrix. The transition matrix is generated using interaction data from subject tracks in the shopping store. For example, the graphical illustration 2301 of connectedness of shelves as shown in FIG. 23A can be generated using interaction data collected from one thousand subject tracks in the shopping store. Fewer than one thousand or greater than one thousands subject tracks can be used to generate the graphs illustrating connectedness of shelves in the shopping store.

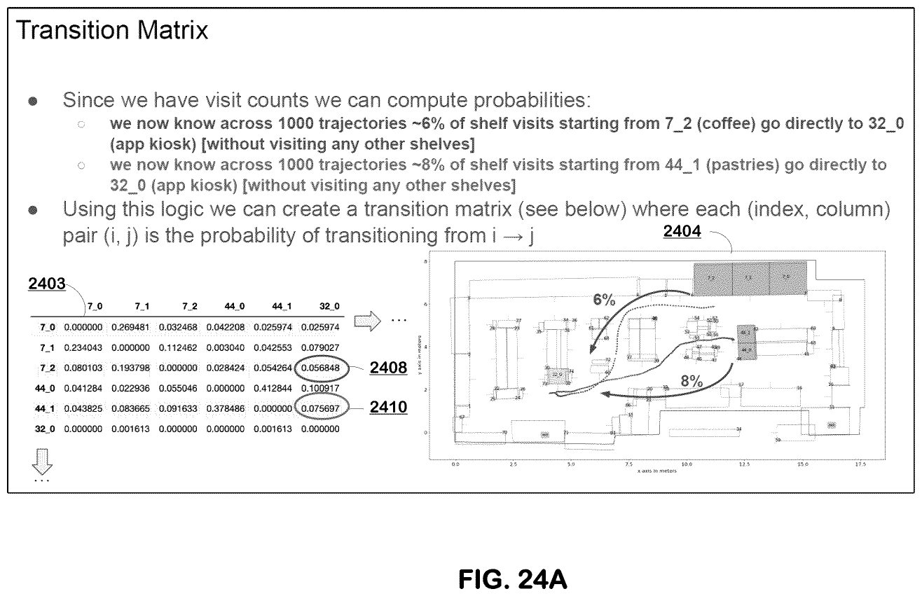

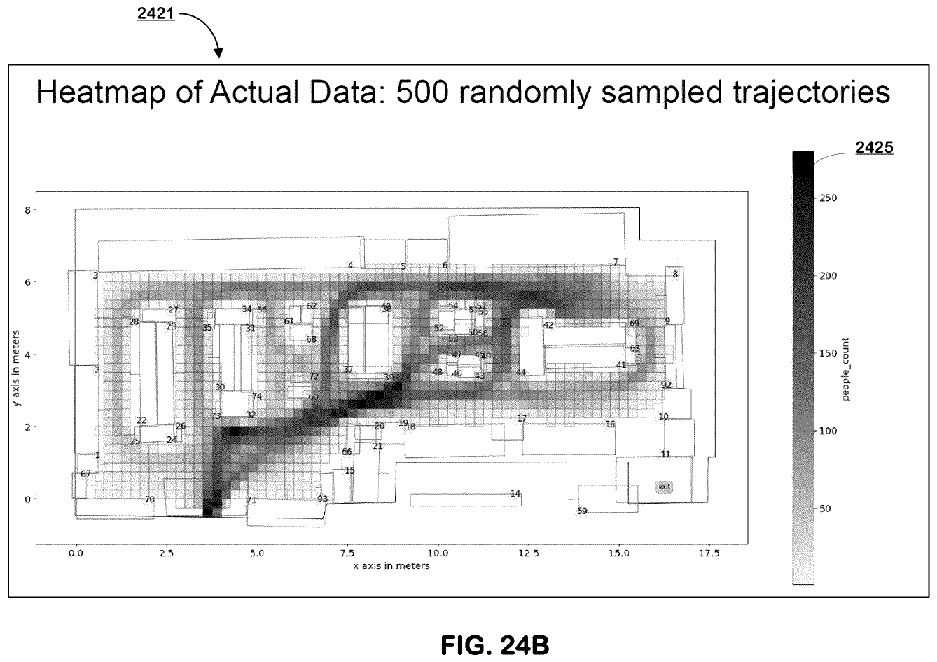

FIG. 23B presents selected connections between nodes to reduce the number of edges in the graph. The graphical illustration 2321 in FIG. 23B shows top twenty strongest connections from a shelf to other shelves in the area of real space. A bold line with edges is also shown indicating a possible path of a shopper in the shopping store. For example, three shelves in the oval 2325 represent shelves where shoppers go to get their coffee. The shelves are labeled as 7_0, 7_1 and 7_2 from right to left in the oval 2325. A shopper picks a coffee cup from the shelf 7_0, fills the cup with coffee at the shelf 7_1 and puts cream and sugar in the coffee at the shelf 7_2. The shopper then picks up a lid for the cup of coffee from the shelf 7_2 and moves on. The edges (with directional arrows) therefore, show the sequence in which shoppers are likely to move from one shelf to another. The last of the three shelves (7_2) in oval 2325 is further connected to a shelf labeled 42_0 shown in an oval 2326. The shelf 42_0 contains pastries that can be taken by shoppers after getting their coffee. The edges i.e., directional arrows or directional edges, connecting the nodes, can be generated in dependence on subject tracks of hundreds or thousands of subjects who visit the shopping store. FIG. 24A presents an example transition matrix illustrating probabilities of subjects (such as shoppers) moving from a first (or a source) shelf to a second (or a destination) shelf in the shopping store. This logic can be applied repeatedly using the transition matrix to predict path of a new shopper in the shopping store. For example, a transition can be selected indicating a high probability that a subject will move from the second shelf to a third shelf and so on. Therefore, the technology disclosed can be used to predict a path of a subject from a first shelf to a last shelf before the shopper exits the shopping store. The rows and columns of the transition matrix represent shelves in the shopping store. For example, a matrix 2403 presents a portion of the transition matrix for a shopping store with a map 2404. The map 2404 shows shelves placed in the shopping store. An element (row index i, column index j) of the transition matrix contains a probability of a shopper moving from a shelf “i” to a shelf “j” in the shopping store. For example, based on the historical data obtained from subject tracks (such as one thousand subject tracks), it is determined that approximately 6% of the shoppers go from the coffee shelf (labeled 7_2) to a checkout location (labeled 32_0). Similarly, it is determined using historical subject tracking data that about 8% of the shoppers go from the pastries shelf (labeled 44_0) to a checkout location (labeled 32_0). These two probability values are presented in elements 2408 and 2410 of the transition matrix, respectively.

FIG. 24B presents a heatmap 2421 of subject tracking data of 500 randomly sampled trajectories in the shopping store with a map 2404 of FIG. 24A. The heatmap generation device 192 includes logic to generate a heatmap for the area of real space in dependence on a count of interactions of all subjects in the area of real space with all shelves in the area of real space. The heatmap generation device 192 includes logic to re-calculate the heatmap for the area of real space in dependence upon a change of a location of at least a first shelf in the area of real space. The heatmap shows areas of the shopping store where shoppers spend more time and/or perform more interactions with items on shelves. A legend 2425 shows that lighter colors of the heatmap indicate fewer shoppers and darker color indicates a larger number of shoppers. The count of the shoppers can be calculated based on interactions of shoppers with shelves or the number of shoppers who spend at least a minimum amount of time in an area. It can be seen that shoppers spend more time on the top right portion of the shopping store. This area (as described above with reference to FIG. 24A) contains coffee and pastry shelves. The middle part of the shopping store contains a self-service checkout kiosk. The shoppers spend more time at the kiosk after taking items from other parts of the shopping store. The legend 2425 shows a range of shoppers from zero at the bottom (corresponding to light color) and two hundred and fifty (250) shoppers at the top (corresponding to dark color). The count of the shoppers can be calculated per unit of time such as per hour, per three hours, per six hours, per twelve hours, per twenty-four hours, one week, one month, etc. The count of shoppers can be calculated for a unit area such as 1 meter by 1 meter area of the floor of the shopping store. Larger and smaller areas of the floor of the shopping store can be used to track subjects per unit of time.

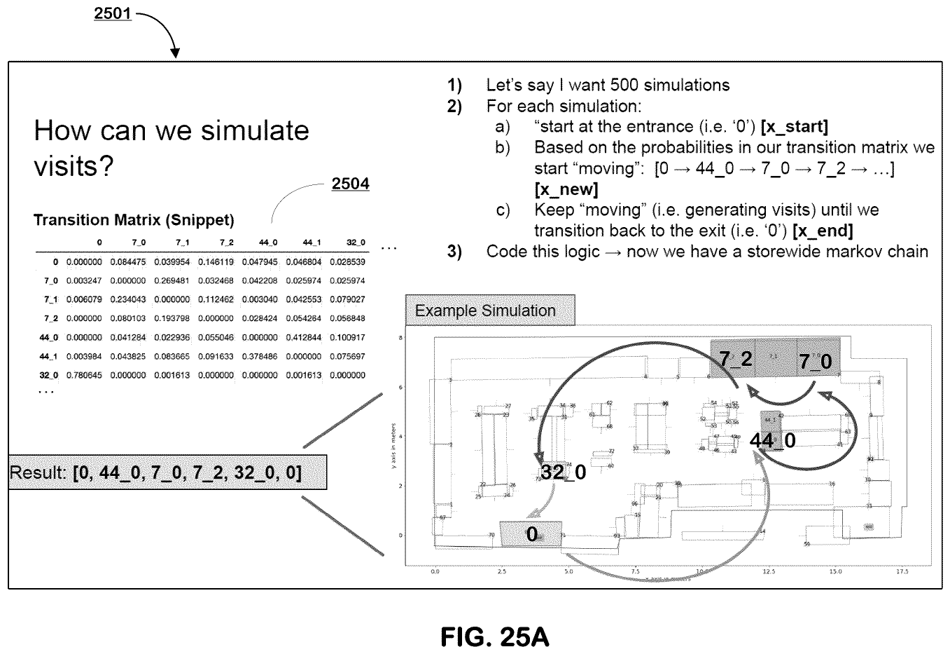

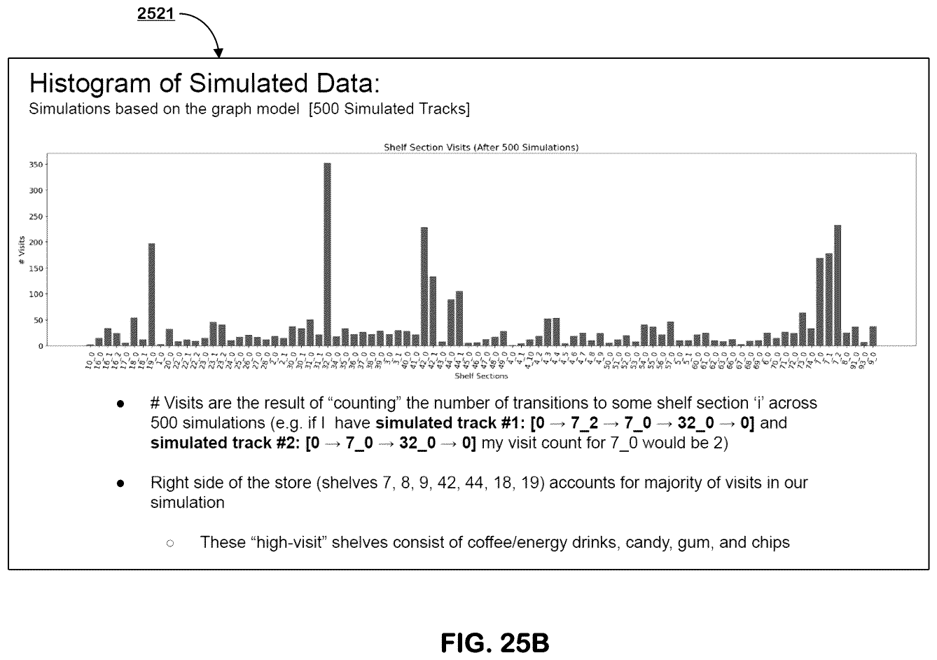

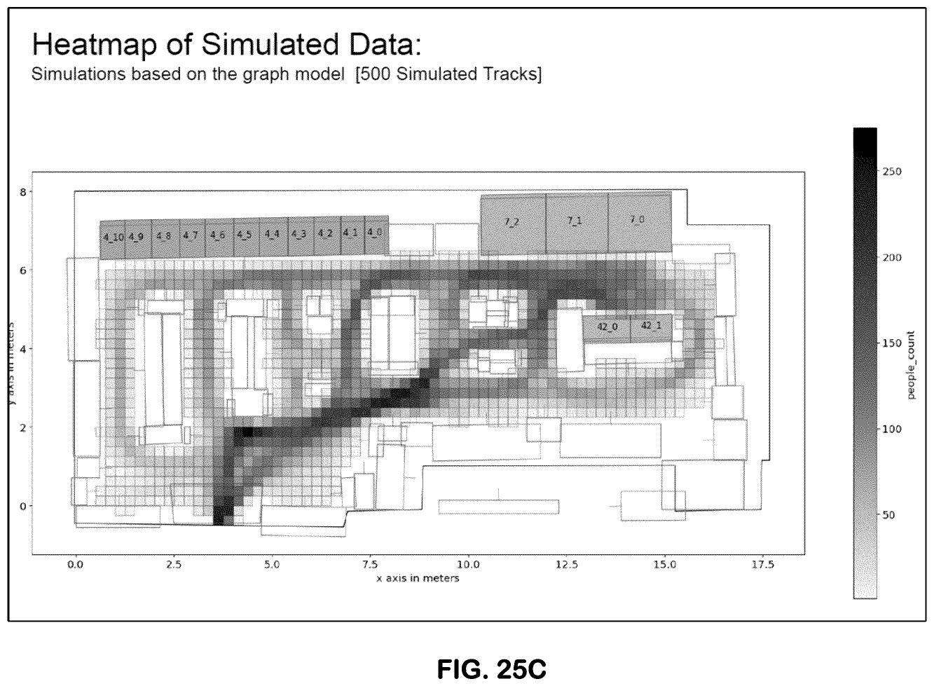

The path prediction device 199 includes logic to generate predicted paths of shoppers in a shopping store using the transition matrix. FIGS. 25A, 25B and 25C presents examples of generating predicted paths of shoppers in a shopping store. FIG. 25A presents an example (2501) of predicting path of a new subject in a shopping store. This process is also referred to as simulation or simulating shoppers in a shopping store. FIG. 25A presents a portion 2504 of a transition matrix for a shopping store. In the example shown in FIG. 25A, the generation of a predicted path of a new shopper (or a new subject) starts from the entrance of the shopping store (labeled as “0”). The generation of a predicted path of a shopper in the shopping store is also referred to as a simulation. Multiple simulations can be generated for shoppers in the shopping store. The next shelf likely to be visited by the shopper after entering the shopping store can be determined by traversing a row for the entrance location (labeled as “0”). An element (0, j) with highest probability value can be selected. Using this element, it can be predicted that the shopper will likely visit the shelf “j” after entering the shopping store. In a second simulation, the shelf “j” can be selected with second highest probability value in the row labeled as “0”. In a third simulation, the shelf “j” can be selected with a third highest probability value in the row labeled as “0”. Thus, multiple simulations for predicted paths of new subjects in the shopping store can be generated. After determined the first shelf visited by the new shopper after entering the store, the process is repeated to determine the second shelf visited after the first shelf. To predict the second shelf, the transition matrix row for the second shelf (“j”) is traversed to determine the shelf (represented by a column “k” in transition matrix) that will be visited next. As described above, the element (j, k) is selected with a high value of probability. This process is repeated to generate a predicted path of a subject (0, j, k, . . . ). In the example, illustrated in FIG. 25A, a predicted path (0, 44_0, 7_0, 7_2, 32_0, 0) is generated for a shopper. The path starts at the entrance “0”. The shopper will likely visit shelves “44_0”, “7_0”, “7_2”, “32_0” and then exit the shopping store by moving to the exit “0”.

FIG. 25B presents a histogram of visits to shelves in the shopping store. The histogram is generated using multiple predicted paths (or multiple simulations). For example, if two predicted paths are generated such that path 1 comprises the visits 0, 7_2, 7_0, 32_0, 0 and path 2 comprises the visits 0->7_0->32_0->0 then the histogram will show a count of two as visits to the shelf “7_0” as both paths have a visit to this shelf. The histogram 2521 shows more visits to shelves 7, 8, 9, 42, 44, 18 and 19 determined from five hundred simulations or five hundred predicted paths of shoppers in the shopping store. These shelves are located on the right side of the shopping store. Some of these shelves (such as 7, 42_0, etc.) contain coffee, pastries and related items. The other shelves contain energy drinks, candy, gum and chips. The store management or store owner can use this information to determine placement of products in shelves to increase visits of shoppers to various areas of the store. This data can also be provided to product manufacturers, product distributors, marketing companies, consumer packaged goods (CPGs) manufacturers and/or distributors for their product research. The data can also be used by the store management and/or store owners to sell certain shelves at a premium price to product manufacturers or product distributors for placing their products. Inventory display locations (such as shelves) near areas or shelves with higher shopper traffic can be sold at a premium as products in these shelves are likely to get higher attention from shoppers.

FIG. 25C shows a heatmap of shopper visits to various shelves in the shopping store using the simulation data generated above with reference to FIGS. 25A and 25B. Dark colored regions indicate popular shelves while lighter colored areas represent low shopper traffic. The heatmap is generated using five hundred subject tracks.

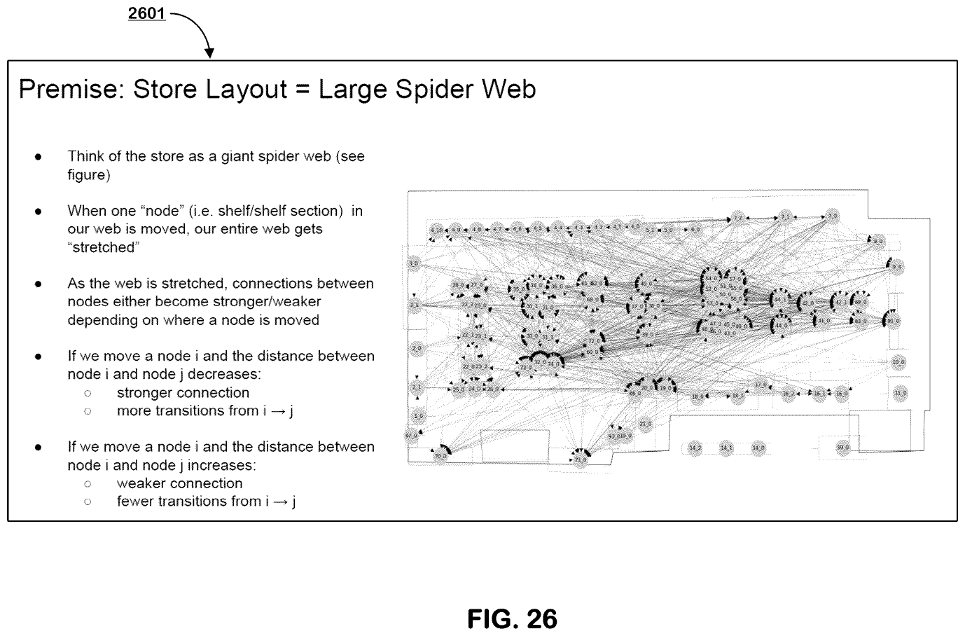

FIG. 26 presents a graphical representation 2601 of a shopping store with nodes representing shelves (or portions of shelves or sections of shelves) and edges representing connections between shelves. The connections between the nodes can become strong or weak when one or more shelves (or sections of shelves) are moved from one location to another location in the shopping store. If by movement of the shelves, the distance between the nodes i and j decreases then strength of connection between nodes can increase. This can result in more transitions from node i to node j. Likewise, when movement of the shelves increases distance between the shelves, the graph is updated to reflect weaker connection between nodes indicating fewer transitions may occur between these two shelves. The edges representing connections can include a weight value or an edge strength value or a transition strength value indicating strength of transition or connection between the two edges. In some instance, the edges can be directional, i.e., indicating the strength of connection from a source node to a destination node. In some instances, the edges can be undirected, i.e., indicating the strength of connection from one node to another node in any direction. The display generation device 193 includes logic to display the graphical representation of connectedness of shelves in the area of real space, the graphical representation (as shown in FIG. 26) comprising nodes representing shelves in the area of real space and comprising edges connecting the nodes representing distances between respective shelves. The edges can be weighted by respective elements of the transition matrix.

The layout generation device 200 includes logic to change a preferred placement of a particular item, in dependence on the predicted path, from an existing location to a new location in the area of real space to increase interaction of future subjects with the particular item. Alternatively, a shelf containing the particular item can be from an existing location to a new location in the area of real space. Changing the placement of a shelf containing a particular item in dependence on the predicted path can increase interaction of the future subjects with the particular item contained within the shelf.

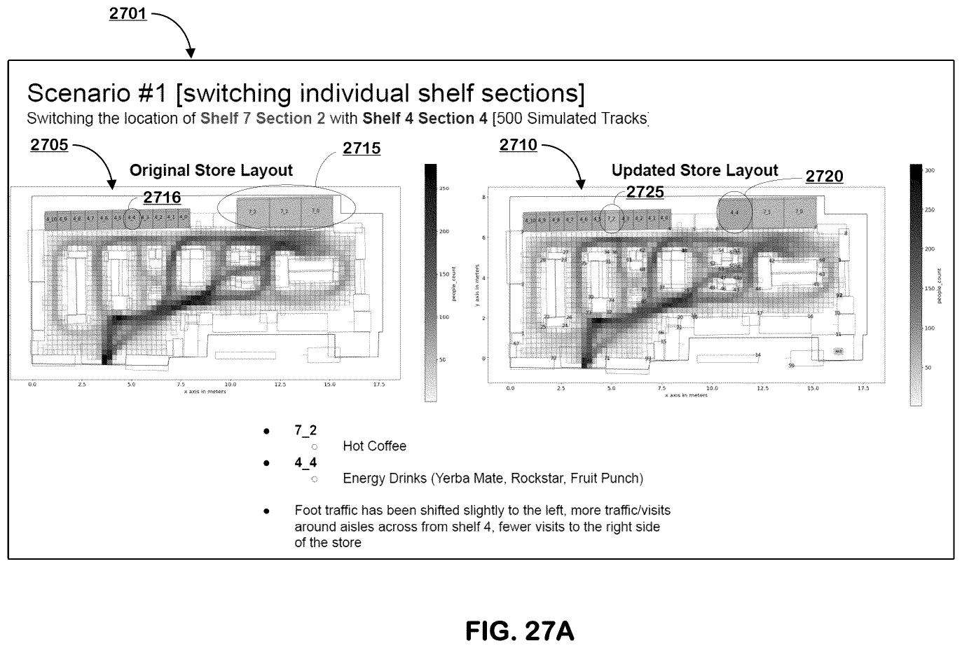

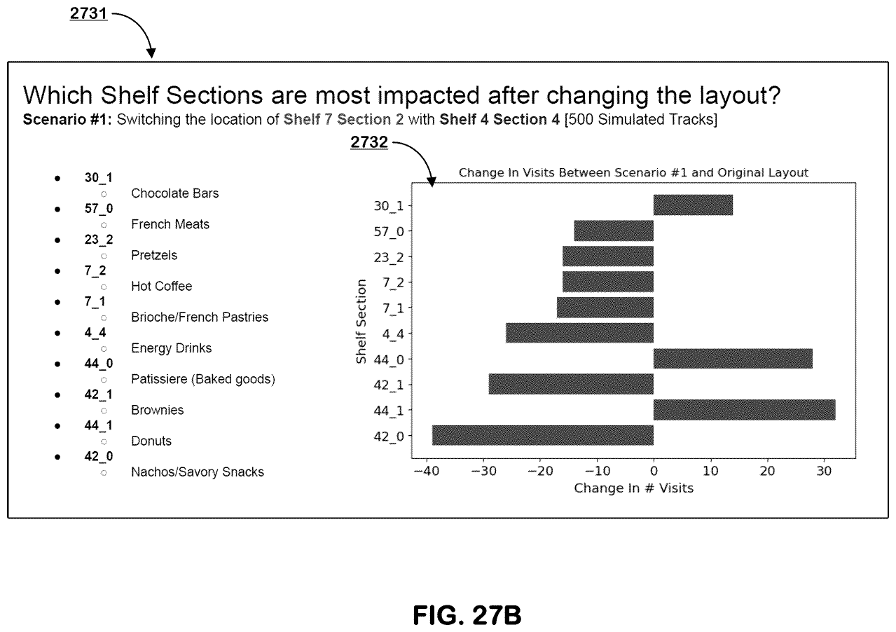

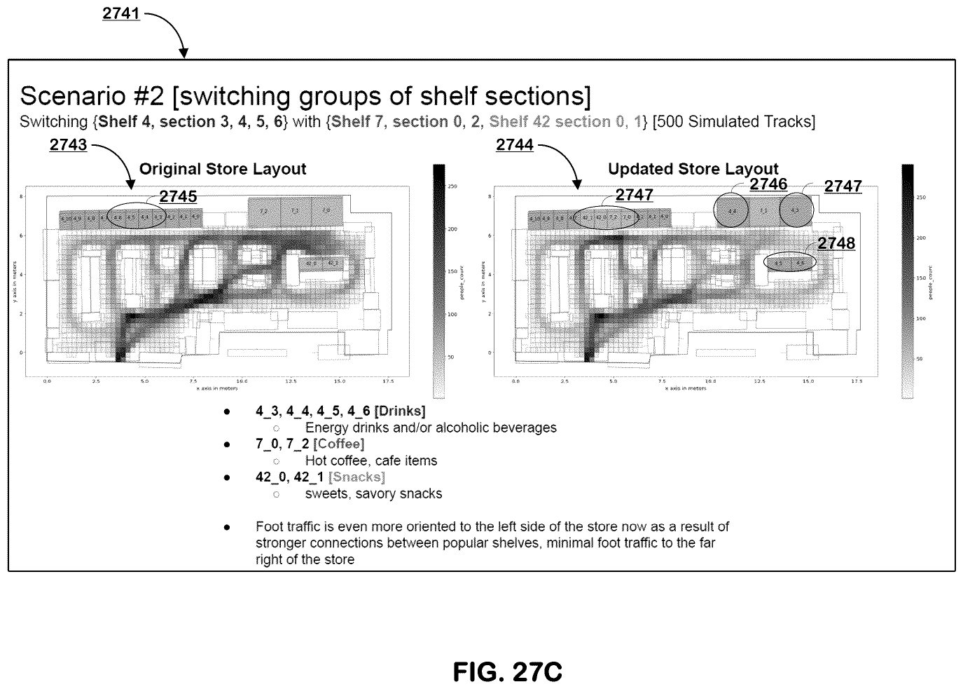

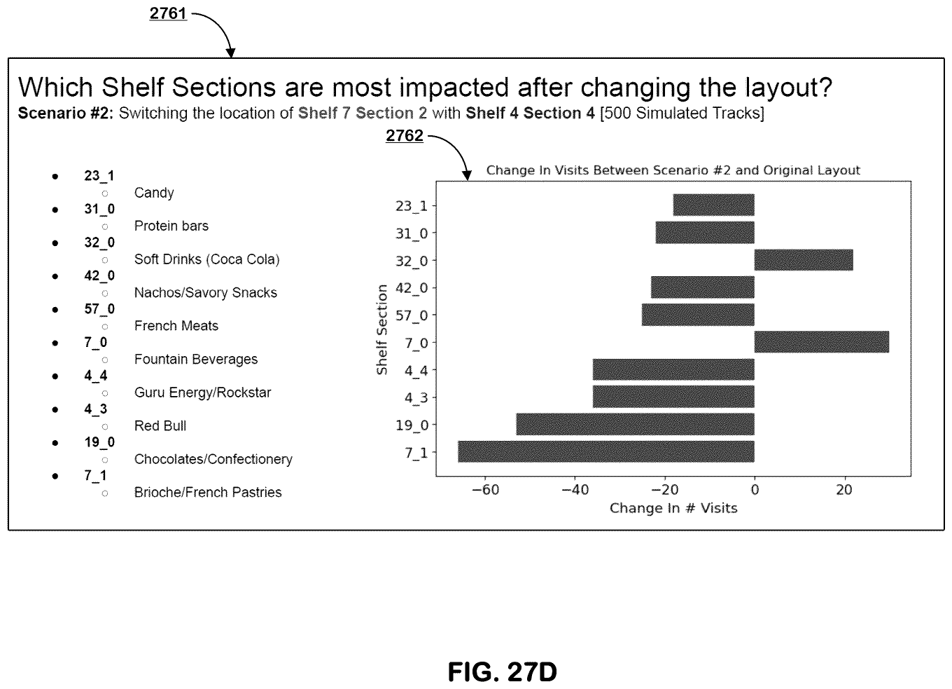

FIGS. 27A, 27B, 27C and 27D present two examples of moving shelves (or moving items contained in shelves or sections of shelves) from an existing location to a new location in the area of real space. The examples also present the impact of changing shelf locations i.e., the change in visits of shoppers to shelves in the changed layout versus the original layout. This type of analysis is very useful for owners and/or managers of shopping stores for increasing the visits of shoppers to the areas of the store that are getting fewer visits by shoppers. The results of such analysis are also useful for product manufactures, product distributors of various types of goods such as consumer packaged goods or CPGs as this data can help improvement of interaction of shoppers with products by selecting locations in the shopping store where the products receive more interactions (or attention) from shoppers.

FIG. 27A presents an illustration 2701 providing two views of shelf layouts in a shopping store. The shelf layout view 2705 presents original layout of shelves in the shopping store. A group of shelves 7_0, 7_1 and 7_2 represent three shelves from where shoppers get their coffee. This group of shelves is labeled as 2715 in the original view of the shopping store. One of the three shelves labeled 7_2 is moved to the location of a shelf 4_4 (labeled 2716). Shelf 4_4 contains energy drinks. In the original layout 2705 the shoppers' traffic is more concentrated on the right side of the shopping store near location of coffee shelves as shown by dark color in the heatmap. The updated store layout 2710 shows that one of the coffee shelves 7_2 is placed at the original location of the energy drinks shelf (4_4). The new location of the shelf 7_2 is indicated by an oval 2725. The energy drinks shelf 4_4 is now positioned at a location 2720 which was originally the location of the coffee shelf 7_2. Simulations of the shoppers visits to the shopping store show that foot traffic has now shifted towards left side of the store near the new location of the coffee shelf (2725). The updated store layout results in reduction of shoppers' visits to the right side of the store. The heatmap of the updated store layout provides a view of the foot traffic of shoppers in the updated store layout. The shoppers' visits are now almost equally distributed between the left and the right side of the shopping store.

FIG. 27B presents an illustration 2731 identifying impact on various shelves with respect to shoppers' interaction with items placed on these shelves after the shelf layout is changed as shown in FIG. 27A. The bar chart 2732 shows that for some items the interactions have increased after changing the location of shelves in FIG. 27A. For example, the number of visits of shoppers have increased for shelves 30_1 containing chocolate bars, 44_0 containing baked goods and 44_1 containing donuts. However, the interactions of shoppers with items on some other shelves have decreased. This information can be used by the store management or store owner to make any further changes in placement of shelves so that the interactions of shoppers can be increased for the shelves receiving fewer interactions from shopper.

FIG. 27C presents an illustration 2741 in which a group of shelves is moved from their original location to a new location in the shopping store. A store map 2743 presents an original layout of shelves in the shopping store. Shelves 4_3, 4_4, 4_5 and 4_6 are moved from their original location 2745 to new locations in the shopping store. The new locations of these four shelves are labeled 2746 (shelf 4_4), 2747 (shelf 4_3), 2748 (shelves 4_5 and 4_6) on an updated store shelf map 2744. Two coffee shelves (7_0 and 7_2) and two sweets and savory snacks shelves (42_0 and 42_1) are moved from their respective original locations to locations of the four energy drinks shelves (4_3, 4_4, 4_5 and 4_6) as shown in the oval 2747. It can be seen in the updated shelf layout 2744 that more shoppers are now visiting left side of the shopping store as compared to the right side of the shopping store in the original store layout in the store map 2743.

FIG. 27D presents an illustration 2761 identifying impact on various shelves with respect to shoppers' interaction with items placed on these shelves after the shelf layout is changed as shown in FIG. 27C. The bar chart 2762 shows that for some items the interactions have increased after changing the location of shelves in FIG. 27C. For example, the number of visits of shoppers have increased for shelves 32_0 containing soft drinks and 7_0 containing fountain beverages. However, the interactions of shoppers with items on some other shelves have decreased.

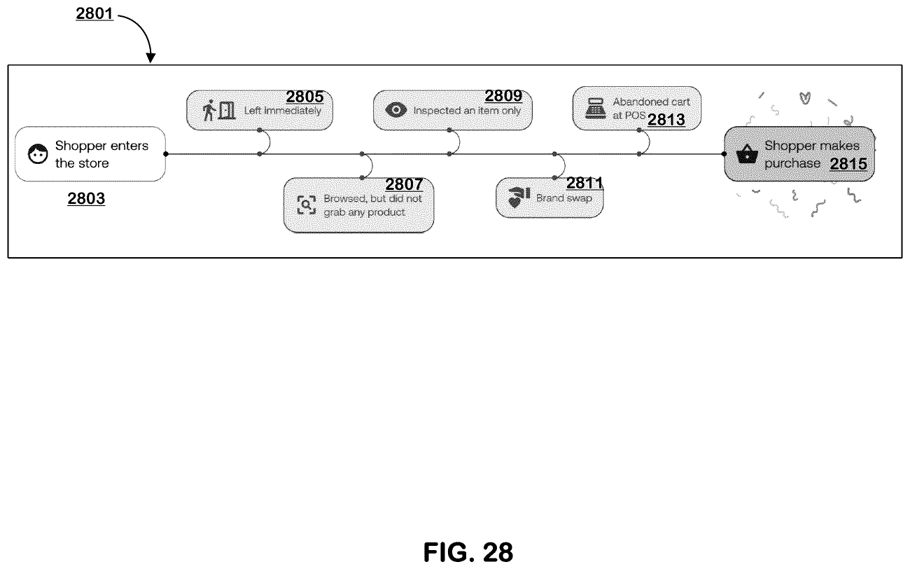

FIG. 28 presents operations (also referred to as a conversion funnel) 2801 that a shopper follows to purchase items from a shopping store. The technology disclosed provides data to store management and/or store owners to not only increase the interactions of shoppers with items (as described above) but also increase the sale of products in the shopping store. Such data is typically easy to capture in online transactions but may not be captured by brick-and-mortar shopping stores. The technology disclosed provides shoppers' shopping behavior data including their preferences for products, competing or alternative products considered by shoppers, preferences regarding various brands, etc. to store managers and/or store owners of brick-and-mortar shopping stores. The operations 2801 present various operations for processing shopper or subject tracking and interactions data during a visit to a shopping store. The shopper may abandon the shopping process at any operation or complete the process and purchase the item taken from a shelf. The operations illustrated in FIG. 28 starts when the shopper enters the shopping store (operation 2803). In one instance, the shopper may leave the shopping store immediately after entering the shopping store without interacting with any items (operation 2805). The shopper may continue to shop in the shopping store and move in the aisles or other open areas of the shopping store. The shopper may look at various products placed in product storage locations or placed in inventory display structures (e.g., shelves, baskets) or just piled on shopping store's floor. The technology disclosed can use shoppers' tracks (also referred to as subject tracks) to determine which products the shoppers looked at but did not take or pick (operation 2807). This information may not be available to store owners and/or store managers without using the technology disclosed. The shopper may take an item from an inventory display structure (shelf, basket, floor, etc.) but put it back after looking at the product and may not purchase the product. The technology disclosed can detect interactions of shoppers with items even when the shoppers do not purchase the items (operation 2809). The shopper may select an alternative product after viewing an item or after taking an item and putting it back on the shelf. The shopper may select an item from another brand after putting back an initially taken item on the inventory display structure. The technology disclosed can detect such brand swap activity (operation 2811) using the interactions of shoppers with items. The technology disclosed can therefore collect data regarding alternate products taken by shoppers and also alternate brands selected by shoppers (operation 2811) using tracking data and items takes and puts data. The shopper may take items to a point-of-sale (POS) location but may leave the shopping cart or shopping basket without purchasing the items taken from shelves. Traditional brick-and-mortar stores may not be able to capture this event but the technology disclosed can determine if shopper leaves the shopping store without purchasing items in the shopper cart (or shopping basket). The technology disclosed can also detect if the shopper leaves the shopping store without purchasing a few items (such as one or more items) in the shopping cart or the shopping basket (operation 2813). The shopper can move out of the shopping store with items in shopping basket or shopping cart. The technology disclosed can automatically charge the items to shoppers' payment information available to the shopping store via a shopping app or a shoppers' account (operation 2815). The technology disclosed can also include a kiosk close to the exit where the shopper can provide payment information, scan a credit card, pay cash, etc. to complete the purchase. The technology disclosed can also include other mechanisms check-in the shoppers, i.e., to link the anonymously tracked shoppers in the shopping store to their accounts containing their payment information. For example, the technology disclosed can send an image to the mobile device carried by the anonymously tracked shopper and then detect the sent image displayed on the display screen to match the subject to a user account. The shopper may be asked to perform a certain gesture (such as moving hands sideways, etc.) and/or hold their mobile devices up, while standing in a designated space in the shopping store to check-in to the shopping store.

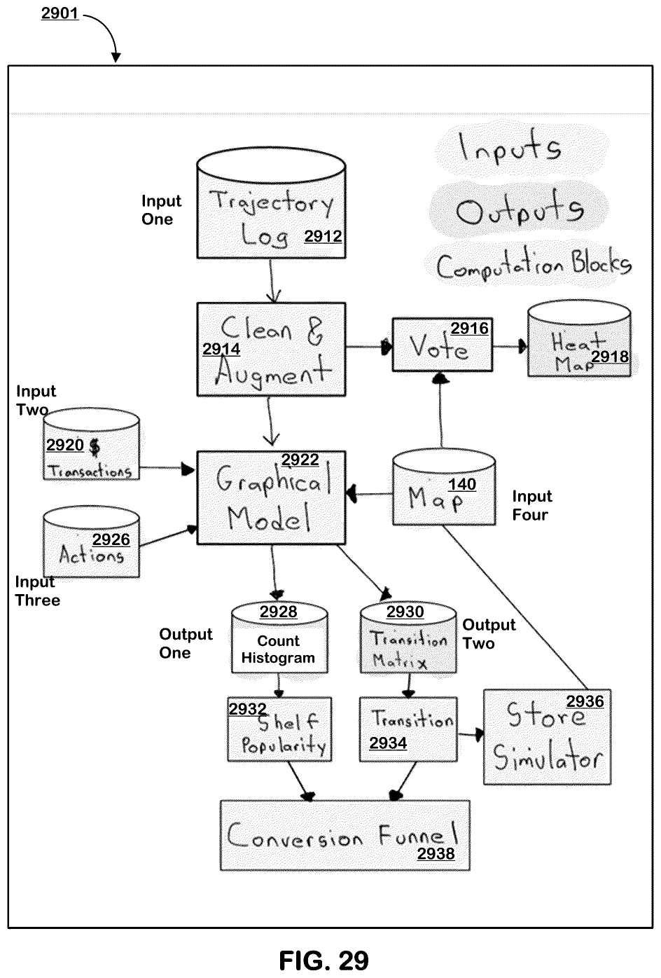

FIG. 29 presents a process flow 2901 for capturing various types of data from the shopping store and processing the data to generate outputs that enable prediction of paths of new shoppers in the shopping store and determination of impact on movement of shoppers in the shopping when locations of one or more shelves (or shelf sections) are changed in the shopping store. There are four inputs labeled as input one (trajectory log 2912), input two (transactions data or transaction logs 2920), input three (actions performed by shoppers 2926) and input four (shelf map of the shopping store from maps database 140). The trajectory log can contain subject tracks data such as subject identifier, one or more locations in the area of real space and one or more timestamps. This data can be captured from various sensors in the area of real space. The sensors can include narrow field of view cameras and wide field of view cameras. Other types of sensors such as depth sensors, LiDAR, etc. can also be used to capture data to track subjects and their actions such as puts of items and takes of items on shelves or other types of inventory display structures. The subject tracking data can also include a total time spent by a subject (such as a shopper) in the area of real space, accumulated time spent at various locations in the shopping store, items taken from shelves, items taken from shelves but placed back, items viewed in shelves but not taken from shelves, amount of time spent close to various shelves reviewing items on shelves, alternative products selected and/or considered, alternative brands selected and/or considered, etc. At an operation 2914, the subject tracking data is cleaned and augmented. The augmentation operation can include combining subject tracking data with data captured from other sources such as transactions logs at point-of-sale (POS) locations, store management systems including data identifying interactions of shoppers with other store systems or store employees such as for product related help, age verification, etc. The cleaned and augmented subject data is then combined with store maps including a shelf map or other maps of the shopping store indicating locations of inventory display structures such as shelves from a maps database 140. Some or all of the maps database 140 can be combined with subject tracks data in an operation 2916 to generate various types of heatmaps for the shopping store. Heatmaps can be stored in a heatmaps database 2918. The subject tracking data can be combined with transaction logs (2920) from the shopping store. The transaction logs can indicate the amount (such as in dollars) spent by shoppers while purchasing various items. This combination of these two data (subject tracks and transactions) can indicate which shelves are more popular in terms of purchases and/or items taken by shoppers. This data can also be combined with additional data of puts and takes of items (also referred to as inventory events) from shelves (2926). Further, maps of the shopping store can be provided as input to generate graphs (or graphical models) of the shopping store. Graphical models of the shopping store layout can be generated at an operation 2922. The graphical models or graphs can include nodes (representing shelves) and edges (representing connections between shelves). The edges can also be weighted indicating the strength of the connections between nodes (i.e., the shelves). The higher the likelihood that a shopper will visit a second (or a destination) shelf from a first (or a source) shelf, the higher the weight of the edge connecting the first node to the second node. Additionally, the technology disclosed includes logic to change positions of nodes in the graph to determine the impact of the transitions of shoppers in the shopping store. When a node is moved from one part of the graph to another part, the edges connecting the node also change in terms of the length of edges and the weight of the edges. The length of the edges can represent a distance between the shelves and the weight of the edges can represent likelihood of a transition from one shelf to another shelf. The technology disclosed includes logic to generate a count histogram (2928) presenting the number of visits to a shelf. The count histogram can be used to determine the shelf popularity score over a period of time (operation 2932). The technology disclosed includes logic to generate a transition matrix (2930) presenting the probabilities of movement of shoppers from a source shelf to a destination shelf. The transition matrix can be used to determine likely paths of new shoppers from a source shelf to a destination shelf (operation 2934). The technology includes logic to generate a simulation of how a new shopper will move and interact with items in the store (operation 2936). The technology disclosed includes to generate a customer conversion funnel providing information of shopper behavior after the shopper enters the shopping store and before the shopper leaves the shopping store (operation 2938).

### Network Configuration

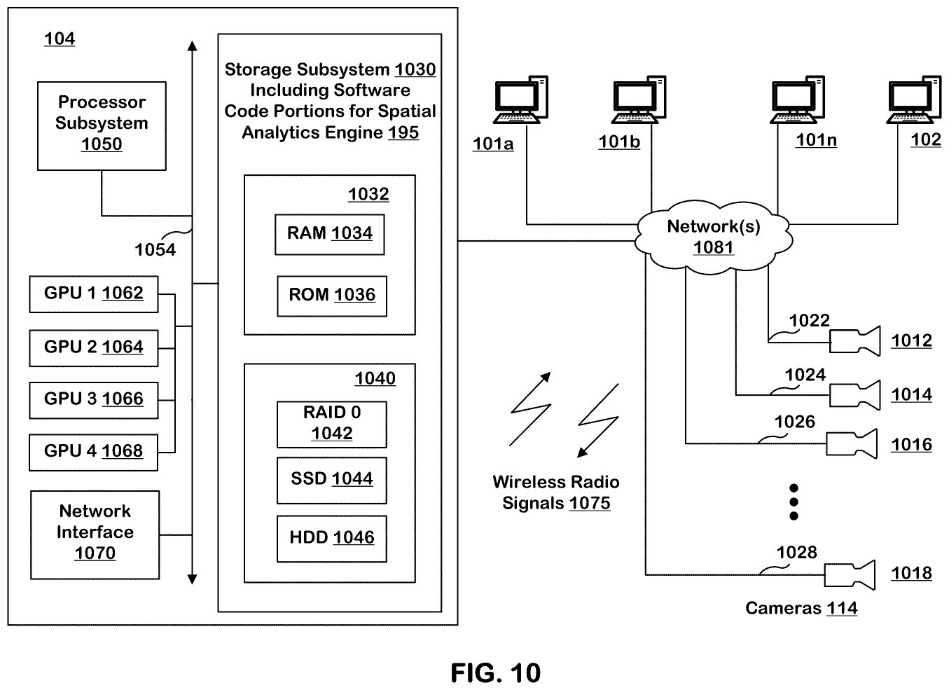

FIG. 10 presents architecture of a network hosting the spatial analytics engine 195 which is hosted on the network node 106. The system includes a plurality of network nodes 101a, 101b, 101n, and 102 in the illustrated implementation. In such an implementation, the network nodes are also referred to as processing platforms. Processing platforms (network nodes) 101a, 101b, 101n, 102, 103, 104, and 105 and cameras 1012, 1014, 1016, . . . , 1018 are connected to network(s) 1081.

FIG. 10 shows a plurality of cameras 1012, 1014, 1016, . . . , 1018 connected to the network(s). A large number of cameras can be deployed in particular systems. In one implementation, the cameras 1012 to 1018 are connected to the network(s) 1081 using Ethernet-based connectors 1022, 1024, 1026, and 1028, respectively. In such an implementation, the Ethernet-based connectors have a data transfer speed of 1 gigabit per second, also referred to as Gigabit Ethernet. It is understood that in other implementations, cameras 114 are connected to the network using other types of network connections which can have a faster or slower data transfer rate than Gigabit Ethernet. Also, in alternative implementations, a set of cameras can be connected directly to each processing platform, and the processing platforms can be coupled to a network.

Storage subsystem 1030 stores the basic programming and data constructs that provide the functionality of certain implementations of the technology disclosed. For example, the various modules implementing the functionality of the spatial analytics engine 195 may be stored in storage subsystem 1030. The storage subsystem 1030 is an example of a computer readable memory comprising a non-transitory data storage medium, having computer instructions stored in the memory executable by a computer to perform all or any combination of the data processing and image processing functions described herein including logic to track subjects, logic to detect inventory events, logic to predict paths of new subjects in a shopping store, logic to predict impact on movements of shoppers in the shopping store when locations of shelves or shelf sections are changed, logic to determine locations of tracked subjects represented in the images, logic match the tracked subjects with user accounts by identifying locations of mobile computing devices executing client applications in the area of real space by processes as described herein. In other examples, the computer instructions can be stored in other types of memory, including portable memory, that comprise a non-transitory data storage medium or media, readable by a computer.

These software modules are generally executed by a processor subsystem 1050. A host memory subsystem 1032 typically includes a number of memories including a main random access memory (RAM) 1034 for storage of instructions and data during program execution and a read-only memory (ROM) 1036 in which fixed instructions are stored. In one implementation, the RAM 1034 is used as a buffer for storing re-identification vectors generated by the spatial analytics engine 195.

A file storage subsystem 1040 provides persistent storage for program and data files. In an example implementation, the file storage subsystem 1040 includes four 120 Gigabyte (GB) solid state disks (SSD) in a RAID 0 (redundant array of independent disks) arrangement, as identified by reference element 1042. In the example implementation, maps data in the maps database 140, subjects data in the subjects database 150, heuristics in the persistence heuristics database, training data in the training database 162, account data in the user database 164 and image/video data in the analytics database 166 which is not in RAM, is stored in RAID 0. In the example implementation, the hard disk drive (HDD) 1046 is slower in access speed than the RAID 0 (1042) storage. The solid state disk (SSD) 1044 contains the operating system and related files for the spatial analytics engine 195.

In an example configuration, four cameras 1012, 1014, 1016, 1018, are connected to the processing platform (network node) 103. Each camera has a dedicated graphics processing unit GPU 1 1062, GPU 2 1064, GPU 3 1066, and GPU 4 1068, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 1050, the storage subsystem 1030 and the GPUs 1062, 1064, and 1066 communicate using the bus subsystem 1054.

A network interface subsystem 1070 is connected to the bus subsystem 1054 forming part of the processing platform (network node) 104. Network interface subsystem 1070 provides an interface to outside networks, including an interface to corresponding interface devices in other computer systems. The network interface subsystem 1070 allows the processing platform to communicate over the network either by using cables (or wires) or wirelessly. The wireless radio signals 1075 emitted by the mobile computing devices 120 in the area of real space are received (via the wireless access points) by the network interface subsystem 1070 for processing by the account matching engine 170. A number of peripheral devices such as user interface output devices and user interface input devices are also connected to the bus subsystem 1054 forming part of the processing platform (network node) 104. These subsystems and devices are intentionally not shown in FIG. 10 to improve the clarity of the description. Although bus subsystem 1054 is shown schematically as a single bus, alternative implementations of the bus subsystem may use multiple busses.

In one implementation, the cameras 114 can be implemented using Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300-∞, a field of view field of view with a ⅓″ sensor of 98.2°-23.8°. The cameras 114 can be any of Pan-Tilt-Zoom cameras, 360-degree cameras, and/or combinations thereof that can be installed in the real space.

### Subject Identification Analysis

The following description provides examples of algorithms for identifying tracked subjects by matching them to their respective user accounts. As described above, the technology disclosed links located subjects in the current identification interval to tracked subjects in preceding identification intervals by performing subject persistence analysis. In the case of a cashier-less store the subjects move in the aisles and open spaces of the store and take items from shelves. The technology disclosed associates the items taken by tracked subjects to their respective shopping cart or log data structures. The technology disclosed uses one of the following check-in techniques to identify tracked subjects and match them to their respective user accounts. The user accounts have information such as preferred payment method for the identified subject. The technology disclosed can automatically charge the preferred payment method in the user account in response to identified subject leaving the shopping store. In one implementation, the technology disclosed compares located subjects in current identification interval to tracked subjects in previous identification intervals in addition to comparing located subjects in current identification interval to identified (or checked in) subjects (linked to user accounts) in previous identification intervals. In another implementation, the technology disclosed compares located subjects in current identification interval to tracked subjects in previous intervals in alternative to comparing located subjects in current identification interval to identified (or tracked and checked-in) subjects (linked to user accounts) in previous identification intervals.

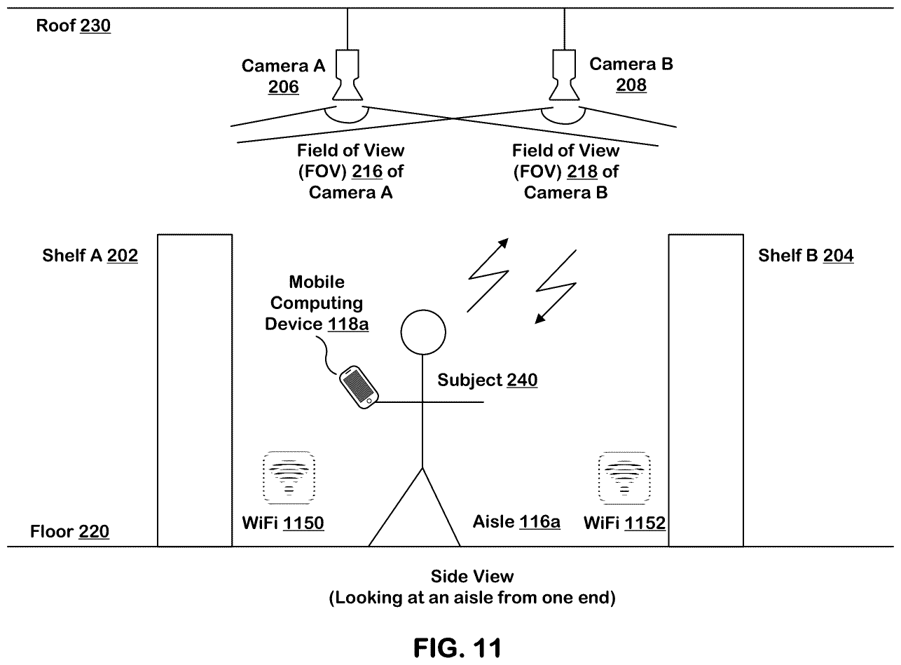

In a shopping store, the shelves and other inventory display structures can be arranged in a variety of manners, such as along the walls of the shopping store, or in rows forming aisles or a combination of the two arrangements. FIG. 11 shows an arrangement of shelves, forming an aisle 116a, viewed from one end of the aisle 116a. Two cameras, camera A 206 and camera B 208 are positioned over the aisle 116a at a predetermined distance from a roof 230 and a floor 220 of the shopping store above the inventory display structures, such as shelves. The cameras 114 comprise cameras disposed over and having fields of view encompassing respective parts of the inventory display structures and floor area in the real space. The coordinates in real space of members of a set of candidate joints, located as a subject, identify locations of the subject in the floor area. In FIG. 11, the subject 240 is holding the mobile computing device 118a and standing on the floor 220 in the aisle 116a. The mobile computing device can send and receive signals through the wireless network(s) 181. In one example, the mobile computing devices 120 communicate through a wireless network using for example a Wi-Fi protocol, or other wireless protocols like Bluetooth, ultra-wideband, and ZigBee, through wireless access points (WAP) in the area of real space.

In the example implementation of the shopping store, the real space can include all of the floor 220 in the shopping store from which inventory can be accessed. Cameras 114 are placed and oriented such that areas of the floor 220 and shelves can be seen by at least two cameras. The cameras 114 also cover at least part of the shelves 202 and 204 and floor space in front of the shelves 202 and 204. Camera angles are selected to have both steep perspective, straight down, and angled perspectives that give more full body images of the customers. In one example implementation, the cameras 114 are configured at an eight (8) foot height or higher throughout the shopping store.

In FIG. 11, the cameras 206 and 208 have overlapping fields of view, covering the space between a shelf A (or shelf unit A) 202 and a shelf B (or shelf unit B) 204 with overlapping fields of view 216 and 218, respectively. A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration.

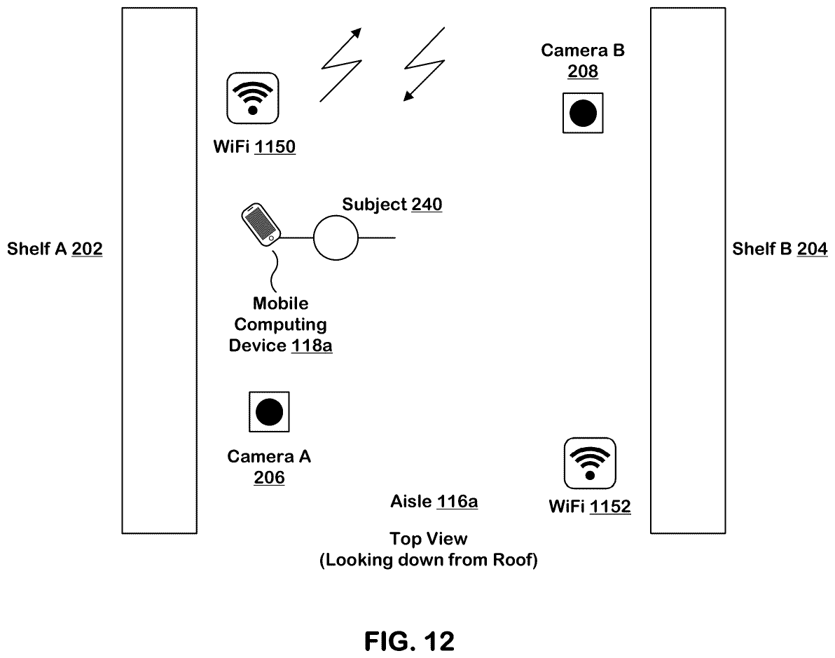

FIG. 12 illustrates the aisle 116a viewed from the top of FIG. 11, further showing an example arrangement of the positions of cameras 206 and 208 over the aisle 116a. The cameras 206 and 208 are positioned closer to opposite ends of the aisle 116a. The camera A 206 is positioned at a predetermined distance from the shelf A 202 and the camera B 208 is positioned at a predetermined distance from the shelf B 204. In another implementation, in which more than two cameras are positioned over an aisle, the cameras are positioned at equal distances from each other. In such an implementation, two cameras are positioned close to the opposite ends and a third camera is positioned in the middle of the aisle. It is understood that a number of different camera arrangements are possible.

### Process to Match Anonymously Tracked Subjects to Accounts

The account matching engine 170 includes logic to identify tracked subjects by matching them with their respective user accounts by identifying locations of mobile devices (carried by the tracked subjects) that are executing client applications in the area of real space. In one implementation, the account matching engine 170 uses multiple techniques, independently or in combination, to match the tracked subjects with the user accounts. The system can be implemented without maintaining biometric identifying information about users, so that biometric information about account holders is not exposed to security and privacy concerns raised by distribution of such information.

In one implementation, a customer (or a subject) logs in to the system using a client application executing on a personal mobile computing device upon entering the shopping store, identifying an authentic user account to be associated with the client application on the mobile device. The system then sends a “semaphore” image selected from the set of unassigned semaphore images in the analytics database 166 to the client application executing on the mobile device. The semaphore image is unique to the client application in the shopping store as the same image is not freed for use with another client application in the store until the system has matched the user account to a tracked subject. After that matching, the semaphore image becomes available for use again. The client application causes the mobile device to display the semaphore image, which display of the semaphore image is a signal emitted by the mobile device to be detected by the system. The account matching engine 170 uses the image recognition engines 112a, 112b, and 112n or a separate image recognition engine (not shown in FIG. 1) to recognize the semaphore image and determine the location of the mobile computing device displaying the semaphore in the shopping store. The account matching engine 170 matches the location of the mobile computing device to a location of a tracked subject. The account matching engine 170 then links the tracked subject (stored in the subject database 150) to the user account (stored in the user account database 164 or the user database 164) linked to the client application for the duration in which the subject is present in the shopping store. No biometric identifying information is used for identifying the subject by matching the tracking subject with the user account, and none is stored in support of this process. That is, there is no information in the sequences of images used to compare with stored biometric information for the purposes of matching the tracked subjects with user accounts in support of this process.

In other implementations, the account matching engine 170 uses other signals in the alternative or in combination from the mobile computing devices 120 to link the tracked subjects to user accounts. Examples of such signals include a service location signal identifying the position of the mobile computing device in the area of the real space, speed and orientation of the mobile computing device obtained from the accelerometer and compass of the mobile computing device, etc.

In some implementations, though implementations are provided that do not maintain any biometric information about account holders, the system can use biometric information to assist matching a not-yet-linked tracked subject to a user account. For example, in one implementation, the system stores “hair color” of the customer in his or her user account record. During the matching process, the system might use for example hair color of subjects as an additional input to disambiguate and match the tracked subject to a user account. If the user has red colored hair and there is only one subject with red colored hair in the area of real space or in close proximity of the mobile computing device, then the system might select the subject with red hair color to match the user account. The details of account matching engine are presented in U.S. patent application Ser. No. 16/255,573, entitled, “Systems and Methods to Check-in Shoppers in a Cashier-less Store,” filed on 23 Jan. 2019, now issued as U.S. Pat. No. 10,650,545, which is fully incorporated into this application by reference.

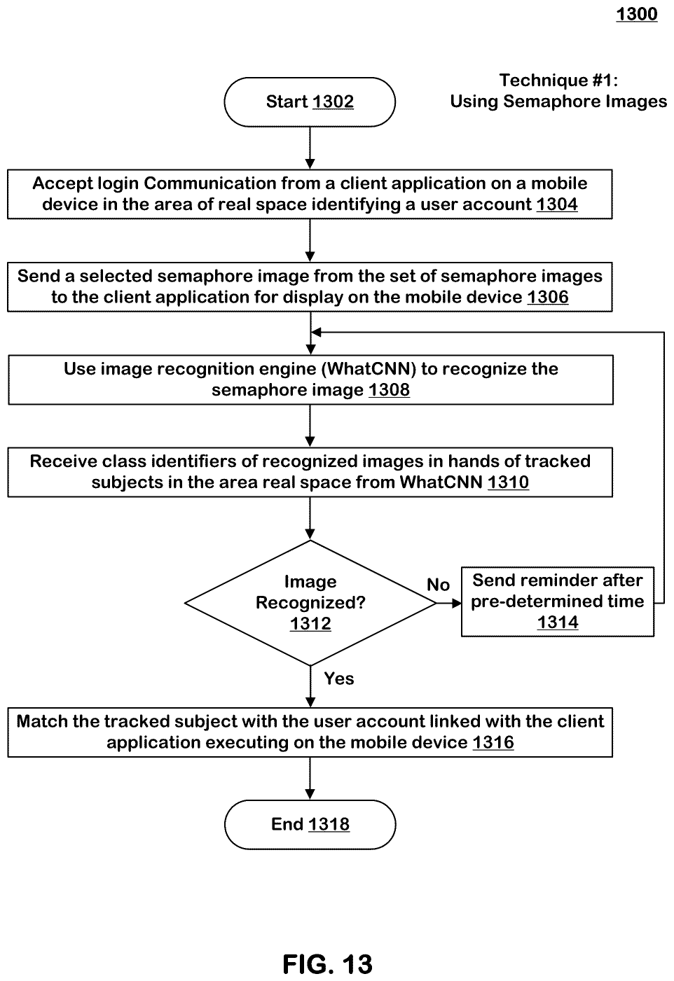

The flowcharts in FIGS. 13 to 16C present operations of four techniques usable alone or in combination by the account matching engine 170.

### Semaphore Images

FIG. 13 is a flowchart 1300 presenting operations for a first technique to identify subject by matching tracked subjects in the area of real space with their respective user accounts. In the example of a shopping store, the subjects are customers (or shoppers) moving in the store in aisles between shelves and other open spaces. The process starts at operation 1302. As a subject enters the area of real space, the subject opens a client application on a mobile computing device and attempts to login. The system verifies the user credentials at operation 1304 (for example, by querying the user account database 164) and accepts login communication from the client application to associate an authenticated user account with the mobile computing device. The system determines that the user account of the client application is not yet linked to a tracked subject. The system sends a semaphore image to the client application for display on the mobile computing device at operation 1306. Examples of semaphore images include various shapes of solid colors such as a red rectangle or a pink elephant, etc. A variety of images can be used as semaphores, preferably suited for high confidence recognition by the image recognition engine. Each semaphore image can have a unique identifier. The processing system includes logic to accept login communications from a client application on a mobile device identifying a user account before matching the user account to a tracked subject in the area of real space, and after accepting login communications sends a selected semaphore image from the set of semaphore images to the client application on the mobile device.

In one implementation, the system selects an available semaphore image from an image database for sending to the client application. After sending the semaphore image to the client application, the system changes a status of the semaphore image in the analytics database 166 as “assigned” so that this image is not assigned to any other client application. The status of the image remains as “assigned” until the process to match the tracked subject to the mobile computing device is complete. After matching is complete, the status can be changed to “available.” This allows for rotating use of a small set of semaphores in a given system, simplifying the image recognition problem.

The client application receives the semaphore image and displays it on the mobile computing device. In one implementation, the client application also increases the brightness of the display to increase the image visibility. The image is captured by one or more cameras 114 and sent to an image processing engine, referred to as WhatCNN. The system uses WhatCNN at operation 1308 to recognize the semaphore images displayed on the mobile computing device. In one implementation, WhatCNN is a convolutional neural network trained to process the specified bounding boxes in the images to generate a classification of hands of the tracked subjects. One trained WhatCNN processes image frames from one camera. In the example implementation of the shopping store, for each hand joint in each image frame, the WhatCNN identifies whether the hand joint is empty. The WhatCNN also identifies a semaphore image identifier or an SKU (stock keeping unit) number of the inventory item in the hand joint, a confidence value indicating the item in the hand joint is a non-SKU item (i.e., it does not belong to the shopping store inventory) and a context of the hand joint location in the image frame.

As mentioned above, two or more cameras with overlapping fields of view capture images of subjects in real space. Joints of a single subject can appear in image frames of multiple cameras in a respective image channel. A WhatCNN model per camera identifies semaphore images (displayed on mobile computing devices) in hands (represented by hand joints) of subjects. A coordination logic combines the outputs of WhatCNN models into a consolidated data structure listing identifiers of semaphore images in left hand (referred to as left_hand_classid) and right hand (right_hand_classid) of tracked subjects (operation 1310). The system stores this information in a dictionary mapping tracking_id to left_hand_classid and right_hand_classid along with a timestamp, including locations of the joints in real space. The details of WhatCNN are presented in U.S. patent application Ser. No. 15/907,112, entitled, “Item Put and Take Detection Using Image Recognition,” filed on 27 Feb. 2018, now issued as U.S. Pat. No. 10,133,933 which is fully incorporated into this application by reference.

At operation 312, the system checks if the semaphore image sent to the client application is recognized by the WhatCNN by iterating the output of the WhatCNN models for both hands of all tracked subjects. If the semaphore image is not recognized, the system sends a reminder at operation 1314 to the client application to display the semaphore image on the mobile computing device and repeats operations 1308 to 1312. Otherwise, if the semaphore image is recognized by WhatCNN, the system matches a user_account (from the user account database 164) associated with the client application to tracking_id (from the subject database 150) of the tracked subject holding the mobile computing device (operation 1316). In one implementation, the system maintains this mapping (tracking_id-user_account) until the subject is present in the area of real space. In one implementation, the system assigns a unique subject identifier (e.g., referred to by subject_id) to the identified subject and stores a mapping of the subject identifier to the tuple tracking_id-user_account. The process ends at operation 1318.

### Service Location

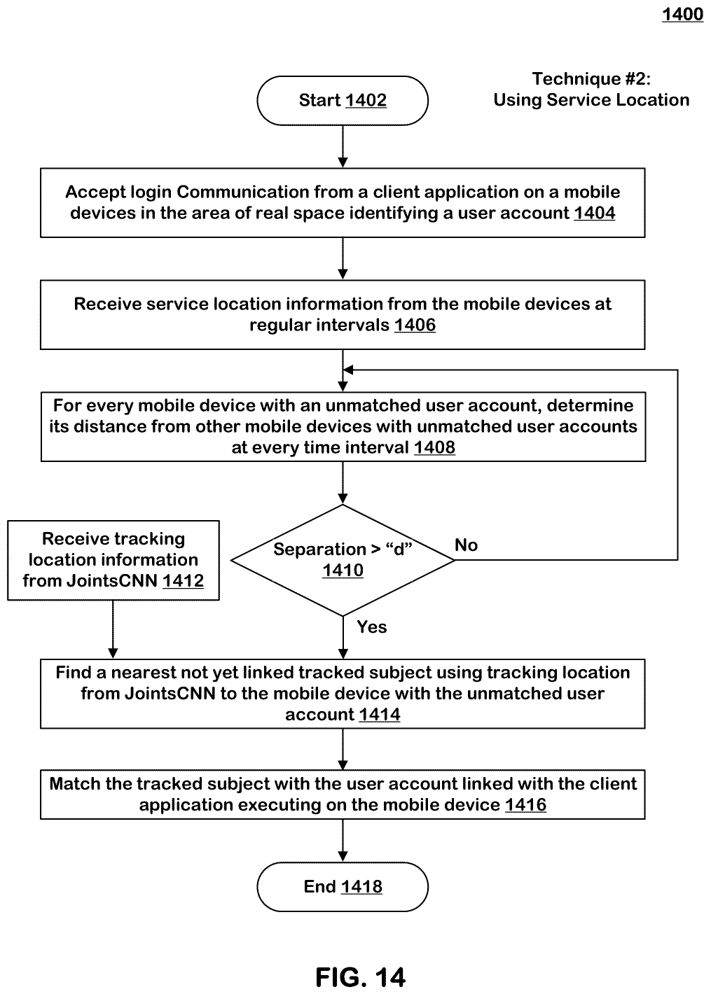

The flowchart 1400 in FIG. 14 presents operations for a second technique for identifying subjects by matching tracked subjects with user accounts. This technique uses radio signals emitted by the mobile devices indicating location of the mobile devices. The process starts at operation 1402, the system accepts login communication from a client application on a mobile computing device as described above in operation 1404 to link an authenticated user account to the mobile computing device. At operation 1406, the system receives service location information from the mobile devices in the area of real space at regular intervals. In one implementation, latitude and longitude coordinates of the mobile computing device emitted from a global positioning system (GPS) receiver of the mobile computing device are used by the system to determine the location. In one implementation, the service location of the mobile computing device obtained from GPS coordinates has an accuracy between 1 to 3 meters. In another implementation, the service location of a mobile computing device obtained from GPS coordinates has an accuracy between 1 to 5 meters.

Other techniques can be used in combination with the above technique or independently to determine the service location of the mobile computing device. Examples of such techniques include using signal strengths from different wireless access points (WAP) such as 1150 and 1152 shown in FIGS. 11 and 12 as an indication of how far the mobile computing device is from respective access points. The system then uses known locations of wireless access points (WAP) 1150 and 1152 to triangulate and determine the position of the mobile computing device in the area of real space. Other types of signals (such as Bluetooth, ultra-wideband, and ZigBee) emitted by the mobile computing devices can also be used to determine a service location of the mobile computing device.

The system monitors the service locations of mobile devices with client applications that are not yet linked to a tracked subject at operation 1408 at regular intervals such as every second. At operation 1408, the system determines the distance of a mobile computing device with an unmatched user account from all other mobile computing devices with unmatched user accounts. The system compares this distance with a pre-determined threshold distance “d” such as 3 meters. If the mobile computing device is away from all other mobile devices with unmatched user accounts by at least “d” distance (operation 1410), the system determines a nearest not yet linked subject to the mobile computing device (operation 1414). The location of the tracked subject is obtained from the output of the JointsCNN at operation 1412. In one implementation the location of the subject obtained from the JointsCNN is more accurate than the service location of the mobile computing device. At operation 1416, the system performs the same process as described above in flowchart 1300 to match the tracking_id of the tracked subject with the user_account of the client application. The process ends at operation 1418.

No biometric identifying information is used for matching the tracked subject with the user account, and none is stored in support of this process. That is, there is no information in the sequences of images used to compare with stored biometric information for the purposes of matching the tracked subjects with user account in support of this process. Thus, this logic to match the tracked subjects with user accounts operates without use of personal identifying biometric information associated with the user accounts.

### Speed and Orientation

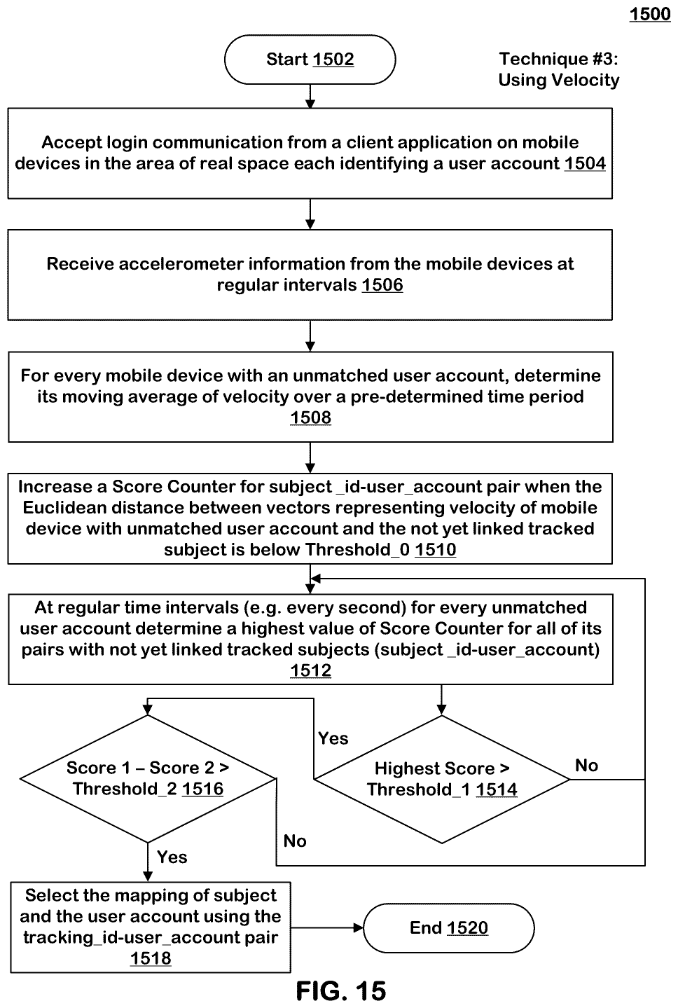

The flowchart 1500 in FIG. 15 presents operations for a third technique to identify subject by matching tracked subjects with user accounts. This technique uses signals emitted by an accelerometer of the mobile computing devices to match tracked subjects with client applications. The process starts at operation 1502. The process starts at operation 1504 to accept login communication from the client application as described above in the first and second techniques. At operation 1506, the system receives signals emitted from the mobile computing devices carrying data from accelerometers on the mobile computing devices in the area of real space, which can be sent at regular intervals. At operation 1508, the system calculates an average velocity of all mobile computing devices with unmatched user accounts.

The accelerometers provide acceleration of mobile computing devices along the three axes (x, y, z). In one implementation, the velocity is calculated by taking the accelerations values at small time intervals (e.g., at every 10 milliseconds) to calculate the current velocity at time “t” i.e., vₜ=v₀+aₜ, where v₀ is initial velocity. In one implementation, the v₀ is initialized as “0” and subsequently, for every time t+1, vi becomes v₀. The velocities along the three axes are then combined to determine an overall velocity of the mobile computing device at time “t.” Finally at operation 1508, the system calculates moving averages of velocities of all mobile computing devices over a larger period of time such as 3 seconds which is long enough for the walking gait of an average person, or over longer periods of time.

At operation 1510, the system calculates Euclidean distance (also referred to as L2 norm) between velocities of all pairs of mobile computing devices with unmatched client applications to not yet linked tracked subjects. The velocities of subjects are derived from changes in positions of their joints with respect to time, obtained from joints analysis and stored in respective subject data structures 320 with timestamps. In one implementation, a location of center of mass of each subject is determined using the joints analysis. The velocity, or other derivative, of the center of mass location data of the subject is used for comparison with velocities of mobile computing devices. For each tracking_id-user_account pair, if the value of the Euclidean distance between their respective velocities is less than a threshold_0, a score_counter for the tracking_id-user_account pair is incremented. The above process is performed at regular time intervals, thus updating the score_counter for each tracking_id-user_account pair.

At regular time intervals (e.g., every one second), the system compares the score_counter values for pairs of every unmatched user account with every not yet linked tracked subject (operation 1512). If the highest score is greater than threshold_1 (operation 1514), the system calculates the difference between the highest score and the second highest score (for pair of same user account with a different subject) at operation 1516. If the difference is greater than threshold_2, the system selects the mapping of user_account to the tracked subject at operation 1518 and follows the same process as described above in operation 1516. The process ends at operation 1520.

In another implementation, when JointsCNN recognizes a hand holding a mobile computing device, the velocity of the hand (of the tracked subject) holding the mobile computing device is used in above process instead of using the velocity of the center of mass of the subject. This improves performance of the matching algorithm. To determine values of the thresholds (threshold_0, threshold_1, threshold_2), the system uses training data with labels assigned to the images. During training, various combinations of the threshold values are used and the output of the algorithm is matched with ground truth labels of images to determine its performance. The values of thresholds that result in best overall assignment accuracy are selected for use in production (or inference).

No biometric identifying information is used for matching the tracked subject with the user account, and none is stored in support of this process. That is, there is no information in the sequences of images used to compare with stored biometric information for the purposes of matching the tracked subjects with user accounts in support of this process. Thus, this logic to match the tracked subjects with user accounts operates without use of personal identifying biometric information associated with the user accounts.

### Network Ensemble

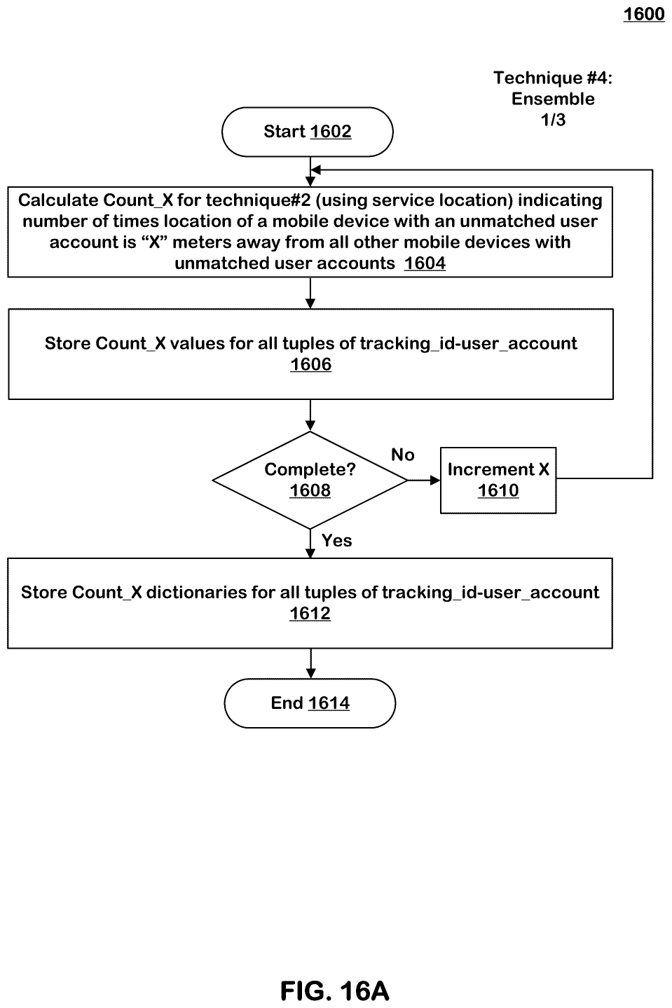

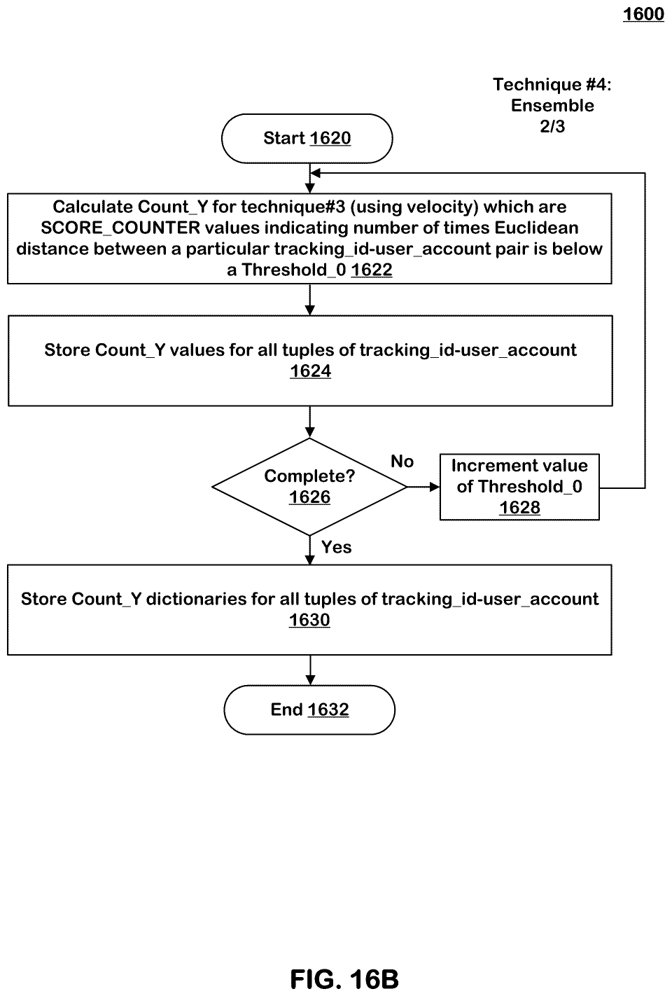

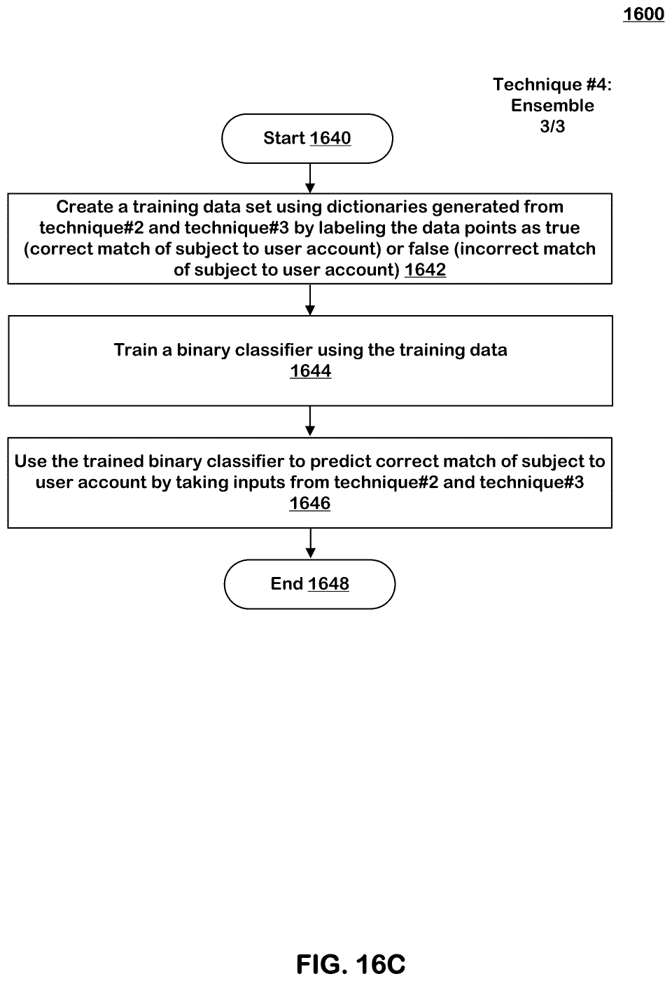

A network ensemble is a learning paradigm where many networks are jointly used to solve a problem. Ensembles typically improve the prediction accuracy obtained from a single classifier by a factor that validates the effort and cost associated with learning multiple models. In the fourth technique to match user accounts to not yet linked tracked subjects, the second and third techniques presented above are jointly used in an ensemble (or network ensemble). To use the two techniques in an ensemble, relevant features are extracted from application of the two techniques. FIGS. 16A-16C present operations (in a flowchart 1600) for extracting features, training the ensemble and using the trained ensemble to predict match of a user account to a not yet linked tracked subject.

FIG. 16A presents the operations for generating features using the second technique that uses service location of mobile computing devices. The process starts at operation 1602. At operation 1604, a Count_X, for the second technique is calculated indicating a number of times a service location of a mobile computing device with an unmatched user account is X meters away from all other mobile computing devices with unmatched user accounts. At operation 1606, Count_X values of all tuples of tracking_id-user_account pairs is stored by the system for use by the ensemble. In one implementation, multiple values of X are used e.g., 1 m, 2 m, 3 m, 4 m, 5 m (operations 1608 and 1610). For each value of X, the count is stored as a dictionary that maps tuples of tracking_id-user_account to count score, which is an integer. In the example where 5 values of X are used, five such dictionaries are created at operation 1612. The process ends at operation 1614.

FIG. 16B presents the operations for generating features using the third technique that uses velocities of mobile computing devices. The process starts at operation 1620. At operation 1622, a Count_Y, for the third technique is determined which is equal to score_counter values indicating number of times Euclidean distance between a particular tracking_id-user_account pair is below a threshold_0. At operation 1624, Count_Y values of all tuples of tracking_id-user_account pairs is stored by the system for use by the ensemble. In one implementation, multiple values of threshold_0 are used e.g., five different values (operations 1626 and 1628). For each value of threshold_0, the Count_Y is stored as a dictionary that maps tuples of tracking_id-user_account to count score, which is an integer. In the example where 5 values of threshold are used, five such dictionaries are created at operation 1630. The process ends at operation 1632.

The features from the second and third techniques are then used to create a labeled training data set and used to train the network ensemble. To collect such a data set, multiple subjects (shoppers) walk in an area of real space such as a shopping store. The images of these subject are collected using cameras 114 at regular time intervals. Human labelers review the images and assign correct identifiers (tracking_id and user_account) to the images in the training data. The process is described in a flowchart 1600 presented in FIG. 16C. The process starts at operation 1640. At operation 1642, features in the form of Count_X and Count_Y dictionaries obtained from second and third techniques are compared with corresponding true labels assigned by the human labelers on the images to identify correct matches (true) and incorrect matches (false) of tracking_id and user_account.

As there are only two categories of outcome for each mapping of tracking_id and user_account: true or false, a binary classifier is trained using this training data set (operation 1644). Commonly used methods for binary classification include decision trees, random forest, neural networks, gradient boost, support vector machines, etc. A trained binary classifier is used to categorize new probabilistic observations as true or false. The trained binary classifier is used in production (or inference) by giving as input Count_X and Count_Y dictionaries for tracking_id-user_account tuples. The trained binary classifier classifies each tuple as true or false at operation 1646. The process ends at an operation 1648.

If there is an unmatched mobile computing device in the area of real space after application of the above four techniques, the system sends a notification to the mobile computing device to open the client application. If the user accepts the notification, the client application will display a semaphore image as described in the first technique. The system will then follow the operations in the first technique to check-in the shopper (match tracking_id to user_account). If the customer does not respond to the notification, the system will send a notification to an employee in the shopping store indicating the location of the unmatched customer. The employee can then walk to the customer, ask him to open the client application on his mobile computing device to check-in to the system using a semaphore image.

No biometric identifying information is used for matching the tracked subject with the user account, and none is stored in support of this process. That is, there is no information in the sequences of images used to compare with stored biometric information for the purposes of matching the tracked subjects with user accounts in support of this process. Thus, this logic to match the tracked subjects with user accounts operates without use of personal identifying biometric information associated with the user accounts.

### Architecture

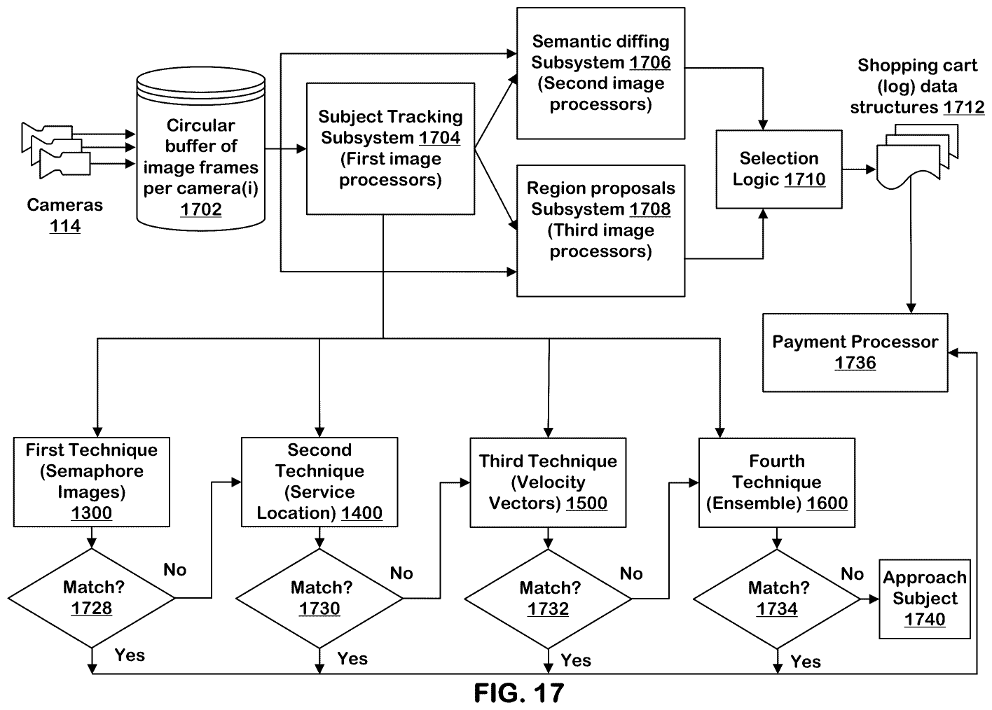

An example architecture of a system in which the four techniques presented above are applied to identify subjects by matching a user_account to a not yet linked tracked subject in an area of real space is presented in FIG. 17. Because FIG. 17 is an architectural diagram, certain details are omitted to improve the clarity of description. The system presented in FIG. 17 receives image frames from a plurality of cameras 114. As described above, in one implementation, the cameras 114 can be synchronized in time with each other, so that images are captured at the same time, or close in time, and at the same image capture rate. Images captured in all the cameras covering an area of real space at the same time, or close in time, are synchronized in the sense that the synchronized images can be identified in the processing engines as representing different views at a moment in time of subjects having fixed positions in the real space. The images are stored in a circular buffer of image frames per camera 1702.

A “subject tracking” subsystem 1704 (also referred to as first image processors) processes image frames received from cameras 114 to locate and track subjects in the real space. The first image processors include subject image recognition engines such as the JointsCNN above.

A “semantic diffing” subsystem 1706 (also referred to as second image processors) includes background image recognition engines, which receive corresponding sequences of images from the plurality of cameras and recognize semantically significant differences in the background (i.e. inventory display structures like shelves) as they relate to puts and takes of inventory items, for example, over time in the images from each camera. The second image processors receive output of the subject tracking subsystem 1704 and image frames from cameras 114 as input. Details of “semantic diffing” subsystem are presented in U.S. patent application Ser. No. 15/945,466, entitled, “Predicting Inventory Events using Semantic Diffing,” filed on 4 Apr. 2018, now issued as U.S. Pat. No. 10,127,438, and U.S. patent application Ser. No. 15/945,473, entitled, “Predicting Inventory Events using Foreground/Background Processing,” filed on 4 Apr. 2018, now issued as U.S. Pat. No. 10,474,988, both of which are fully incorporated into this application by reference. The second image processors process identified background changes to make a first set of detections of takes of inventory items by tracked subjects and of puts of inventory items on inventory display structures by tracked subjects. The first set of detections are also referred to as background detections of puts and takes of inventory items. In the example of a shopping store, the first detections identify inventory items taken from the shelves or put on the shelves by customers or employees of the store. The semantic diffing subsystem includes the logic to associate identified background changes with tracked subjects.

A “region proposals” subsystem 1708 (also referred to as third image processors) includes foreground image recognition engines, receives corresponding sequences of images from the plurality of cameras 114, and recognizes semantically significant objects in the foreground (i.e. shoppers, their hands and inventory items) as they relate to puts and takes of inventory items, for example, over time in the images from each camera. The region proposals subsystem 1708 also receives output of the subject tracking subsystem 1704. The third image processors process sequences of images from cameras 114 to identify and classify foreground changes represented in the images in the corresponding sequences of images. The third image processors process identified foreground changes to make a second set of detections of takes of inventory items by tracked subjects and of puts of inventory items on inventory display structures by tracked subjects. The second set of detections are also referred to as foreground detection of puts and takes of inventory items. In the example of a shopping store, the second set of detections identifies takes of inventory items and puts of inventory items on inventory display structures by customers and employees of the store. The details of a region proposal subsystem are presented in U.S. patent application Ser. No. 15/907,112, entitled, “Item Put and Take Detection Using Image Recognition,” filed on 27 Feb. 2018, now issued as U.S. Pat. No. 10,133,933, which is fully incorporated into this application by reference.

The system described in FIG. 17 includes a selection logic 1710 to process the first and second sets of detections to generate log data structures including lists of inventory items for tracked subjects. For a take or put in the real space, the selection logic 1710 selects the output from either the semantic diffing subsystem 1706 or the region proposals subsystem 1708. In one implementation, the selection logic 1710 uses a confidence score generated by the semantic diffing subsystem for the first set of detections and a confidence score generated by the region proposals subsystem for a second set of detections to make the selection. The output of the subsystem with a higher confidence score for a particular detection is selected and used to generate a log data structure 1712 (also referred to as a shopping cart data structure) including a list of inventory items (and their quantities) associated with tracked subjects.

To process a payment for the items in the log data structure 1712, the system in FIG. 17 applies the four techniques for matching the tracked subject (associated with the log data) to a user_account which includes a payment method such as credit card or bank account information. In one implementation, the four techniques are applied sequentially as shown in the figure. If the operations in flowchart 1300 for the first technique produces a match between the subject and the user account then this information is used by a payment processor 1736 to charge the customer for the inventory items in the log data structure. Otherwise (operation 1728), the operations presented in flowchart 1400 for the second technique are followed and the user account is used by the payment processor 1736. If the second technique is unable to match the user account with a subject (operation 1730) then the operations presented in flowchart 1500 for the third technique are followed. If the third technique is unable to match the user account with a subject (operation 1732) then the operations in flowchart 1600 for the fourth technique are followed to match the user account with a subject.

If the fourth technique is unable to match the user account with a subject (operation 1734), the system sends a notification to the mobile computing device to open the client application and follow the operations presented in the flowchart 1300 for the first technique. If the customer does not respond to the notification, the system will send a notification to an employee in the shopping store indicating the location of the unmatched customer. The employee can then walk to the customer, ask him to open the client application on his mobile computing device to check-in to the system using a semaphore image (operation 1740). It is understood that in other implementations of the architecture presented in FIG. 17, fewer than four techniques can be used to match the user accounts to not yet linked tracked subjects.

### Process for Automatic Generation of Layouts for a Cashier-Less Store

The following discussion describes several aspects of the technology disclosed including automatic camera placement plan generation, automatic calibration and re-calibration of cameras in the area of real space and use of images captured by the calibrated cameras to generate three-dimensional maps (3D maps) or 3D points cloud of the area of real space. The 3D points cloud can be provided as input to the layout generation engine for generating the layout of the area of real space.

The system of FIG. 1A can include a layout generation engine (not shown) that implements the logic to automatically determine a layout of shelves or other types of inventory display structures in the area of real space. The layout of the area of real space can be stored in the maps database 140. The layout generation engine also includes logic to detect changes to layout in an area of real space when shelves or other types of inventory display structures are moved to other positions in the area of real space. The layout generation engine can then determine the new positions of shelves and update the layout of shelves in the area of real space in the layout plan stored in the maps database 140. The layout generation engine can therefore avoid any errors in detecting interactions of subjects with items even when layout of shelves is changed.

The layout generation engine can take a three-dimensional map or a three-dimensional point cloud of an area of real space as input and generate a semantic map of the area of real space. A point cloud is a discrete set of data points in a three-dimensional (3D) space. The points may represent a 3D shape or object. Each point position has its set of Cartesian coordinates. The semantic map includes positions of shelves and pedestrian paths in the area of real space. The layout generation engine includes logic to extract positions of shelves (or other types of inventory display structures) and walkable areas from the semantic map. A shelf map, extracted from the semantic map, provides a layout of the area of real space. When shelves are moved to other locations in the area of real space, the layout generation engine can detect a change in the current layout of the area of real space and initiate the process to generate an updated layout of the area of real space. The layout generation engine can therefore automatically update the layout of an area of real space without manual effort or human intervention. Additionally, the layout generation can be completed in a short period of time such as in about 30 minutes to about an hour. A longer period of time such as up to two hours or more can be required for large areas of real space with a large number of shelves (e.g., more than 50 inventory display structures). The technology disclosed therefore solves the problem of errors in operations of a cashier-less store when layout of shelves is changed in the store by automatically updating the layout when changes are detected in positions of shelves. The changed positions of shelves can be detected in real time or within a short period of time such as within a few hours (e.g., three to six hours). In one implementation, the technology disclosed continuously updates the layout of an area of real space at regular time intervals, e.g., every six hours, every twelve hours or once a day. Consider, for example, when special events are occurring (e.g., the Super Bowl or holiday festivities, new display structures are often placed in a store to offer products related to the special events. Previously, the cashier-less shopping system would need to receive a manual update to identify the location of the new display structure. However, the technology disclosed is able to update the layout in the middle of the night (after the new display structure is added) so that in the morning when the store opens (or gets busier), the cashier-less store will be up and running with the updated layout. When changes are detected in the layout of the area of real space in a previous time interval, the layout generation engine automatically updates the layout of the area of real space.

The technology disclosed provides several advantages in operations of cashier-less shopping stores. For example, with the implementation of the layout generation engine, the shelf layout plans are continuously updated in real time or near real time. Therefore, the shelf layout plan for the shopping store is not outdated or inconsistent with placement of shelves. The store management can provide access to the shelf layout plans to vendors or product distributors so that they can keep stocking their items on correct shelves even when the positions of the shelves are changed. The store manager can easily change placement of popular products on certain shelves in real time, for example, to alter the flow of subjects in the store. The store management can also strategically place products in different location in the shopping store to make subjects walk through most of the store. A particular soft drink can be placed on shelves at one end of the store or a coffee station can be positioned at one of the store to make subjects pass through an area which was previously not frequently visited. This can increase sales of products in that area of the shopping store. The store management does not need to contact the vendors or product distributors when placement of their product is changed. The vendors or product distributors can simply access the shelf layout plan and follow the plan to place their products in shelves or inventory display structures.

The store management can generate various useful analytics which can be used to upsell particular shelves to vendors or product distributors. For example, the technology disclosed can determine the number of subjects that passed by a particular shelf in a day, the number of subjects that stopped and looked at the product (using their gaze directions), the number of subjects that interacted with the products on the shelf, the number of subjects that purchased the product from the shelf. This data can be used to indicate shelves that are popular and the store management can sell particular shelves at higher fee to vendors or product distributors.

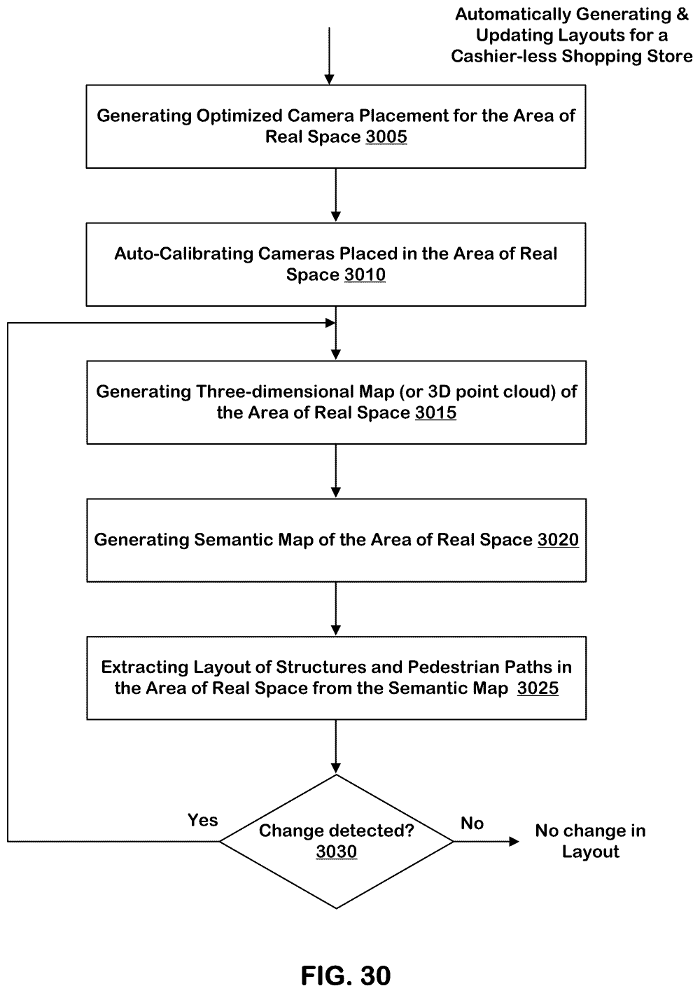

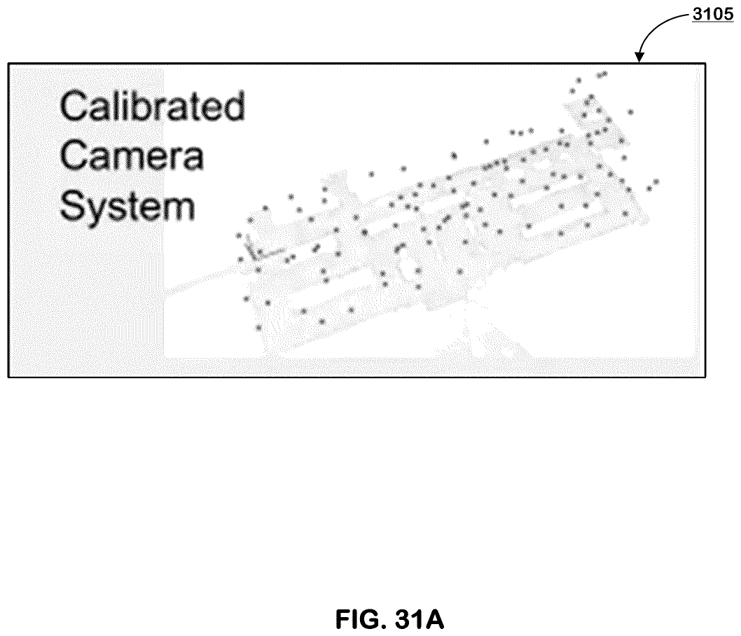

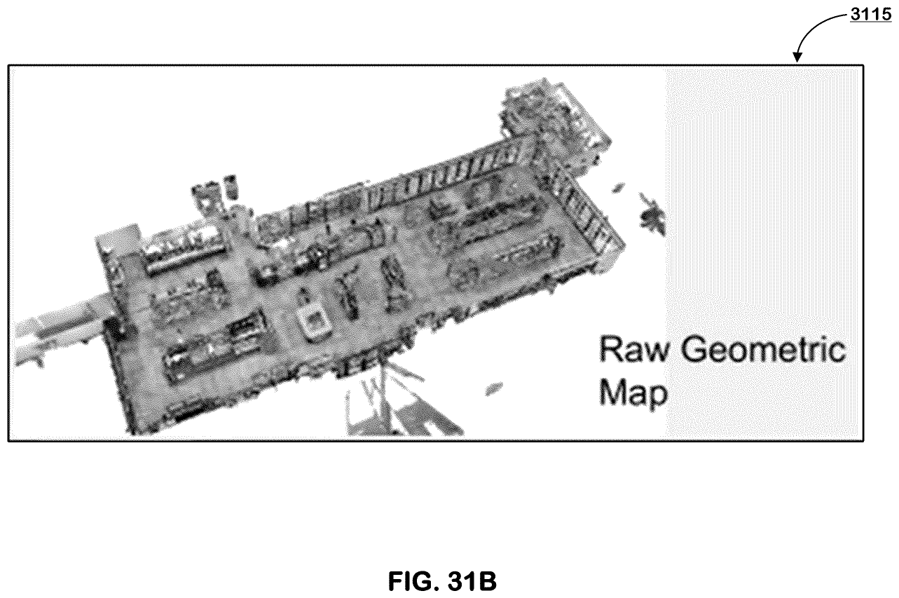

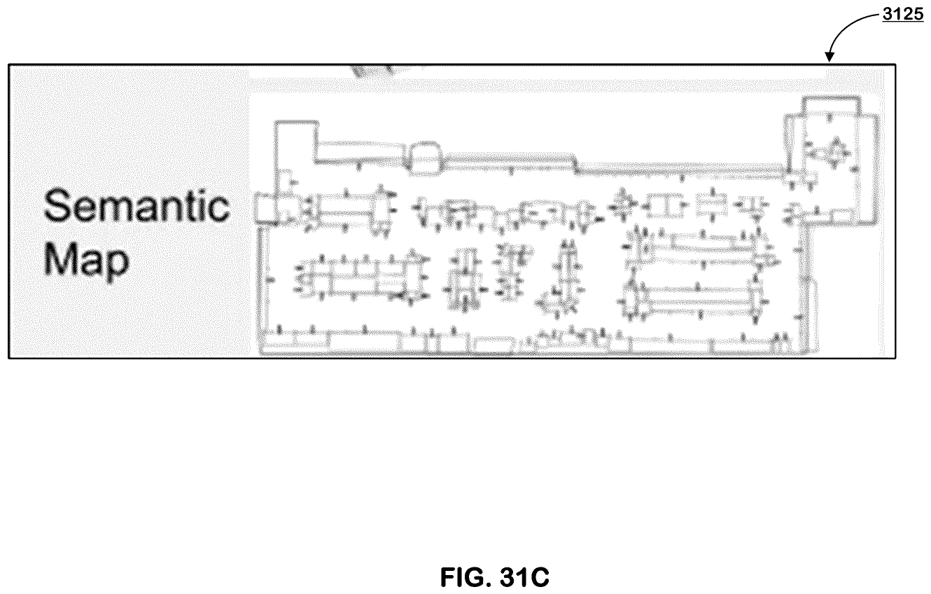

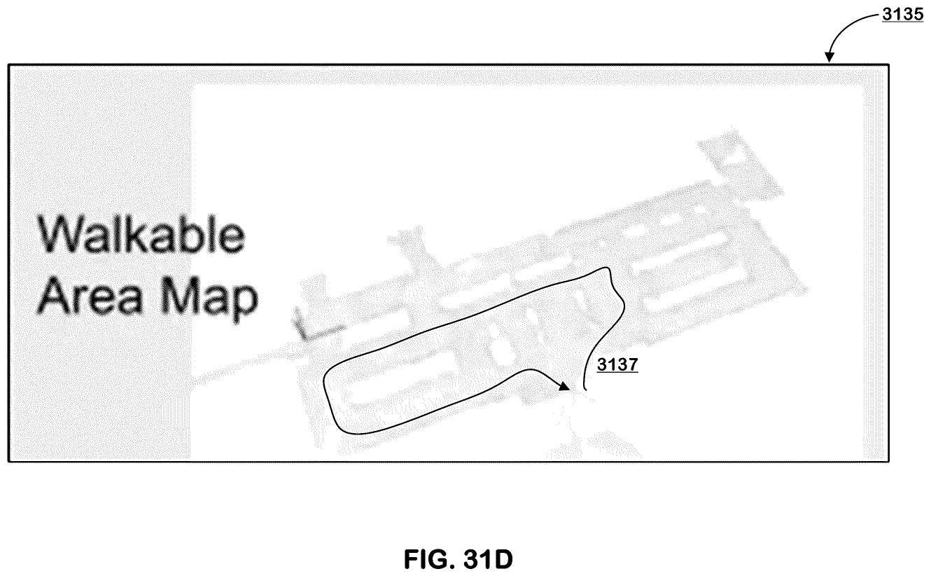

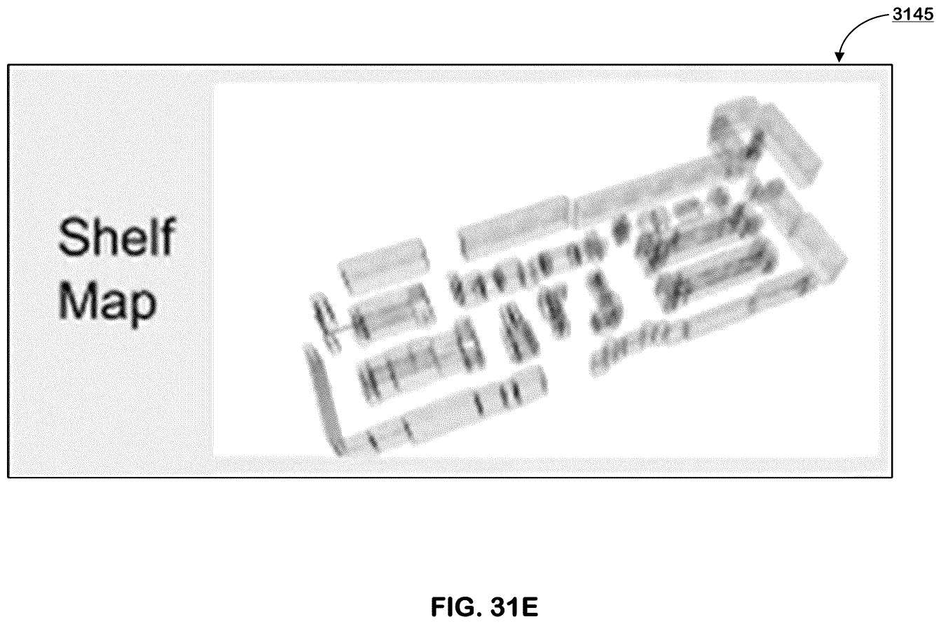

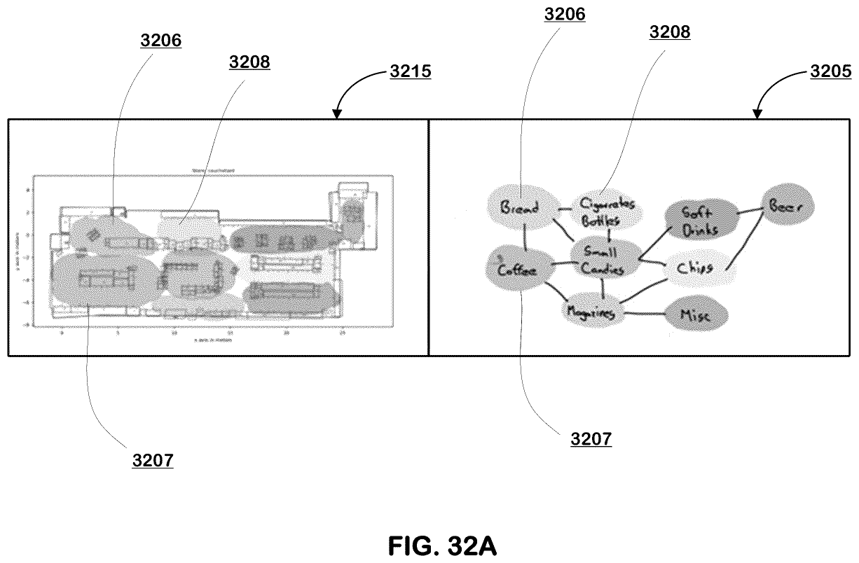

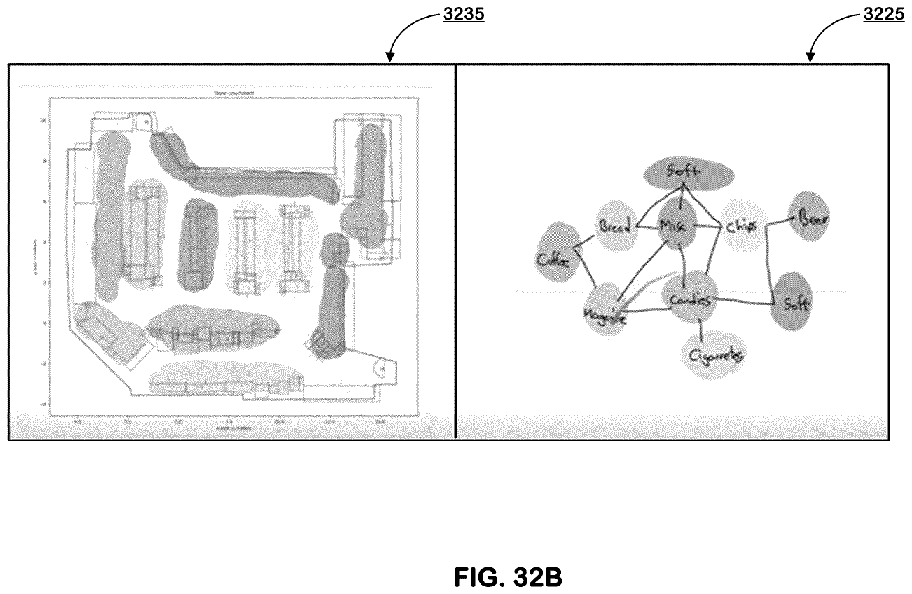

A process flowchart including operations for generating layouts for the cashier-less shopping store for autonomous checkout is presented in FIG. 30. Several examples of layouts are presented in FIGS. 31A to 31E. Examples of representations of shelf layouts as network topologies are presented in FIGS. 32A and 232B.

FIG. 30 presents a process flowchart including operations to automatically generate the layout of the area of real space. The layouts can be generated automatically for a cashier-less shopping store for autonomous checkout or a self-service checkout. The technology disclosed allows owners or managers of a shopping store (or any other individual) to automatically generate layout of shelves and other inventory display structures for cashier-less stores for autonomous checkout. The technology disclosed can detect changes to an existing layout of shelves in a cashier-less shopping store and automatically update the layout.

The process starts at operation 3005 when a camera placement plan is generated for the area of real space. The technology disclosed can use the camera placement plan generation technique presented above. A map of the area of real space can be provided as input to the camera placement generation technique along with any constraints for placement of cameras. The constraints can identify locations at which cameras cannot be installed. The camera placement generation technique outputs one or more camera placement maps for the area of real space. A camera placement map generated by the camera placement technique can be selected for installing cameras in the area of real space. The manager (or owner) of the shopping store (or any other individual) can order cameras which can be delivered to the shopping store for installation per the selected camera placement map generated by the camera placement generation technique. The cameras can be installed at the ceiling of the shopping store or installed using stands/tripods at outdoor locations. The serial number and/or identifier of a camera can be scanned and provided as input to the camera placement engine when placing the camera at a particular camera location per the camera placement map. For example, a camera with a serial number “ABCDEF” is registered as camera number “1” when plugged into the location at a location that is designated as a location for camera “1” in the camera placement map. A central server such as a cloud-based server can register the cameras installed in the area of real space and assign them the camera numbers per camera placement map. The technology disclosed allows swapping of existing cameras with new cameras when a camera breaks down or when a new camera with higher resolution and/or processing power is to be installed to replace an old camera. The existing camera can be plugged out of its location and a new camera can be plugged in by an employee of the shopping store. The camera placement engine automatically updates the camera placement record in a camera placement record for the area of real space by replacing the serial number of the old camera with the serial number of the new camera. The technology disclosed includes logic to send camera setup configuration data to the new camera. Such data can be accessed from a calibration database as well. Further details of an automatic camera placement generation technique are presented above and also in U.S. patent application Ser. No. 17/358,864, entitled, “Systems and Method for Automated Design of Camera Placement and Cameras Arrangements for Autonomous Checkout,” filed on 25 Jun. 2021, now issued as U.S. Pat. No. 11,303,853 which is fully incorporated into this application by reference.

When one or more cameras are installed in the area of real space, the technology disclosed can initiate auto-calibration technique presented above for calibrating the one or more cameras. The technology disclosed can apply the camera calibration logic calibrate or recalibrate the cameras in the area of real space (operation 3010). The camera recalibration can be performed at regular intervals or when one or more cameras are moved from their respective locations due to changes or movements in the structure on which they are positioned or due to cleaning etc. The details of an automatic camera calibration and recalibration technique are presented above and also in U.S. patent application Ser. No. 17/357,867, entitled, “Systems and Methods for Automated Recalibration of Sensors for Autonomous Checkout,” filed on 24 Jun. 2021, now issued as U.S. Pat. No. 11,361,468 which is fully incorporated into this application by reference. The technology disclosed can also use the automated camera calibration technique presented in U.S. patent application Ser. No. 17/733,680, entitled, “Systems and Methods for Extrinsic Calibration of Sensors for Autonomous Checkout,” filed on 29 Apr. 2022 which is fully incorporated into this application by reference. An example calibrated camera system 3105 is shown in FIG. 31A. The circles in the illustration 3105 indicate positions of cameras in the area of real space placed according to the camera placement plan.

The images captured by calibrated cameras can be used to generate a three-dimensional map (3D map) or a three-dimensional point cloud (3D point cloud) of the area of real space (operation 3015). The layout generation engine includes logic to access a 3D point cloud generated by an external system such as Matterport tool available at <<matterport.com>>. Other external systems can also be used to generate 3D point cloud of the area of real space. The technology disclosed can also use mobile devices to capture images of the area of real space and use the captured images to generate a 3D point cloud. The 3D point cloud can be generated at regular intervals to detect changes in the layout of shelves or other types of inventory display structures in the area of real space. An example of a three-dimensional map 3115 of the area of real space is shown in FIG. 31B. The three-dimensional map (also referred to as a raw geometric map) indicates positions of inventory display structures and pedestrian paths in the area of real space.

The layout generation engine includes logic to generate a semantic map of the area of real space from the 3D point cloud or raw geometric map of the area of real space (operation 3020). FIG. 31C presents an example semantic map 3125 of the area of real space. The semantic map 3125 includes positions of inventory display structures or shelves and pedestrian paths in the area of real space. In one implementation, the layout generation engine includes a trained machine learning model that can classify portions of a 3D point cloud as shelves and pedestrian paths. The machine learning model can also classify portions of shelves into different classes. For example, a portion of the shelf can be classified as containing refrigerated items such as produce, dairy etc. The machine learning model can be trained to classify shelves into various classes of items such as clothing, electronics, canned food, deli etc. The semantic map can also indicate entrances and exits to the area of real space, open spaces, coffee area, restrooms other types of designated spaces in the area of real space.

The layout generation engine can extract various types of maps or information about the area of real space from the semantic map (operation 3025). For example, the layout generation engine can extract a shelf map 3145 illustrated in FIG. 31E from the semantic map of the area of real space. The walkable area map and the shelf map of the area of real space can also be extracted from three-dimensional maps of the area of real space, one or more sets of calibrated camera images or LiDAR sensors positioned in the area of real space. The shelf map provides positions of various types of inventory display structures in the area of real space. The layout generation engine can also extract a walkable area map 3135 illustrated in the FIG. 31D from the semantic map of the area of real space. The walkable area map 3135 shows locations of pedestrian paths in the area of real space. The walkable area map includes possible pedestrian paths for subjects in the area of real space. For example, the “pedestrian paths” can indicate the “actual paths” of subjects in the area of real space. The actual paths can be determined using the subject tracking engine 110. The walkable area map in FIG. 31D shows an example pedestrian path 3137. Multiple pedestrian paths can be presented on a walkable area map. The walkable area map can also include the “expected paths” of subjects which may be used by the subjects for walking through the inventory display structures. When planning for a new store, the actual paths may not be available and therefore, the analysis can be performed using the expected paths of subjects in the area of real space. The walkable area maps can also include a ranking of pedestrian paths in the area of real space based on the subject traffic, most items taken or other criteria as determined by the store management. When a layout of a shopping store changes, the walkable area map of the shopping store also needs to be updated along with update to the shelf map. Walkable areas represent the paths that shoppers take in a shopping store. As more data regarding walking paths is collected from multiple shopping store locations, this data can used to train a machine learning model. The trained machine learning model can be used to predict commonly or frequently taken paths by shoppers in an existing or a new shopping store. Other machine learning models can be trained to predict frequently visited locations in a shopping store given a layout of a shopping store. This is helpful for planning changes to layouts of shopping stores or for planning for new shopping stores as store managers can predict the frequent paths that shoppers would take and the locations that shoppers will frequently visit.

The layout generation engine can compare the various types of maps such as the shelf map or the walkable area map with corresponding maps generated in a previous time interval. When changes are detected in a map (such as the shelf map or the walkable area map) in the current time interval with respect to a similar map from a previous time interval then operations 3015, 3020 and 3025 are repeated to update the layout of the area of real space (operation 3030). In one implementation, the changes in the shelf map and/or walkable area maps can initiate other processes related to the operations of the cashier-less shopping store. For example, a process can be initiated to update data structures and/or databases that are used for inventory event detection such as detection of takes of items from shelves and puts of items on shelves. Examples of such data structures include camograms, realograms and/or planograms of the area of real space. The updates to these data structures ensure that changes in positions of inventory items is propagated to various data structures and databases that are used to support operations of the cashier-less shopping store. A camogram data structure includes positions of inventory items on shelves as viewed by one or more cameras. The camogram data structure can also include details of inventory items such as SKU, item category, item subcategory, price, weight etc. A realogram data structure indicates positions of inventory items on various shelves in the area of real space as they are moved around. The realogram data structure can be used to determine locations of a particular item in the area of real space in real time or near real time. A planogram data structure includes planned placement of inventory items in the area of real space. The planogram can be generated when the shopping store is being setup. It may become outdated as shelves are moved around or inventory items are moved from one shelf to another. The positions of inventory items in realogram and camogram data structures can be used to update the planogram or vice versa. Using data collected from multiple shopping store locations, machine learning models can be trained to predict the impact of product locations on shopper visits. For example, trained machine learning models can be used to predict shopper behavior (such as paths taken or locations visited) with products positioned at different locations in the shopping store. When no changes are detected in a shelf map or a walkable area map in a current time interval with respect to a similar map in a previous time interval then the current layout of the area of real space is not changed. The operations 3015 to 3025 may be repeated a regular time interval as mentioned above to automatically update the layout of the area of real space. When new cameras are installed, the operation 3010 can also be performed to automatically recalibrate the cameras.

### Representation of a Layout as a Network Topology

FIGS. 32A and 32B present example layouts for respective areas of real space. The layouts are presented at a higher level in which groups of shelves are combined to represent semantically meaningful subspaces or sections.

FIG. 32A presents a shelf layout map 3215 of an area of real space overlayed with nine oval-shaped regions. Each oval-shaped subspace includes a group of shelves in the shelf layout map 3215 such that the shelves in the group are stocked with inventory items that belong to a particular class of items. The layout 3215 (left-side of FIG. 32A) is represented as a network topology 3205 (right-side of FIG. 32A). The network topology 3205 represents each oval-shaped subspace in the layout 3215 as a node in a graph connected by an edge to one or more other nodes representing other subspaces. Two subspaces are connected by an edge in the graph 3205 when they are adjacent to each other in the layout 3215. For example, the “bread” subspace 3206 in the shelf layout map 3215 is adjacent to “coffee” subspace 3207 and “cigarettes and bottles” subspace 3208. The network topology 3205 represents these adjacent positions of subspaces by including edges connecting “bread” subspace 3206 with the “coffee” subspace 3207 and the “cigarettes and bottles” subspace 3208, respectively.

The network topology can be used for planning and analysis of subject traffic and item purchases in various subspaces of the area of real space. The store manager or owner can generate various possible arrangements of subspaces by moving the subspaces to other locations in the area of real space. The changes can then be viewed in a graphical format with nodes connected by edges. The graphical visualization helps the store management to determine how the connections between various subspaces can be impacted by changes in the layout of subspaces in the area of real space. In another type of analysis one type of subspace can be divided into multiple smaller subspaces to increase purchases or to increase subject traffic in different areas of the shopping store. For example, instead of having one “coffee” subspace 3207 on the left-side of the store (in FIG. 32A), the store manager may decide to have two coffee subspaces, one in the left-side of the store the other on the right-side of the store. This can increase subject traffic to both the left and the right sides of the area of real space, thus increasing product purchases in both the left and the right side of the store.

FIG. 32B presents another example in which a shelf layout plan 3235 is represented as a network topology 3225. The shelf layout plan 3235 shows that there are ten subspaces represented as oval-shaped regions overlayed on the shelf layout plan. The network topology represents these ten subspaces as ten nodes connected by edges in a graph. Two nodes are connected by an edge when they are adjacent to each other in the shelf layout map 3235. The adjacency between subspaces or between shelves can be defined using other criteria such as based on product categories. A distance between subspaces or between shelves can also be calculated based on these criteria. When the distance is below a threshold, the subspaces or shelves may be connected by an edge. The distance can be calculated using product category e.g., a coffee subspace may not be close to a candy subspace (or a candy shelf) as their respective product categories are quite different and therefore the distance between these two subspaces can be greater than the threshold. A distance can be calculated by combining various criteria. In one implementation, a criterion can be assigned a weight when calculating the distance. In this way, the store management can assign higher weights to criteria that are more important for their store when calculating the distance between subspaces and between shelves. The lower the distance, the closer the two subspaces may be placed and the higher the distance the farther the subspaces or shelves may be placed. The categorical-topology representation (as shown in FIGS. 32A and 32B) enables analysis of different shopping stores with different characteristics and geometries. For example, the technology disclosed includes logic to analyze similarities in shoppers' behavior in one shopping store location or across multiple shopping store locations. The technology disclosed can extract shoppers' behavior patterns in shopping stores (e.g., frequently taken paths or frequently visited locations). The technology disclosed can be used to predict shopper behavior for different topological representations of a shopping store.

Any data structures and code described or referenced above are stored according to many implementations in computer readable memory, which comprises a non-transitory computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

### Particular Implementations

The technology disclosed is related to generating and updating a layout map of an area of real space.

The technology disclosed can be practiced as a system, method, device, product, computer readable media, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

The technology disclosed can be practiced as a method for generating and updating a layout map for an area of real space. The method can include using a plurality of sequences of images received from a plurality of cameras installed in the area of real space. The plurality of cameras can be installed at respective locations in the area of real space as specified in a camera coverage plan and the plurality of cameras are calibrated to track subjects in the area of real space such that at least two cameras with overlapping fields of view capture images of shelves and subjects' paths in the area of real space. The method can include generating a first map of the shelves in the area of real space based on images of the shelves and open spaces detected in images captured by the plurality of cameras and storing the first map of the shelves as the layout map of the area of real space. The method can include subsequently generating a second map of the shelves in the area of real space using the plurality of sequences of images received from the plurality of cameras installed in the area of real space. The method can include comparing the second map of the shelves to the first map of the shelves to detect changes in placement of shelves in the area of real space. The method can include updating the layout map of the area of real space when a difference is detected between the first map of the shelves and the second map of the shelves to capture the changes in the placement of shelves as detected in the subsequent images of the area of real space. The method can include updating data structures related to placement of items in the area of real space such as a camogram and a realogram representing current positions of inventory items in the area of real space. The method can include using the updated current map and the updated data structures to track inventory events in the area of real space wherein the inventory events include takes of inventory items from shelves and puts of inventory items on shelves.

This method and other implementations of the technology disclosed can include one or more of the following features. In the interest of conciseness, the combinations of features disclosed in this application are not individually enumerated and are not repeated with each base set of features. Features applicable to methods, systems, and articles of manufacture are not repeated for each statutory class set of base features. The reader will understand how features identified in this section can readily be combined with base features in other statutory classes.

In one implementation, the method includes generating a three-dimensional point cloud of the area of real space using the plurality of sequences of images received from the plurality of cameras and using the three-dimensional point cloud to generate the first map of the shelves in the area of real space.

In such an implementation, the method includes, generating a semantic map of the area of real space from the three-dimensional point cloud of the area of real space. The semantic map includes location of shelves in the area of real space and locations of pedestrian paths in the area of real space.

In such an implementation, the method further includes extracting locations of shelves and the locations of pedestrian paths in the real space from the semantic map and storing the locations of shelves and the locations of pedestrian paths as part of the layout map of the area of real space.

The operations including the subsequently generating the second map, the comparing the second map to the first map, the updating the layout map of the area of real space, and the updating data structures can be performed automatically at predetermined time interval and/or upon detection of a movement of a subject in the area of real space.

The operations including the subsequently generating the second map, the comparing the second map to the first map, the updating the layout map of the area of real space, and the updating data structures can be performed upon receiving an input requesting updated layout map of the area of real space.

Other implementations consistent with this method may include a non-transitory computer readable storage medium storing instructions executable by a processor to perform any of the methods described above. Yet another implementation may include a system with memory loaded from a computer readable storage medium with program instructions to perform the any of the methods described above. The system can be loaded from either a transitory or a non-transitory computer readable storage medium.

Aspects of the technology disclosed can be practiced as a system that includes one or more processors coupled to memory. The memory is loaded with computer instructions to generate and update a layout map for an area of real space. The instructions, when executed on the processors, implement the following operations. The system includes logic to use a plurality of sequences of images received from a plurality of cameras installed in the area of real space. The plurality of cameras can be installed at respective locations in the area of real space as specified in a camera coverage plan and the plurality of cameras are calibrated to track subjects in the area of real space such that at least two cameras with overlapping fields of view capture images of shelves and subjects' paths in the area of real space. The system includes logic to generate a first map of the shelves in the area of real space based on images of the shelves and open spaces detected in images captured by the plurality of cameras and storing the first map of the shelves as the layout map of the area of real space. The system includes logic to subsequently generate a second map of the shelves in the area of real space using the plurality of sequences of images received from the plurality of cameras installed in the area of real space. The system includes logic to compare the second map of the shelves to the first map of the shelves to detect changes in placement of shelves in the area of real space. The system includes logic to update the layout map of the area of real space when a difference is detected between the first map of the shelves and the second map of the shelves to capture the changes in the placement of shelves as detected in the subsequent images of the area of real space. The system includes logic to update data structures related to placement of items in the area of real space such as a camogram and a realogram representing current positions of inventory items in the area of real space. The system includes logic to use the updated current map and the updated data structures to track inventory events in the area of real space wherein the inventory events include takes of inventory items from shelves and puts of inventory items on shelves.

The computer implemented systems can incorporate any of the features of method described immediately above or throughout this application that apply to the method implemented by the system. In the interest of conciseness, alternative combinations of system features are not individually enumerated. Features applicable to systems, methods, and articles of manufacture are not repeated for each statutory class set of base features. The reader will understand how features identified in this section for one statutory class can readily be combined with base features in other statutory classes.

Other implementations may include a non-transitory computer readable storage medium storing instructions executable by a processor to perform functions of the system described above. Yet another implementation may include a method performing the functions of the system described above.

As an article of manufacture, rather than a method, a non-transitory computer readable medium (CRM) can be impressed (or loaded) with computer program instructions executable by one or more processors. The program instructions when executed, implement the computer-implemented method presented above. Alternatively, the program instructions can be loaded on a non-transitory CRM and, when combined with appropriate hardware, become a component of one or more of the computer-implemented systems that practice the method disclosed.

Each of the features discussed in this particular implementation section for the method implementation apply equally to CRM implementation. As indicated above, all the method features are not repeated here, in the interest of conciseness, and should be considered repeated by reference.

A method, system and a non-transitory computer readable storage medium impressed with computer program instructions are disclosed that perform any of the generating the first map of the shelves, the subsequent generating of the second map of the shelves, the comparing the second map of the shelves to the first map of the shelves, the updating the layout map of the area of real space when the difference is detected between the first map of the shelves and the second map of the shelves, the updating data structures related to placement of items in the area of real space operations described herein.

1. A system for predicting a path of a subject in an area of real space in a shopping store including a cashier-less checkout system, the system comprising:
a plurality of sensors, producing respective sequences of frames of corresponding fields of view in the real space;
an identification device comprising logic to identify, for a particular subject, a determined path in the area of real space over a period of time using the sequences of frames produced by sensors in the plurality of sensors, the determined path including a subject identifier, one or more locations in the area of real space and one or more timestamps;
an accumulation device, comprising logic to accumulate multiple determined paths for multiple subjects over a period of time;
a matrix generation device, comprising logic to generate a transition matrix using the accumulated determined paths, wherein an element in the transition matrix identifies a probability of a new subject moving from a first location to at least one of other locations in the area of real space;
a path prediction device, comprising logic to predict the path of the new subject in the area of real space in dependence on an interaction of the new subject with an item associated with the first location in the area of real space, wherein the predicting of the path comprises identifying a second location, from the other locations included in the transition matrix, having a highest probability associated therewith with respect to movement of the new subject from the first location; and
a layout generation device, comprising logic to change a preferred placement of a particular item, in dependence on the predicted path, from an existing location to a new location in the area of real space to increase interaction of future subjects with the particular item.

2. The system of claim 1, wherein the layout generation device further includes logic to change a preferred placement of a shelf containing the particular item, in dependence on the predicted path, from an existing location to a new location in the area of real space to increase interaction of the future subjects with the particular item contained within the shelf.

3. The system of claim 1, wherein the path prediction device further includes logic to identify a third location, from the other locations included in the transition matrix, having a highest probability associated therewith with respect to movement of the new subject from the second location.

4. The system of claim 1, wherein the path prediction device further includes logic to determine the interaction of the new subject with the item when an angle between a plane connecting shoulder joints of the new subject is greater than or equal to 40 degrees and less than or equal to 50 degrees corresponding to a plane representing a front side of a shelf at the first location and when a speed of the subject is greater than or equal to 0.15 meters per second and less than or equal to 0.25 meters per second and when a distance of the subject is less than or equal to 1 meter from the shelf at the first location.

5. The system of claim 1, further comprising a shelf popularity score calculation device including logic to:
increment a count of visits to a particular shelf whenever the interaction is determined for the particular shelf, and
use the count of visits to the particular shelf over a period of time to determine a shelf popularity score for the particular shelf.

6. The system of claim 5, wherein the shelf popularity score is calculated for the particular shelf at different times of a day and at different days of a week.

7. The system of claim 1, further comprising a heatmap generation device including logic to generate a heatmap for the area of real space in dependence on a count of interactions of all subjects in the area of real space with all shelves in the area of real space.

8. The system of claim 1, further comprising a heatmap generation device including logic to re-calculate the heatmap for the area of real space in dependence upon a change of a location of at least a first shelf in the area of real space.

9. The system of claim 1, wherein the path prediction device further comprises logic to generate the predicted path for the new subject starting from a location of a first shelf with which the subject interacted and ending at an exit location from the area of real space.

10. The system of claim 1, comprising a display generation device including logic to display a graphical representation of connectedness of shelves in the area of real space, the graphical representation comprising nodes representing shelves in the area of real space and comprising edges connecting the nodes representing distances between respective shelves weighted by respective elements of the transition matrix.

11. The system of claim 10, wherein, in response to changing a location of a shelf in the area of real space, the display generation device further includes logic to displaying an updated graphical representation by recalculating the edges connecting the shelf to other shelves in the area of real space.

12. The system of claim 1, further comprising a training device including logic to train a machine learning model for predicting the path of the subject in the area of real space, the training device including logic to:
input, to the machine learning model, labeled examples from training data, wherein an example in the labeled examples comprises at least one determined path from the accumulated multiple paths for multiple subjects,
input, to the machine learning mode, a map of the area of real space comprising locations of shelves in the area of real space, and
input, to the machine learning model, labels of products associated with respective shelves in the area of real space.

13. The system of claim 12, further comprising logic to use the trained machine learning model to predict the path of the new subject in the area of real space by providing, as input, at least one interaction of the new subject with an item associated with the first location in the area of real space.

14. A method for predicting a path of a subject in an area of real space, the method including:
using a plurality of sensors to produce respective sequences of frames of corresponding fields of view in the real space;
identifying, for a particular subject, a determined path in the area of real space over a period of time using the sequences of frames produced by sensors in the plurality of sensors, the determined path including a subject identifier, one or more locations in the area of real space and one or more timestamps;
accumulating multiple determined paths for multiple subjects over a period of time;
generating a transition matrix using the accumulated determined paths, wherein an element in the transition matrix identifies a probability of a new subject moving from a first location to at least one of other locations in the area of real space; and
predicting the path of the new subject in the area of real space in dependence on an interaction of the new subject with an item associated with the first location in the area of real space, wherein the predicting of the path comprises identifying a second location, from the other locations included in the transition matrix, having a highest probability associated therewith with respect to movement of the new subject from the first location.

15. The method of claim 14, wherein the predicting the path of the new subject in the area of real space further includes identifying a third location, from the other locations included in the transition matrix, having a highest probability associated therewith with respect to movement of the new subject from the second location.

16. The method of claim 14, further including determining the interaction of the new subject with the item when an angle between a plane connecting shoulder joints of the new subject is greater than or equal to 40 degrees and less than or equal to 50 degrees corresponding to a plane representing a front side of a shelf at the first location and when a speed of the subject is greater than or equal to 0.15 meters per second and less than or equal to 0.25 meters per second and when a distance of the subject is less than or equal to 1 meter from the shelf at the first location.

17. The method of claim 14, further including:
incrementing a count of visits to a particular shelf whenever the interaction is determined for the particular shelf; and
using the count of visits to the particular shelf over a period of time to determine a shelf popularity score for the particular shelf.

18. A non-transitory computer readable storage medium impressed with computer program instructions to predict a path of a subject in an area of real space, the instructions, when executed on a processor, implement a method comprising:
using a plurality of sensors, producing respective sequences of frames of corresponding fields of view in the real space;
identifying, for a particular subject, a determined path in the area of real space over a period of time using the sequences of frames produced by sensors in the plurality of sensors, the determined path including a subject identifier, one or more locations in the area of real space and one or more timestamps;
accumulating multiple determined paths for multiple subjects over a period of time;
generating a transition matrix using the accumulated determined paths, wherein an element in the transition matrix identifies a probability of a new subject moving from a first location to at least one of other locations in the area of real space;
predicting the path of the new subject in the area of real space in dependence on an interaction of the new subject with an item associated with the first location in the area of real space, wherein the predicting of the path comprises identifying a second location, from the other locations included in the transition matrix, having a highest probability associated therewith with respect to movement of the new subject from the first location; and
changing placement of a particular item, in dependence on the predicted path, from an existing location to a new location in the area of real space to increase interaction of subjects with the particular item.

19. The non-transitory computer readable storage medium of claim 18, wherein the predicting the path of the new subject in the area of real space, implementing the method further comprising, determining the interaction of the new subject with the item when an angle between a plane connecting shoulder joints of the new subject is greater than or equal to 40 degrees and less than or equal to 50 degrees corresponding to a plane representing a front side of a shelf at the first location and when a speed of the subject is greater than or equal to 0.15 meters per second and less than or equal to 0.25 meters per second and when a distance of the subject is less than or equal to 1 meter from the shelf at the first location.

20. The non-transitory computer readable storage medium of claim 18, implementing the method further comprising:
incrementing a count of visits to a particular shelf whenever the interaction is determined for the particular shelf, and
using the count of visits to the particular shelf over a period of time to determine a shelf popularity score for the particular shelf.
